(19) United States
(12) Patent Application Publication
(10) Pub. No.: US 2014/0302476 A1
(43) Pub. Date: Oct. 9, 2014

(54) COMPUTER-AIDED TRAINING SYSTEMS, METHODS AND APPARATUSES

(71) Applicant: FURUNO ELECTRO CO., LTD., Nishinomiya-city, Hyogo (JP)

(72) Inventors: Mads Friis Sørensen, Hvidovre (DK); Ken Helle Jensen, Hvidovre (DK)

(21) Appl. No.: 14/356,049

(22) PCT Filed: Nov. 2, 2012
(86) PCT No.: PCT/IB2012/002732

§ 371 Date: May 2, 2014

Related U.S. Application Data
(60) Provisional application No. 61/555,909, filed on Nov. 4, 2011.

(51) Int. Cl. G09B 19/00

(52) U.S. Cl. CPC G09B 19/00
USPC 434/307 R

(57) ABSTRACT

The present invention discloses computer aided training methods, apparatuses, systems and media. A computer aided training system according to one embodiment comprises a workstation (8A) providing a simulation of a device, the workstation being configured to connect to a cloud environment (2) and to access a training application (320) that comprises training for the device, wherein the training application (320) is hosted on the cloud environment (2).

### CROSS REFERENCE TO RELATED APPLICATION

This application is the National Stage Entry into U.S. of PCT application PCT/IB2012/002732 filed on 2 Nov. 2012, and PCT application PCT/IB2012/002732 is based upon and claims priority of U.S. Provisional Patent Application Ser. No. 61/555,909 filed on Nov. 4, 2011, the entire disclosure of all of these applications being herein incorporated by reference.

### BACKGROUND OF THE INVENTION

1. Field of the Invention

The present invention discloses Computer Aided Training systems, methods and apparatuses. In one embodiment, the present invention discloses Computer Aided Training systems, methods and apparatuses which utilize cloud computing. The present invention may be used to implement training aboard and for all types of vessels and vessel equipment, as well as other infrastructure such as land, sea and underwater equipment, air/space stations, non-maritime vessels, industrial infrastructure, and also in learning centers worldwide.

2. Description of the Related Art

Maritime travel and operations are governed by strict training and operating regulations. The regulations are implemented by regulatory bodies such as Standards of Training, Certification & Watchkeeping (STCW) and International Safety Management (ISM), which govern the qualifications of seafarers. For example, STCW 2010 Regulation 1/14 requires that:
Each Administration shall, in accordance with the provision of Section AI/14, hold companies responsible for the assignment of seafarers for service on their ships in accordance with the provisions of the present Convention, and shall require every such company to ensure that: Seafarers, on behalf assigned to any of it's ships, are familiarized with their specific duties and with all ship arrangements, installations, equipment, procedures and ship characteristics that are relevant to their routine and emergencies.

Also, ISM Code 6.2 indicates that “[t]he company should ensure that each ship is manned with qualified, certificated and medically fit seafarers in accordance with national and international requirements.” Further, ISM Code 6.3 provides that:
The company should establish procedures to ensure that new personnel and personnel transferred to new assignments related to safety and protection of the environment are given proper familiarization with their duties. Instructions which are essential to be provided prior to sailing should be identified, documented and given.

Further, ISM Code 6.5 provides that:
The company should establish and maintain procedures for identifying any training which may be required in support of the safety management system and ensure that such training is provided for all personnel concerned.

Various rules also govern retrofit sales of navigation equipment, such as, for example, Electronic Chart Display and Information System (ECDIS) retrofit sales. ECDIS requires training for seafarers to obtain a certification to operate it. When the ship owner is considering a retrofit of his fleet, his decision to retrofit is controlled by multiple factors, including: easy and cheap access to ECDIS type specific training; price; functionality; and service provisions worldwide. These factors are of significant interest to the ship owner, because of newly announced requirements for ship specific ECDIS training requested by the STCW and the ISM, which may result in huge crew training expenses. In addition, there is significant confusion regarding compliance with multiple states' rules, because of flag states' inability to provide unified and clear requirements for ship specific training.

The latest regulations concerning ECDIS vetting, from the Ship Inspection Report Program (SIRE), provide the following instructions:
4.23 If the vessel is provided solely with paper charts, does the operator have procedures in place to prepare for the mandatory introduction of ECDIS?
   Notes: The 2009 SOLAS Amendments mandate the carriage of ECDIS and effective 1 Jul. 2012, new tankers>3,000 gt, must be fitted with ECDIS. In the case of existing tankers>3,000 gt, ECDIS must be fitted not later than the first survey on or after 1 Jul. 2015. Operators must be aware of the fundamental changes in navigation that take place with the use of ECDIS and a program should be in place to ensure that the transition is smooth, equipment installed and masters and all bridge watchkeepers properly trained. Such training must be both generic and specific to the ECDIS equipment that officers will use. ECDIS training must be incorporated into the company's SMS for the use of ECDIS in accordance with paragraph 6.5 of the ISM Code and deck officers must be fully familiar with the operation of ECDIS prior to the first voyage after the installation of ECDIS in accordance with paragraph 6.3 of the ISM Code. The IMO 34© Copyright OCIMF 2011. All rights reserved. 34 SN.1/Circ. 276—Transitioning From Paper Chart to Electronic Chart Display and Information Systems (ECDIS) Navigation provides details and guidance for compliance. The vessel must be in possession of the operator's procedures for the ECDIS introduction.
4.24 If the vessel is equipped with an Electronic Chart Display and Information System (ECDIS), are the Master and deck watch-keeping officers able to produce appropriate documentation that generic and type-specific ECDIS familiarization has been undertaken?
   Notes: Each deck watchkeeper must be in possession of an ECDIS certificate of training. This Generic training must have taken place at an establishment approved by the Flag Administration, address the subjects set out in, and fully address each of the topics contained in the IMO Model course 1.27, (The operational use of Electronic Chart Display and Information Systems (ECDIS)). If the equipment on board is of a different type (manufacturer) to which the generic training was undertaken, then evidence of familiarization of the actual equipment fitted on board should be provided. Record in comments the nature of and duration of such familiarization.

ECDIS retrofit sales rules emphasize the importance of ECDIS training in connection with retrofitted features, regardless of the manner in which that training is administered. Det Norske Veritas (DNV, internet link at http://www.dnv.com/) has recently published a report that indicates that more than 80% of all maritime accidents are caused by the human factor and not by the equipment. The report also concludes that the provision of proper training for seafarers has been reduced, and ship owners have moved from building up seafarers' competence to using tick off policies that do not always ensure compliance with ECDIS training requirements.

The Maritime and Coastguard Agency (MCA, internet link at http://www.dft.gov.uk/mca/) has indicated that the platform used for the provision of ECDIS training is not important. The important thing is the competences acquired using the training platform. MCA indicates that in the future, it will not emphasize the specific training certificates presented by the crew in connection with port state controls. Instead, MCA plans to shift to a direct assessment of the competences of the seafarers. In the case of ECDIS, MCA will ask the crew to prove their competences by performing various tasks on the ECDIS. If the performance is not satisfactory and the Port State Control Officer (PECO) judges that the navigator fails competences in ECDIS, then the ship will be detained at the port.

Computer-Based Training (CBT) and Web-Based Training (WBT), as well as classroom training may be used to provide ECDIS training. Providers such as Seagull and Safebridge market Computer-Based Training and Web-Based Training, while standard training companies promote classroom training at training centres, to the detriment of CBT and WBT. CBT and WBT providers similarly promote computer-based and web-based training to the detriment of classroom training. A ship owner, on the other hand, may want to be able to freely select between CBT/WBT and classroom training.

Training centres are governed by rules stemming from the ECDIS training requirements. Due to the new regulations for ECDIS type-specific training, such as ISM code 6.2, ISM Code 6.3, ISM Code 6.5, and STCW 1/14-5, the training centres are looking for ECDIS suppliers to cooperate with. The training centres are especially looking for accreditation by manufacturers, exclusivity, and cheap equipment that can support type-specific ECDIS training, easy access to customers/trainees to provide fast return on investment, and easy establishment of training business. The training centres are not positively inclined towards CBT and WBT, because CBT and WBT are in direct competition with the training centres. On the other hand, the ship owners may prefer CBT and WBT. FIG. 25 illustrates the conflict between the goals of the training centres, the goals of the ship owners, and manufacturers' requests concerning training systems.

State-of-the-art manufacturers of training systems have chosen either the training centre approach, or the CBT or WBT approach. FIGS. 26 and 27 illustrate state-of-art training systems available from various manufacturers.

The present approaches to training of seafarers therefore present multiple drawbacks. Some training systems compromise on value and quality, and substantially all CBT/WBT approaches compete with the training centres. This leads to additional costs for training and delays in providing training services to ships, as well as restrictions in the training that can be performed via CBT/WBT.

### SUMMARY OF THE INVENTION

Disclosed embodiments of the present invention provide Computer Aided Training systems, methods and apparatuses. According to a first aspect of the present invention, a Computer Aided Training system comprises a workstation providing a simulation of a device, the workstation being configured to connect to a cloud environment and to access a training application that comprises training for the device, wherein the training application is hosted on the cloud environment.

According to a second aspect of the present invention, a Computer Aided Training system, the system comprises: a cloud server which belongs to a cloud environment, the cloud server hosting a training application that comprises training for a device, wherein the cloud server delivers the training application to a workstation which is configured to connect to the cloud environment, and provides a simulation of the device.

According to a third aspect of the present invention, a method of distributing training to a user to qualify the user for operating a device comprises: producing a simulation of the device, and distributing, via a network, a training application for the device to a location of the user, the training application providing training using the simulation of the device.

According to a fourth aspect of the present invention, a computer readable storage medium stores a computer program, the computer program when executed causes a processor to perform the step of distributing to a location of a user, via a cloud environment, a training application for a device, the training application providing training using a functional simulation of the device at the location of the user.

### BRIEF DESCRIPTION OF THE DRAWINGS

Further aspects and advantages of the present invention will become apparent upon reading the following detailed description in conjunction with the accompanying drawings. The accompanying drawings, which are incorporated in and constitute a part of this specification, illustrate several embodiments of the invention and together with the description, serve to explain the principles, features and aspects of the invention.

It may be appreciated that the diagrams are examples of the system environment and the components within the apparatuses of the present invention, and the information depicted therein may be configured in a different manner, as may be appreciated by one skilled in the art.

FIG. 1 is a general block diagram of a NavSkills Computer Aided Training (CAT) system environment, according to an embodiment of the present invention;

FIG. 2 is an exemplary block diagram of a NavSkills CAT system environment based on cloud computing, according to an embodiment of the present invention illustrated in FIG. 1;

FIG. 3 illustrates another exemplary block diagram of a NavSkills CAT system environment based on cloud computing, according to an embodiment of the present invention illustrated in FIG. 1;

FIG. 4 illustrates another exemplary block diagram of a NavSkills CAT system environment based on cloud computing, according to an embodiment of the present invention illustrated in FIG. 1;

FIG. 5 illustrates another exemplary diagram of a NavSkills CAT system environment including training workstations, according to an embodiment of the present invention illustrated in FIG. 1;

FIG. 6 is an exemplary block diagram illustrating components customized by Furuno for NavSkills CAT system environment, according to an embodiment of the present invention illustrated in FIG. 1;

FIG. 7 illustrates exemplary implementations of NavSkills CAT training systems, apparatuses and methods of the present invention for various customer groups, according to an embodiment of the present invention;

FIG. 8A is a block diagram for an exemplary NavSkills CAT workstation used for training on the NavSkills CAT platform, according to an embodiment of the present invention illustrated in FIG. 1;

FIG. 8B is a block diagram for an exemplary NavSkills CAT workstation used for ECDIS training on the NavSkills CAT platform, according to an embodiment of the present invention illustrated in FIG. 8A;

FIG. 8C is another image of an exemplary NavSkills CAT workstation used for training on the NavSkills CAT platform, according to an embodiment of the present invention illustrated in FIG. 8A;

FIG. 8D illustrates exemplary monitors with screenshots and NavSkills CAT ECDIS keyboards for ECDIS training using NavSkills CAT, according to an embodiment of the present invention illustrated in FIG. 8A;

FIG. 8E illustrates an exemplary ECDIS exercise display during NavSkills CAT training, according to an embodiment of the present invention illustrated in FIG. 8A;

FIG. 8F illustrates an exemplary Conning Information display during NavSkills CAT training, according to an embodiment of the present invention illustrated in FIG. 8A;

FIG. 8G illustrates an exemplary visual simulation display during NavSkills CAT training, according to an embodiment of the present invention illustrated in FIG. 8A;

FIG. 9 is an exemplary block diagram of a NavSkills CAT system, according to an embodiment of the present invention illustrated in FIG. 1;

FIG. 10A is a flow diagram illustrating a training flow process for an exemplary NavSkills CAT platform, according to an embodiment of the present invention illustrated in FIG. 9;

FIG. 10B is a flow diagram illustrating in more detail a training flow process for an exemplary NavSkills CAT platform, according to an embodiment of the present invention illustrated in FIG. 9;

FIG. 11A is a flow diagram illustrating an exemplary process flow for startup and/or login into a NavSkills CAT platform, according to an embodiment of the present invention illustrated in FIG. 9;

FIG. 11B is a flow diagram illustrating in more detail an exemplary process flow for startup and/or login into a NavSkills CAT platform, according to an embodiment of the present invention illustrated in FIG. 11A;

FIG. 12 is a flow diagram illustrating in additional detail an exemplary process flow for startup and/or login into a NavSkills CAT platform for a new user or for a pre-registered user, according to an embodiment of the present invention illustrated in FIG. 11A;

FIG. 13A illustrates an exemplary interconnection diagram for an ECDIS equipment for which training may be provided on a NavSkills CAT platform, according to an embodiment of the present invention;

FIGS. 13B and 13C illustrate exemplary system configurations for another ECDIS equipment for which training may be provided on a NavSkills CAT platform, according to an embodiment of the present invention;

FIG. 14A is a flow diagram illustrating an exemplary process flow for accessing and conducting training on a NavSkills CAT platform, according to an embodiment of the present invention illustrated in FIG. 9;

FIG. 14B is a flow diagram illustrating in more detail an exemplary process flow for accessing and conducting training on a NavSkills CAT platform, according to an embodiment of the present invention illustrated in FIG. 14A;

FIG. 15 illustrates an exemplary screen that appears when a user selects “user profile” when conducting training on a NavSkills CAT platform, according to an embodiment of the present invention illustrated in FIG. 14A;

FIG. 16 is a flow diagram illustrating an exemplary process flow for user and certificate control in a NavSkills CAT platform, according to an embodiment of the present invention illustrated in FIG. 9;

FIG. 17A illustrates an exemplary monitor set for use in an exemplary NavSkills CAT workstation, according to an embodiment of the present invention;

FIG. 17B illustrates an exemplary desktop that appears after a monitor set for a NavSkills CAT workstation is turned on, according to an embodiment of the present invention;

FIG. 17C illustrates an exemplary login screen that appears when a user wishes to use the NavSkills CAT system, according to an embodiment of the present invention;

FIG. 17D illustrates another exemplary login screen that appears when a user wishes to use the NavSkills CAT system, according to an embodiment of the present invention;

FIG. 17E illustrates an exemplary login screen in NavSkills CAT that appears when the user selects registration as a new user, according to an embodiment of the present invention;

FIG. 17F illustrates another exemplary screen in NavSkills CAT presented to a user for login and registration, according to an embodiment of the present invention;

FIG. 17G illustrates an exemplary screen in NavSkills CAT presented to a user for editing or changing profile information during login/registration, or at other steps during training, according to an embodiment of the present invention;

FIG. 17H illustrates an exemplary login screen in NavSkills CAT that appears when the user selects the existing or preregistered user login option, according to an embodiment of the present invention;

FIG. 17I illustrates an exemplary screen in NavSkills CAT that allows login as an existing or preregistered user, according to an embodiment of the present invention;

FIG. 17J illustrates another exemplary screen in NavSkills CAT that allows the login as an existing or preregistered user, according to an embodiment of the present invention;

FIG. 17K illustrates an exemplary screen shot when a NavSkills CAT application is initializing, according to an embodiment of the present invention;

FIG. 17L illustrates an exemplary screen in NavSkills CAT that appears after login and enables the user to select the equipment in which training needs to be performed, according to an embodiment of the present invention;

FIG. 17M illustrates another exemplary screen in NavSkills CAT that appears after login, and enables the user to select the equipment in which training needs to be performed, according to an embodiment of the present invention;

FIG. 17N illustrates an exemplary screen in NavSkills CAT that illustrates selected equipment for training, according to an embodiment of the present invention;

FIG. 17O illustrates an exemplary initialization screen for starting the equipment training that was selected by the user in NavSkills CAT, according to an embodiment of the present invention;

FIG. 17P illustrates an exemplary screen on which training, free run or user profile may be selected in NavSkills CAT, according to an embodiment of the present invention;

FIG. 17Q illustrates an exemplary screen in NavSkills CAT for user training by demonstration, according to an embodiment of the present invention;

FIGS. 17R, 17S and 17T illustrate exemplary screens in NavSkills CAT for user training in exercise mode, according to an embodiment of the present invention;

FIG. 17U illustrates an exemplary screen in NavSkills CAT for user training in IOD mode, according to an embodiment of the present invention;

FIG. 17V illustrates an exemplary screen menu in NavSkills CAT including buttons with which the user can select various options, according to an embodiment of the present invention;

FIGS. 18A-18U illustrate screens of an exemplary user interface for conducting training on a NavSkills CAT platform, according to an embodiment of the present invention illustrated in FIG. 9;

FIG. 19A is a diagram illustrating an exemplary NavSkills CAT training setting, according to an embodiment of the present invention;

FIG. 19B is a diagram of a set-up including workstation(s) and training center(s) which provide training in a NavSkills CAT platform based on cloud computing, according to an embodiment of the present invention;

FIG. 20 is a diagram illustrating exemplary training centers set-up for deployment of a NavSkills CAT platform based on cloud computing, according to an embodiment of the present invention;

FIG. 21 is a diagram illustrating exemplary deployment of a NavSkills CAT platform at Furuno INS training centers, according to an embodiment of the present invention;

FIG. 22 illustrates some pictures from Furuno INS Training centers, according to an embodiment of the present invention;

FIG. 23 illustrates current and planned centers for Furuno NavSkills CAT network of training centres, according to an embodiment of the present invention;

FIG. 24 illustrates a comparison between an exemplary NavSkills CAT training platform for ECDIS according to an embodiment of the present invention, and CBT/WBT training for ECDIS;

FIG. 25 illustrates conflicts between preferences of training centres and preferences of ship owners in connection with training for seafarers;

FIGS. 26 and 27 illustrate state-of-art training systems available from various manufacturers;

FIGS. 28A-28D illustrate an exemplary ECDIS system FEA 2107/2807 for which training may be performed on the NavSkills CAT platform, according to an embodiment of the present invention illustrated in FIG. 1; and

FIGS. 29A-29E illustrate another exemplary ECDIS system FMD-3200/3300 for which training may be performed on the NavSkills CAT platform, according to an embodiment of the present invention illustrated in FIG. 1.

### DETAILED DESCRIPTION

The present invention discloses Computer Aided Training (CAT) systems, apparatuses and methods which enable interactive training via a network, such as, for example, the World Wide Web (WWW). The CAT systems, apparatuses and methods of the present invention, herein referred to as NavSkills CAT, may employ various communication protocols to enable interactive training.

The training approach of the present invention is not a competitor to training centres, in contrast with CBT/WBT approaches. Instead, the training systems, methods and apparatuses of the present invention may be implemented as an added business to a training centre set-up or network. The present invention may be implemented for navigational product/equipment training and retrofit training. The present invention may be implemented for maritime training, as well as training in other fields besides the maritime environment, such as, for example, for equipment used in other industries in which usage standards have to be passed to operate the equipment. For example, the present invention may be implemented for aviation or underwater equipment training.

In one embodiment, the NavSkills CAT platform system is implemented via a networking technology that uses a network to maintain data and deploy the training platform. Thus, computing resources may be delivered as a service over the network. The network may be, for example, the Internet, but other networks may also be used.

Examples of networking technologies that use a network and server(s) are cloud computing and client/server environment, this list not being exhaustive. Cloud computing types include public cloud, community cloud, hybrid cloud and private cloud, this list not being exhaustive.

In an exemplary embodiment, the NavSkills CAT platform system is based on cloud computing. The NavSkills CAT cloud computing platform can deliver complicated training for navigational equipment with high functionality and detail, and an effective communications interface as needed.

The present invention is therefore not merely a Computer-Based Training or a Web-Based Training system.

NavSkills CAT is a flexible, adaptable, and accessible training platform that can implement training modules taking into account requirements and preferences coming from International Maritime Organization (IMO), flag states, Port state control, Vetting institutions, Protection and Indemnity (P&I) clubs, customers, existing training institutes, manufacturers, crewing agents/companies, etc. All of these entities influence training needs for maritime training.

Some exemplary embodiments of the present invention are described below in the context of Electronic Chart Display and Information Systems (ECDIS) type-specific training or generic training and retrofit training, for learning how to operate ECDIS. However, the ECDIS systems mentioned in the present disclosure do not limit the applicability of the NavSkills CAT platform of the present invention, as NavSkills CAT may be customized to provide training on any type of navigational equipment, and not only on ECDIS equipment. The present invention is not limited to ECDIS training, and may be implemented for generic or type-specific training for other navigational systems (also referred to as “navigational products” or “navigational equipment” herein), for the maritime and water-based environment. For example, NavSkills CAT may provide training for learning how to operate a radar, a chart radar, an automatic radar plotting aid (ARPA), a Bridge Navigational Systems (e.g., Bridge Navigational Watch Alarm System—BNWAS, BR-500 and BR-1000), a sonar, various electronic chart systems, safety systems (e.g., Global Maritime Distress and Safety System—GMDSS), Identification Systems (e.g., Automatic Identification System), etc. Furthermore, the present invention is not limited to maritime/water navigation training, and may be implemented for training for other types of environments, such as, for example, underwater, air, space, and land navigation equipment or infrastructure equipment training.

Exemplary NavSkills CAT training courses include generic ECDIS training, type-specific ECDIS training, shore staff ECDIS training, bridge team management/bridge resource management training, track control system training, ship resource management training, generic Integrated Bridge System (IBS) training, and type specific IBS training. This list is not exhaustive, as other suitable navigation/maritime training courses may be provided on the same NavSkills CAT platform.

As mentioned above, regulations regarding qualification of seafarers are provided by STCW (internet link at http://www.stcw.org/) and ISM (internet link at http://www5.imo.org/SharePoint/mainframe.asp?topic_id=287). STCW 2010 Regulation 1/14 and ISM Code 6.2, 6.3 and 6.5 set rules regarding training and qualifications of seafarers.

For example, the Electronic Chart Display and Information System (ECDIS) is a computer-based navigation information system that complies with International Maritime Organization (IMO) regulations. The following internet link provides more information regarding ECDIS: http://en.wikipedia.org/wiki/Electronic_Chart_Display_and_information_System. ECDIS requires training for seafarers to obtain a certification to operate it.

Compliance with the navigation regulations is ensured through training of seafarers. Conventionally, training centers provide training to certify for operating ECDIS. For example, some makers, such as JRC, Transas, L3 SAM, Raytheon and Sperry Marine, have their own training centers. Furuno also has such training centers in Denmark (Furuno INS Training Centre Denmark) and in Singapore (Furuno INS Training Centre Singapore). Details of these

centers can be found at the following internet links: http://www.thedigitalship.com/conferences/2006/displaynews.asp?NewsID=1863 and http://www.furuno.com/special/en/instc/about/index.html.

ECDIS training typically has two grades in its certification. One training grade is for general understanding of ECDIS. This is the generic training defined by IMO in the standard IMO ECDIS Model Course 1.27. The other training grade is for the specific apparatus, and is referred to as type-specific or ship-specific ECDIS training. The generic ECDIS training requires “classroom training”. The type-specific or ship-specific ECDIS training, on the other hand, can be conducted as classroom training, Computer-Based Training (CBT), Web-Based Training (WBT), On-Board Training (OBT) or On-Location Training (OLT). CBT and WBT provide one-way training. OBT and OLT provide interactive training. On-Board Training refers to training onboard a vessel.

The NavSkills CAT training systems, methods and apparatuses of the present invention provide a new training platform for maritime training courses including the type-specific training and the generic training, with built-in assessment and certification of individuals. The training may be obtained through a PC or workstation operated locally by the trainee and connected to a cloud server which runs the training application software, and which provides a communication link between trainee and instructors. Exemplary communication links may be provided using VoIP (Voice over Internet Protocol), VoLTE (Voice over LTE—Long Term Evolution), EV-DO (Evolution-Data Optimized or Evolution-Data Only), CDMA (Code Division Multiple Access Communication), video streaming, HSPA (High Speed Packet Access), and/or HSPA+ (Evolved High Speed Packet Access). In a preferred embodiment, communication is established via VoIP, VoLTE and/or video streaming.

The NavSkills CAT training systems, methods and apparatuses include a server system between a training center and each seafarer who needs to take the training. In one embodiment, the server system is a cloud server system. The seafarer runs the training application software from the cloud server having the option to connect to an instructor, who can advise and guide the seafarer through the training application using one or more communication systems such as VoIP, VoLTE, and/or video streaming.

Aspects of the invention are more specifically set forth in the accompanying description with reference to the appended figures.

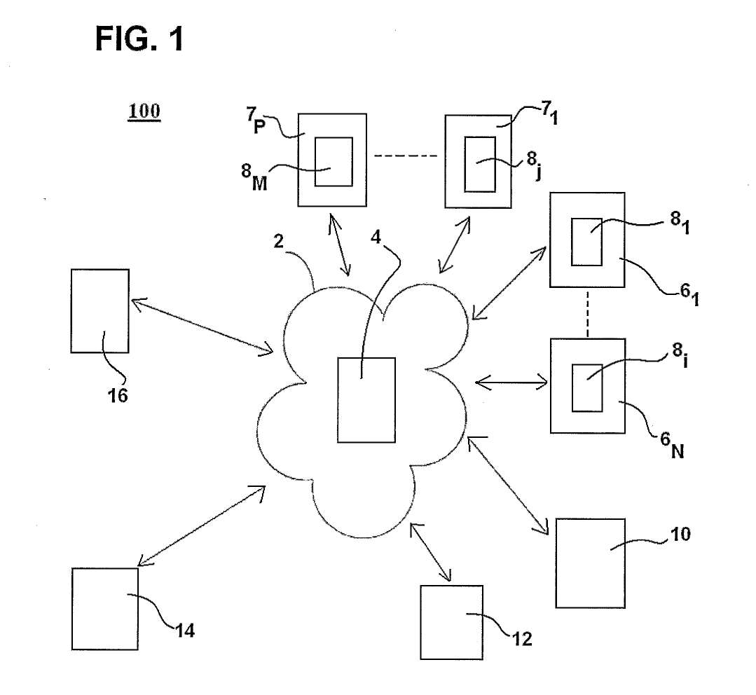

FIG. 1 is a general block diagram of a NavSkills Computer Aided Training (CAT) system environment 100, according to an embodiment of the present invention. The system architecture illustrated in FIG. 1 depicts a system environment in which systems, methods, apparatuses, computer-readable media and data structures consistent with the principles of some embodiments of the present disclosure may be included. It may be appreciated that the components of system environment 100 may be implemented through any suitable combinations of hardware, software, and/or firmware.

As shown in FIG. 1, one or more servers 4 deliver services to clients which may be in various locations, countries, etc., at a training center, on a ship, or at other location. The server 4 may include a hosted or owned server, application software, processing implementation, data sharing capability, as well as other capabilities depending on training requirements. The server 4 may include computer hardware and/or computer software and packages, multi-core processors, cloud-specific operating systems, combined/hybrid systems, etc.

The server 4 belongs to a network 2, which may be implemented as the Internet, or any local or wide area network, either public or private. Network 2 may also include a hardware system physically connecting some or all of the units 6, 7, 8, 10, 12, 14 and 16. Network 2 may utilize browser applications available from, e.g., Microsoft, Mozilla, Netscape, etc., other software for connecting to an item/page/interface/application package, etc. available on the network, a connector to, e.g., HTTP, SMS, etc.

In one embodiment, the NavSkills CAT platform is based on cloud computing, such that network 2 is a cloud system and server 4 is a cloud server.

Network 2 and server 4 communicate with: one or more control centers 10; clients 6₁ . . . 6_{N} and dedicated training centers 7₁ . . . 7_{P} which may have NavSkills CAT workstations 8₁ . . . 8_{M}; training management center 12, which may be provided separate or in connection with the control centers 10; one or more vetting administrations 14; and one or more helpdesks 16. Thus, network 2 and server 4 establish communication between control centers, dedicated training centers, and clients using dedicated workstations, and further between training management center, vetting administrations, and helpdesks as needed.

The control center 10 communicates with the server 4 to perform or direct various functions such as installation of application software, application software updates, maintenance, etc. The application software updates may be installed in connection with issued updates in training regulations and requirements.

Clients 6₁ . . . 6_{N} may be entities or individuals who need to perform training for operating certain navigational equipment. Exemplary clients are ship owners, ship/crewing agents, classroom training facilities, Computer-Based Training (CBT) facilities, Web-Based Training (WBT) facilities, On-Board Training (OBT), On-Location Training (OLT) facilities, etc.

Exemplary dedicated training centers 7₁ . . . 7p may be Furuno INS Training Centers (INSTC). NavSkills CAT workstations 8₁ . . . 8_{M} are dedicated workstations that deliver the NavSkills CAT training experience, as described in more detail below.

Training management center 12 performs control and monitoring functions such as, for example, monitoring the training system performance, assessing trainees, providing certification for trainees upon successful completion of the course, and identification and verification of issued certificates.

Vetting administrations 14 communicate with network 2/server 4 to provide and update information concerning navigation regulations, to accept/confirm/validate certificates of trained users, and to request additional training from navigation personnel, as needed.

To achieve outstanding training results, the helpdesk 16 provides online support to the trainees using remote communication. Helpdesk 16 communicates and consults with trainees via various communication channels such as, for example, VoIP, VoLTE, Internet video-chat and video streaming, EV-DO, CDMA, HSPA, HSPA+, etc., to provide help during training, as needed. Helpdesks 16 may be provided as standalone facilities, or may be included in training centers, control centers, and/or training management centers. The helpdesk 16 may be accessible through a soft key on the system screen of a NavSkills CAT workstation 8ᵢ. By activating the help desk function, a trainee is connected to an instructor, who can guide the trainee or answer questions to facilitate the trainee's better understanding of the navigational equipment that the trainee is studying.

Server 4 and NavSkills CAT workstations 8₁ . . . 8_{M} may include input/output devices such as, for example, keyboards, mice, video cams, displays, interactive screens, storage devices, printers, portable recording media, electro-mechanical devices, etc., and may also include personal computing devices, handheld devices, and interfaces with a virtual environment.

It may also be appreciated by one of ordinary skill in the art that while only one server 4, network 2, control center 10, training management center 12, vetting administration 14 and helpdesk 16 are depicted, more servers 4, networks 2, control centers 10, training management centers 12, vetting administrations 14 and helpdesks 16 may reside within the system 100 and connect through network(s) 2. A plurality of networks 2 may be interconnected networks. It is also noted that some of a client 6, training center 7, control center 10, training management center 12, vetting administration 14 and helpdesk 16 may be absent from system environment 100.

The control centers, clients, training centers, training management center, vetting administration and helpdesks may use network applications that include software applications that facilitate communication with server 4 through network 2. The network 2 and server 4, and the control centers, clients, training centers, training management center, vetting administration and helpdesk may include CPUs, purpose built hardware such as, for example, FPGA, ASIC, etc., software systems and applications, software packages, computer readable media such as ROM, RAM, USB, CD, DVD drives and other types of memories, one or more (micro)processors, databases, system connectors, virtual interfaces, website links for accessing NavSkills CAT training, etc., to facilitate establishing, maintaining and closing training and system management sessions within the NavSkills CAT platform, and to record, store, send, receive, and process, as needed, trainee information, and training information and software. Software packages that may be part of network 2 may be recorded on a computer readable medium such as a memory device, RAM, CD/DVD/USB drives, handheld memory device, etc., and/or may be part of a physical device such as one or more (micro)processors or electro-mechanical systems. Also, the server(s) 4, control centers 10, clients 6, training centers 7, training management center 12, and helpdesk 16 may be fixed systems, mobile systems or portable systems. It may be appreciated that various configurations may be implemented providing the functionality discussed herein below is achieved.

The network 2 and server 4 may additionally include components for implementing, adding, or modifying characteristics and training modules in the NavSkills CAT training platform in real-time or off-line, and for implementing security operations. Thus, NavSkills CAT platform may communicate/interface with end-users using hardware, software and hybrid interfaces that can communicate and exchange information with computers and dedicated NavSkills CAT workstations, mobile devices, a network, etc.

Although some units in FIG. 1 are illustrated as discrete elements, it should be recognized that certain operations of some of the various components may be performed by the same physical device, e.g., by one or more (micro)processors or other type of computing devices. Thus, it may be appreciated that the various components of NavSkills CAT platform may reside in or work from the same unit/computing device/(micro)processor or location. Various components of the NavSkills CAT platform may also be separate. For example, various components of the NavSkills CAT platform, such as training modules, management software, certification modules, interfaces, etc., may reside on, or work from separate computing devices or locations, while being connected through the network 4. It may further be appreciated that each of the clients, helpdesks, and centers shown in FIG. 1 may communicate with more than one NavSkills CAT training modules that reside within the same computing device or on different computing devices or on local or remote servers 4 operating within the NavSkills CAT platform on network 2.

When NavSkills CAT application software is operated via a Cloud, the instructor at any training center, helpdesk or at another location can monitor the activities of a trainee and advise him/her accordingly, so that any questions that the trainees may have during the training are resolved on the spot. The instructor may also be able to perform lectures on the training application software which would be accessed by trainees logged into the system.

NavSkills CAT operated via a Cloud also makes it possible to dynamically update the training software on a global scale, on the cloud server. Thus, software updating and/or maintenance may be performed at only one data source location. In this way, seafarers can always take a training course for the latest navigational system/product without commuting to a training center. The NavSkills CAT training software may be stored and periodically updated on the cloud server that subscribers can access for training sessions through the Internet. In this way, subscribers receive up-to-date training applications at all times, without any upgrade of computer software at the subscriber side.

Online access to the latest training programmes for the navigation models on the training cloud server provides the advantage that training can be conducted at the offices of the ship owners, hence saving the cost of transportation and accommodation for the trainees. Moreover, the contents and quality of the training programme is identical to the classroom training provided by a dedicated training center (e.g., INSTC Denmark, INSTC Singapore and Furuno NavSkills Training Centers) which have been designed to conform to the training standards and requirements set out by flag administrations as well as the vetting society.

The cloud server(s) and cloud environment of the NavSkills CAT platform of the present invention may provide training and/or maintenance in connection with: airtime/broadband provisions; manuals/documentation directly available to end users; SMS/Remote Maintenance System; training products such as, for example, Ship Inspection Report Program—SIRE a.o.; and ship data collection and transfer to ship owner.

NavSkills CAT may also realize “multi-instructors”-to-“multi-trainees” training systems, in addition to “one-instructor”-to-“multi-trainees” and “one-instructor” to “one-trainee”, via the cloud server, including VoIP, VoLTE, video streaming or other communication channels. NavSkills CAT may be implemented as a packaged total solution for navigation equipment training and other relevant and suitable maritime training courses, or training courses for other environments and industries.

For maritime navigation and maritime communication-related training courses, the training model of NavSkills CAT platform may be based on and designed according to the general ship operation. In other words, the training system and the implementation may be built up on a frame which covers the operation circle and execution. The training model may include three main elements: pre-departure, voyage and post-voyage. To achieve the training for the various elements, the following training instruments may be used alone or in combination: lecture, demonstration, exercise, and evaluation, as described in more detail below.

The training sessions may consist of step-by-step exercises followed by trainees during the training sessions, and at the end of each step, an assessment session may be presented, which the trainees have to pass to demonstrate their understanding and competence before going onto the next level. Since the trainees may consult with the online instructors available at help desks around the globe, any uncertainty that arises during the training session may be promptly resolved.

NavSkills CAT easily provides updated training programmes for respective equipment, because the training application has to be updated only on the central server, and not the local workstation/PC. Furthermore, NavSkills CAT provides access to the help desk through the network, to ask for advice and guidance from a skilled instructor.

For example, when network 2 is a cloud environment, once the training software is updated on the NavSkills CAT cloud system, everyone can access and use the updated training software without updating one's PC/workstation. This will save significant time for seafarers, especially when training is being updated to comply with new regulations, and when the updated training package has a voluminous electronic size. Since the NavSkills CAT training application software is located, stored and operated on the cloud server, the processing is conducted on the cloud server. The trainee PC/workstation may then provide only the user interface to the training application, so that training application software need not be transferred to the PC/workstation. The seafarer can immediately conduct the training, and can communicate directly with an instructor/teacher to receive advice, lectures and guidance through the connection to the cloud server and VoIP, VoLTE and video streaming. The instructor can monitor the trainee and advise and guide the trainee, over the cloud server. Thus, with the present invention, seafarers do not have to commute to a faraway training center, which will save travel expense and time.

Remote Assessment of the training performed using NavSkills CAT may be accomplished through tests performed in the training application software. The trainee's identity may be registered in the cloud server, using, for example, the trainee's photo and/or fingerprints (obtained using a web camera and/or a fingerprint reader, for example) together with login information and personal information of the trainee (such as, for example, name and birth date), which may all be stored. Each time the trainee logs into the training application, the training system may verify his/her fingerprints and a photo may be taken for verification of his/her identity. During assessment, photos may be taken randomly and stored.

The NavSkills CAT platform therefore provides the ship owner with the total solution for navigational training, including generic and type-specific training for the maritime environment or other types of environments and industries. The NavSkills CAT platform includes a server based training solution, thus providing easy access to training. The NavSkills CAT platform is also a cost efficient solution, since full access to all the training programmes on the NavSkills CAT is provided. NavSkills CAT platform is configured to provide a fully emulated navigation equipment, with a tailor-made training application that may be adjusted based on user training needs, thus providing a flexible and scalable training solution. The training application may be designed by the manufacturer of the equipment on which the user has to train. The training application may also be designed by a collaborative effort between the manufacturer of the equipment and NavSkills CAT platform management.

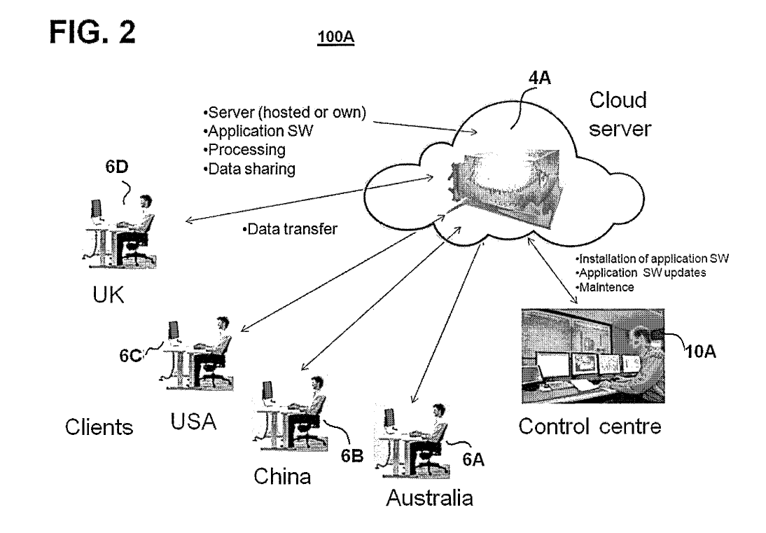

FIG. 2 is an exemplary block diagram of a NavSkills CAT system environment 100A based on cloud computing, according to an embodiment of the present invention illustrated in FIG. 1. As shown in FIG. 2, a cloud server 4A delivers cloud services to clients 6A . . . 6D which may be in various locations and even countries, at a training center, on a ship, or at other location. The cloud server 4A may include a hosted or owned server, application software, processing implementation, data sharing capability, as well as other capabilities depending on training requirements. The cloud server 4A may include computer hardware and/or computer software and packages, multi-core processors, cloud-specific operating systems, combined/hybrid systems, virtual applications, etc.

A control center 10A communicates with cloud server 4A to perform or direct various functions such as installation of application software, application software updates, maintenance, etc. Since the training application software is operated via the cloud, an instructor at any training center or at another location can monitor the activities of the trainee and advise him/her accordingly. The instructor may also be able to present lectures on the training application software which would be accessed by trainees logged into the system. The cloud server 4A also communicates with clients 6A . . . 6D for transferring data to them and receiving data from the clients depending on the training that the clients perform.

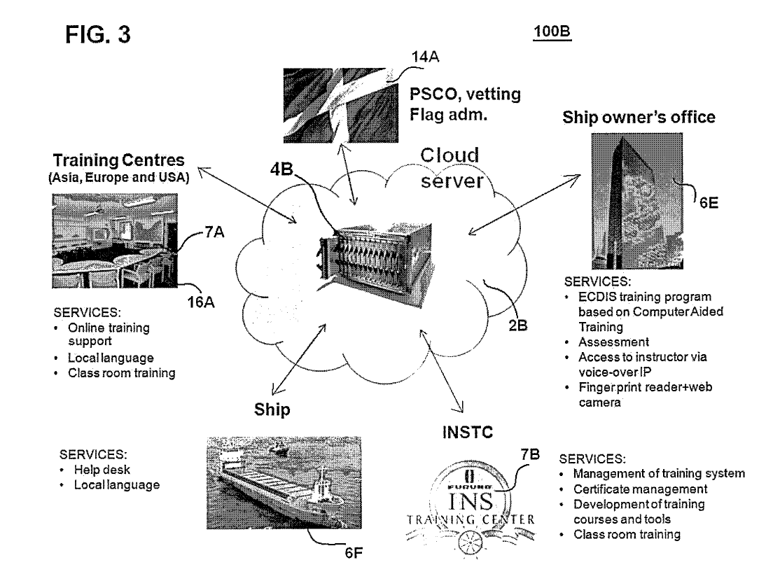

FIG. 3 illustrates another exemplary block diagram of a NavSkills CAT system environment 100B based on cloud computing, according to an embodiment of the present invention illustrated in FIG. 1. In the system in FIG. 3, the cloud server 4B communicates with training centers 7A which may be located anywhere, with ships 6F, with Furuno INS training center 7B, with ship owner's office 6E and with Port State Control Officer (PSCO)/vetting flag administration 14A.

To the training centers 7A, cloud server 4B delivers cloud services such as online training support in various languages including local language. Thus, classroom training may be provided at training centers 7A, using the cloud contents. In this way, the cloud server 4B can provide online training support in any language, as well as classroom training via the training centers 7A.

Cloud server 4B may deliver similar cloud services to ship 6F and may also provide help desk assistance in various languages which may include a local language, through helpdesks 16A which may be included in some training centers 7A. Cloud server 4B also communicates with Furuno INS training center 7B to provide various services such as management of the NavSkills CAT training system, certificate management, development of training courses and tools, and classroom training.

The communication between cloud server 4B and ship owner's office 6E may provide services to implement equipment training program such as, for example, ECDIS training based on computer aided training, assessment of individual training results, access to instructor via voice-over IP or VoLTE, and identification, data exchange and storage using fingerprint reader(s) and web camera(s).

Cloud server 4B may also communicate with the PSCO and vetting flag administration(s) 14A to provide certification data as required by PSCO and/or flag administration(s), and to receive certification requests and updates concerning regulations from PSCO and/or or flag administration(s) 14A.

As shown in FIG. 3, communication between cloud server 4B and the illustrated entities 7A, 6F, 7B, 6E, 16A and 14A is bi-directional, such that the entities 7A, 6F, 7B, 6E, 16A and 14A both receive data from and transmit data to the cloud server 4B; similarly, cloud server 4B both transmits required or requested data, and receives data from entities 7A, 6F, 7B, 6E, 16A and 14A. That is, training and certification within the NavSkills CAT platform is performed interactively, based on reciprocal data exchange and reciprocal information processing between the cloud server 4B and the entities 7A, 6F, 7B, 6E, 16A and 14A in the cloud environment 2B.

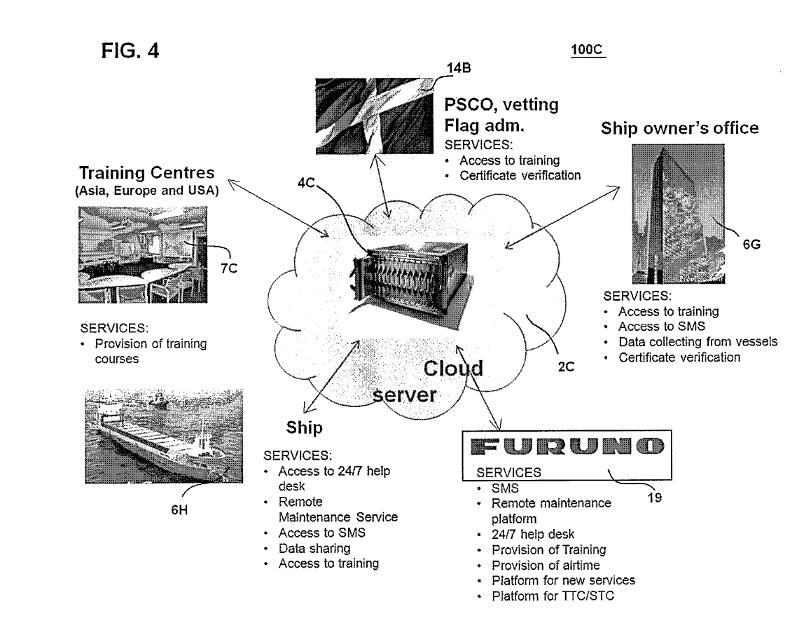

FIG. 4 illustrates another exemplary block diagram of a NavSkills CAT system environment 100C based on cloud computing, according to an embodiment of the present invention illustrated in FIG. 1.

In the system in FIG. 4, the cloud server 4C communicates with training centers 7C which may be located anywhere, and with ships 6H, with Furuno services module 19, with ship owner's office 6G and with Port State Control Officer/vetting flag administration 14B. To the training centers 7C, cloud server 4C delivers cloud services such as online training support in various languages including local language, in the form of training courses. Cloud server 4C may deliver the same to ship 6H and may provide 24/7 access to help desk(s), remote maintenance service, access to SMS, data sharing and access to training.

The communication between cloud server 4C and Furuno services module 19, which may be a separate center and/or an online service provision, may provide various services such as SMS capability, remote maintenance platform, 24/7 help desk, provision of training, provision of airtime, platform for new services and platform for Target Tracking Console (TTC)/Sensitivity Time Control (STC). These services may then be provided via Furuno services module 19 to local trainees, or to remote trainees, via the Cloud 2C.

The communication between cloud server 4C and ship owner's office 6G may implement services such as access to training, access to SMS, data collecting from vessels and certificate verification. Cloud server 4C may also communicate with Port State Control Officer and vetting flag administration(s) 14B to provide data required by PSCO and/or flag administration(s), provide access to training, verify certificates, and receive requests from PSCO and/or or flag administration(s).

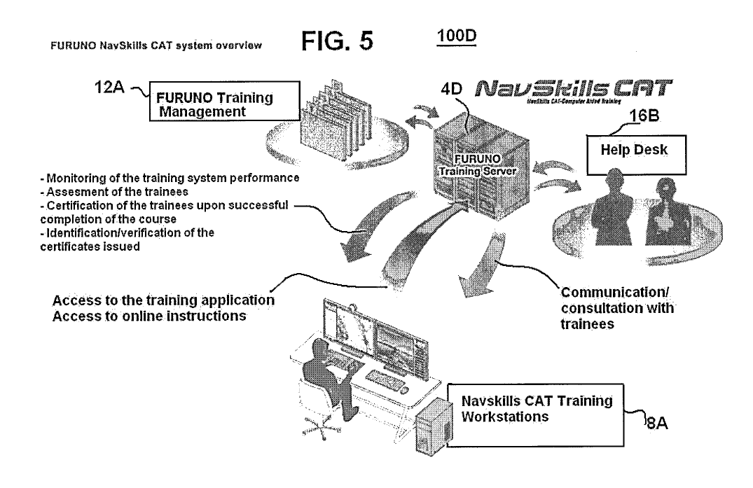

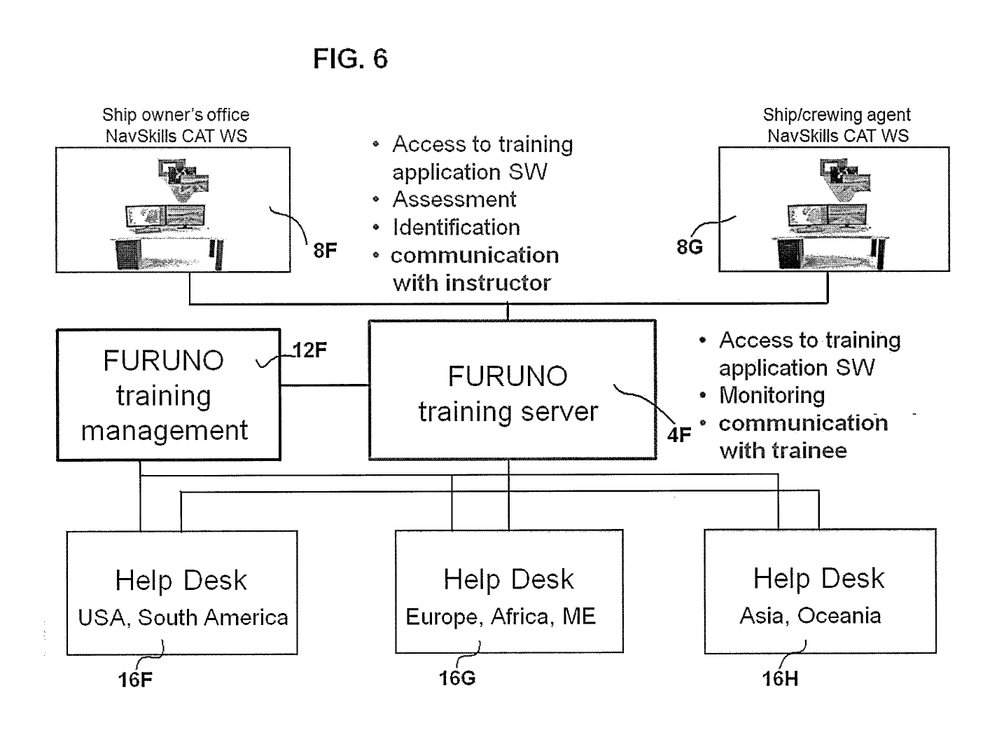

FIG. 5 illustrates another exemplary diagram of a NavSkills CAT system environment 100D including training workstations, according to an embodiment of the present invention illustrated in FIG. 1. FIG. 6 is an exemplary block diagram illustrating components customized by Furuno for NavSkills CAT system environment, according to an embodiment of the present invention illustrated in FIG. 1.

FIG. 5 illustrates an exemplary Furuno NavSkills CAT system overview. As shown in FIG. 5, one or more Furuno training servers 4D bi-directionally communicates with helpdesk(s) 16B, with Furuno training management 12A, and with NavSkills CAT training workstations 8A. Thus, bi-directional communication is established between all modules of the system. FIG. 6 similarly illustrates a Furuno training server 4F, a Furuno training management 12F, helpdesks 16F, 16G, 16H at global locations, and NavSkills CAT workstations 8F and 8G located at a ship owner's office and at a ship/crewing agent location, respectively.

The training management monitors the training system performance, assesses trainees, provides certification for trainees upon successful completion of the course, and identifies and verifies issued certificates. For example, as shown in FIG. 6, training server 4F provides access to training application software and enables monitoring and communication with trainees, using training management 12F oversight and helpdesks 16F, 16G and 16H. Via the NavSkills CAT workstations 8F and 8G, training server 4F provides access to training application software and enables assessment and identification of trainees and communication with instructors. Communication with instructors and trainees may be performed, as previously mentioned, via VoIP, VoLTE, video streaming, or other technologies. Such communication may be established through the Furuno training server, which communicates with NavSkills CAT training workstations and with the helpdesks, to provide communication/consultation between the trainees and the helpdesks.

The NavSkills CAT training workstations 8 may be located anywhere. Exemplary locations are offices of ship owners and ship/crewing agents. The NavSkills CAT workstations access the training application using the training server, and access online instructors, and are configured to use VoIP, VoLTE or other types of communication to access online instructors.

The helpdesks may also be located anywhere. An exemplary help desk is the helpdesk at INSTC Denmark.

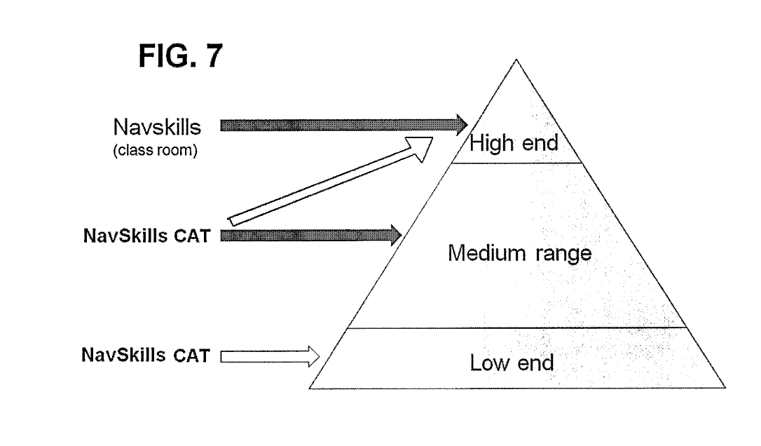

FIG. 7 illustrates exemplary implementations of training systems, apparatuses and methods of the present invention for various customer groups, according to an embodiment of the present invention. For example, the NavSkills CAT training solution of the present invention may be implemented for medium or low range customer groups, while the classroom NavSkills solution may be implemented for high end customer groups. The classroom NavSkills solution is the NavSkills™ training solution described at http://www.furuno.com/en/business_product/merchant/training/navskills/index.html.

Here, it is noted that the term “NavSkills” refers to Furuno's overall crew training concept that provides both classroom training solutions and computer aided training solutions. The classroom training solutions, which include the NavSkills™ training solution, are supported by Furuno navigational equipment interfaced to full mission simulator package and ECDIS simulator systems. The computer aided training solution is realized by NavSkills CAT, which provides various types of training, including type specific and generic training, supported by the Cloud technology. Thus, the NavSkills CAT is incorporated into the NavSkills crew training concept, to facilitate type specific and generic training.

The NavSkills™ training solution includes turnkey training solutions that include provision of a full-mission simulator with a navigation bridge fitted with genuine Furuno navigation equipment.

The CAT training solution of the present invention may also be implemented for high end customer groups.

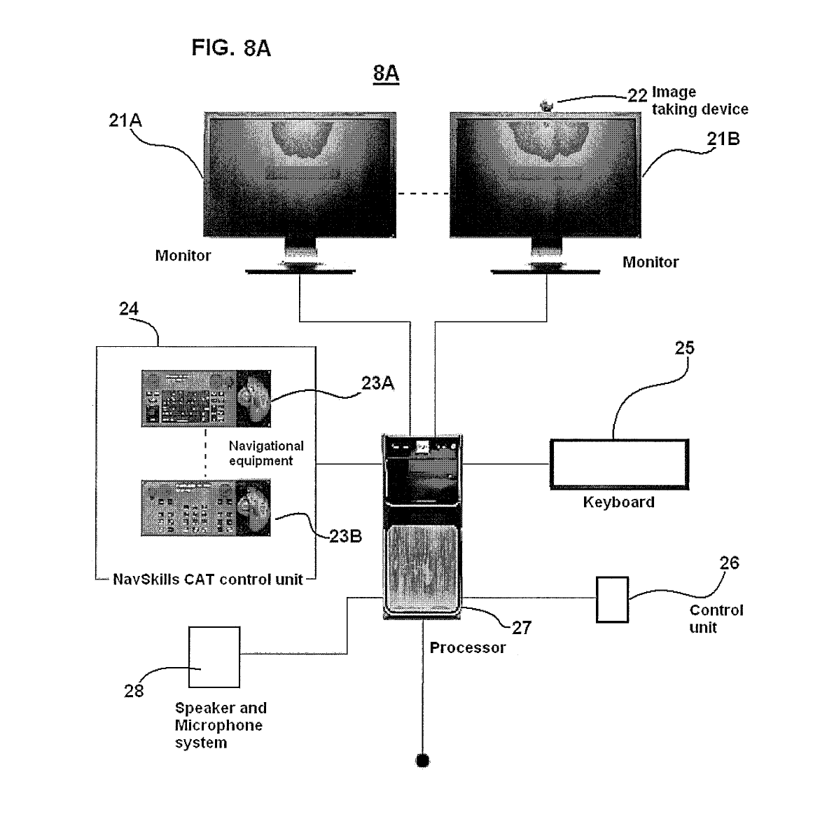

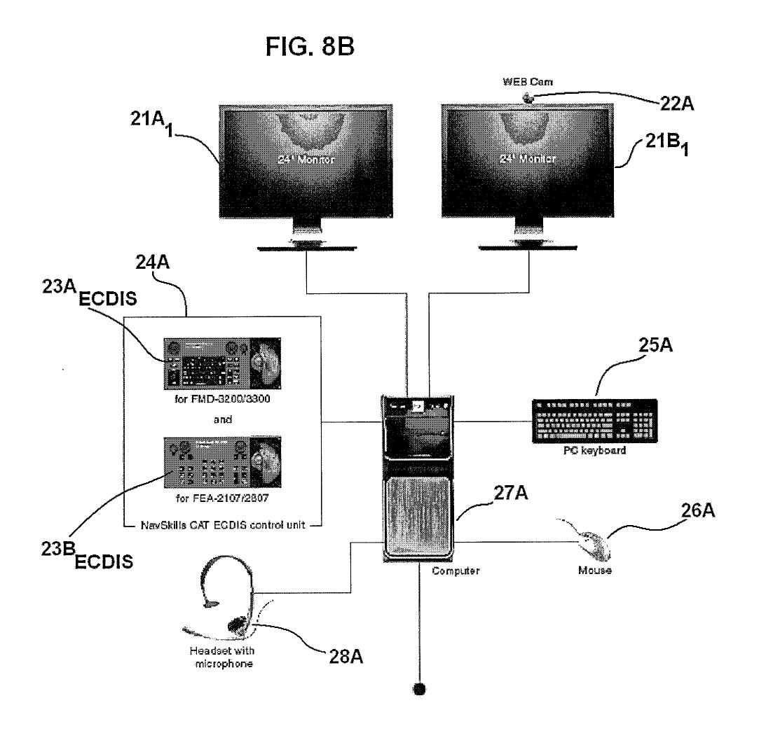

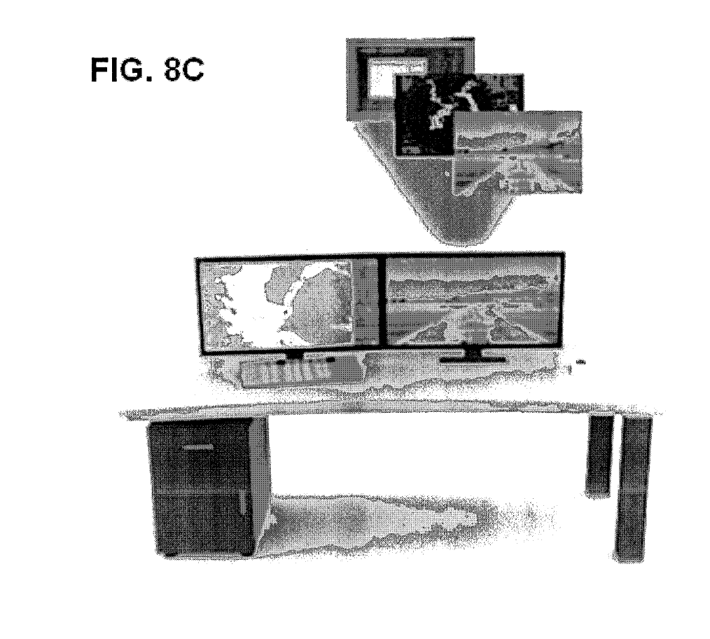

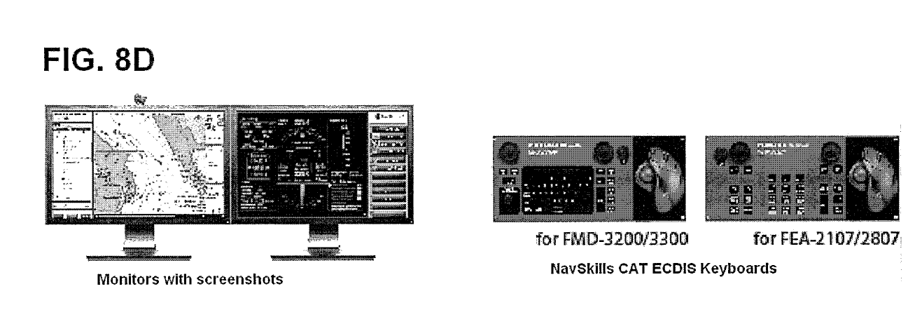

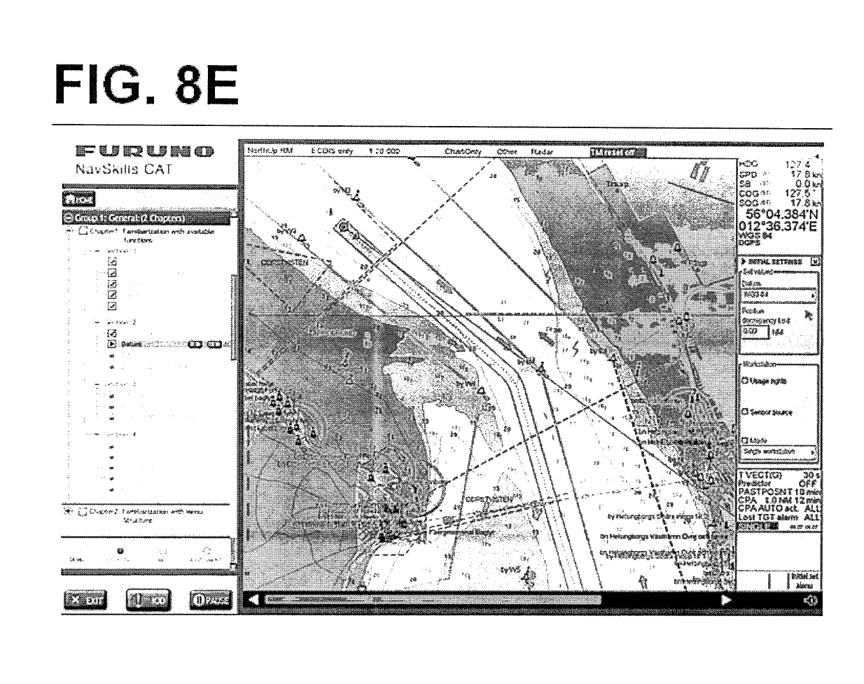

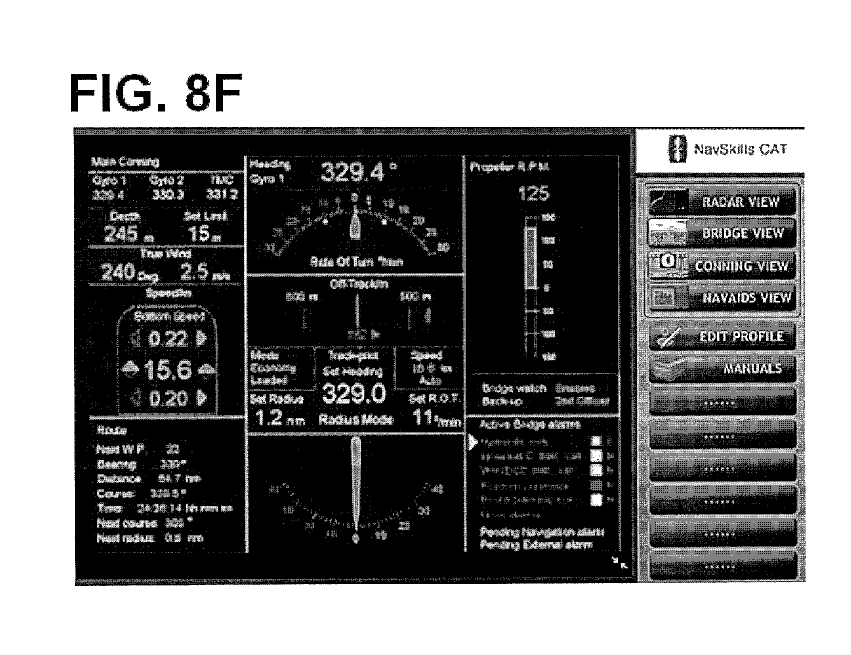

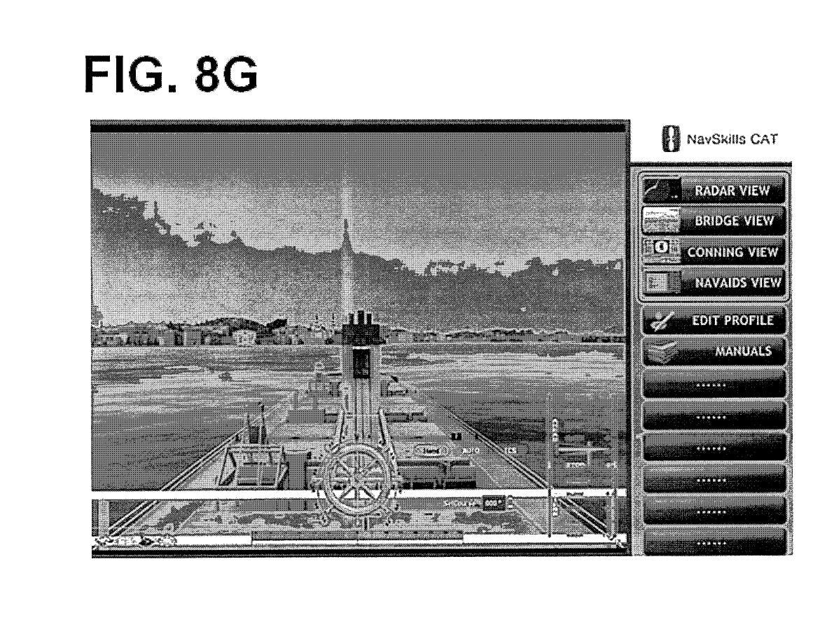

FIG. 8A is a block diagram for an exemplary NavSkills CAT workstation used for training on the NavSkills CAT platform, according to an embodiment of the present invention illustrated in FIG. 1.

As shown in FIG. 8A, an exemplary NavSkills CAT workstation includes an image taking device 22, a number N (which can be 1, 2 or more than 2) of monitors 21A, 21B, etc., or other type of visual interface devices, a control unit 26, a keyboard or other type of input/output control device 25, a speaker and microphone system 28, a NavSkills CAT control unit 24 including options for training on one or more of a number M of navigational equipment systems 23A, 23B, etc., and one or more processors 27 connected to the various components of the NavSkills CAT workstation. In an exemplary embodiment, the navigational equipment systems 23 are Furuno Control Heads.

The NavSkills CAT workstation also includes an operating system and a necessary license to access the NavSkills CAT cloud environment. The workstation may also be configurable to receive and hold the license permissions when necessary, e.g., when the workstation is deployed to a trainee. In an exemplary implementation, the workstation is PC-based. In an exemplary implementation, the operating system is the Linux or Windows 7 operating system.

The processor 27 may be a PC workstation/standard PC computer or other type of visual interface processor, with virtual software. The control unit 26 may be a PC mouse or another input/output control device, such as, for example, a specialized control unit which may be a mouse-joystick system, or a mouse-type control unit such as a gaming mouse as those used in the electronic gaming industry. The input/output control device 25 in the NavSkills CAT workstation may be a standard keyboard, a display with an interactive screen, a storage device, a portable recording medium or a portable electronic device such as a phone, IPAD, laptop, etc., an electro-mechanical device such as a joystick, etc. The navigational equipment systems 23A, 23B may be a set of systems that include keyboards (also called control heads, or control units, or control panels) which are specialized for different types of equipment on which the user is training. Such specialized keyboards may include multiple keyboard parts such as controls, push keys, trackballs, scroll wheels and thumbwheels, directional keys, knobs, rotary controls, keypads, etc.

In one embodiment, the control head in 23A/23B contains the original printed circuit board of the original control head of the specific navigational equipment for which the user needs to train, extended with an interface and a power supply circuit. In an exemplary embodiment, the interface is a USB interface. The output of the NavSkills CAT control head 23A/23B is forwarded via the NavSkills CAT workstation, over the Internet to the emulated navigational equipment environment on the Cloud system. Thus, the hardware of the original control head of the specific navigational equipment is modified to work in the NavSkills CAT environment, using the added interface (e.g., USB interface) and power supply circuit, as well as modifying existing Power On and Alarm system interface features.

The processor 27 is configured to present the training software on the monitors 21. The processor 27 can be controlled by the input/output control device 25 and the control unit 26 and by the specialized navigational equipment (control heads) 23 in the NavSkills CAT control unit 24. The training application for the navigational equipment will be operated by the control heads 23.

When the NavSkills CAT platform is on a Cloud, the trainee uses the workstation 8A to access a cloud server. The workstation 8A may be provided by Furuno or by another entity such as, e.g., the manufacturer of the respective navigation equipment for which the user is training. The NavSkills CAT workstation 8A is designed to be installed and used anywhere, where an Internet connection (e.g., a broadband Internet connection) is present within the customers' premises, such as office or any of the customer's branch offices. Thus, the training can be conducted at the customers' location or anywhere else where is it convenient for the customer. The NavSkills CAT workstation 8A may accommodate the training environment with the above-described displays, simulation and control heads which are similar to actual navigation equipment used onboard a vessel or in other navigational setting. Because NavSkills CAT provides training via realistic workstations 8A that mimic the actual equipment, NavSkills CAT helps navigators to understand and use all the capabilities of the equipment. In this way, the trainees can learn how to navigate the menus with the specialized control head 23 elements (e.g., track balls, controls, push keys, scroll wheels and thumbwheels, directional keys, knobs, rotary controls, keypads) and how to use the fast keys and controls on the control panel of the control head for fast and easy operation of the navigation equipment. The workstation 8A may be provided by Furuno fully configured as a plug-and-play solution, hence requiring no setting up at the trainee side.

A user can contact and communicate with a training instructor on duty using the training software and the speaker and microphone system 28. The communication may be made via any implementation over the Internet. For example, communication may be implemented via VoIP or VoLTE over an Internet network connection. The image taking device 22 serves to validate the user registration.

FIG. 8B is a block diagram for an exemplary NavSkills CAT workstation used for ECDIS training on the NavSkills CAT platform, according to an embodiment of the present invention illustrated in FIG. 8A. FIG. 8C is another image of an exemplary NavSkills CAT workstation used for training on the NavSkills CAT platform, according to an embodiment of the present invention illustrated in FIG. 8A.

The exemplary NavSkills CAT workstation illustrated in FIG. 8B is for training on ECDIS. The workstation includes a webcam 22A, two monitors 21A₁ and 21B₁, a keyboard 25A, a control unit which is a mouse 26A, a processor which is a computer 27A, a speaker and microphone system which is a headset 28A, and a NavSkills CAT ECDIS control unit 24A including options for training on one or more of a number of navigational equipment systems including FMD-3200/3300 and FEA 2107/2807 ECDIS systems using functional ECDIS keyboards (control heads) 23A_{ECDIS} and 23B_{ECDIS}. The control head 23A_{ECDIS}/23B_{ECDIS} is similar to the actual Furuno ECDIS control head used onboard a vessel for the respective ECDIS.

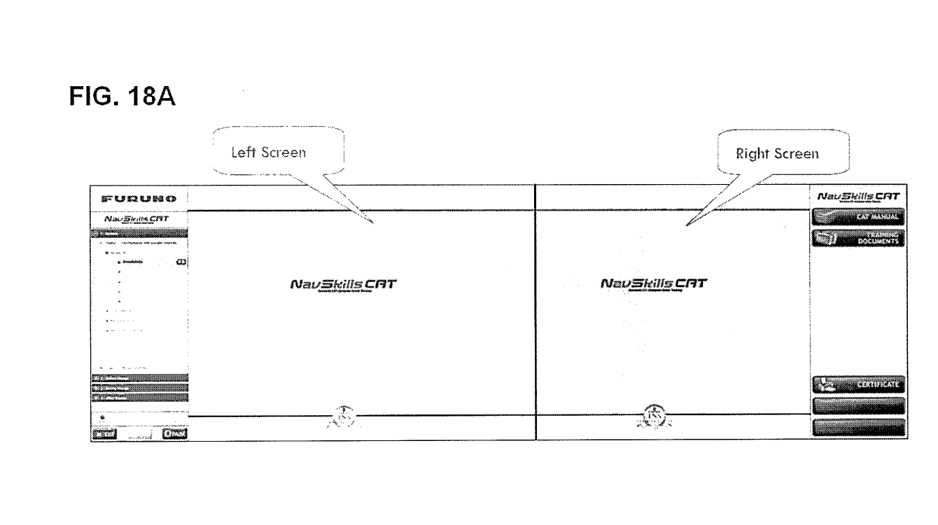

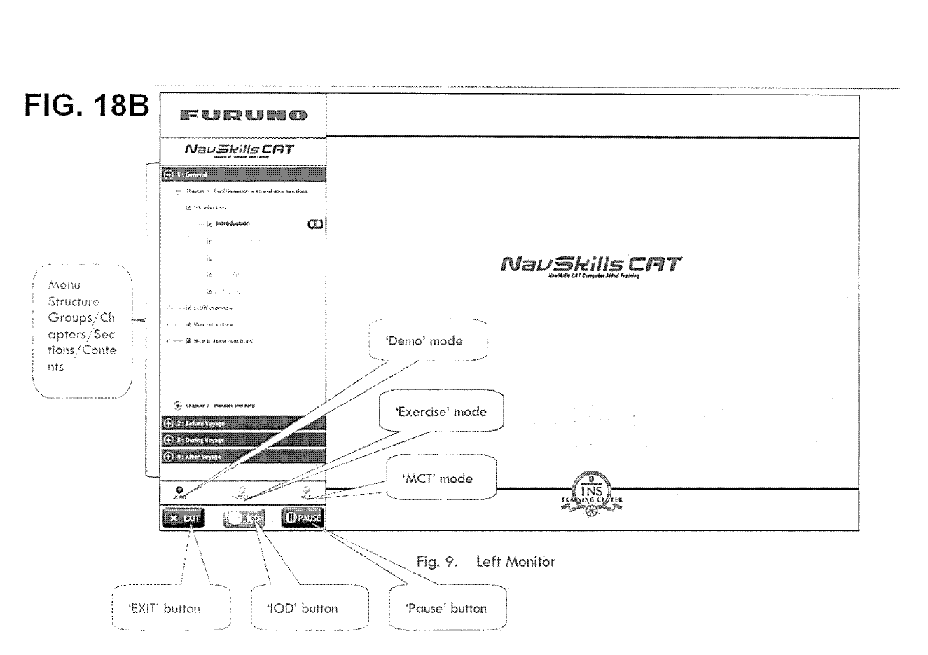

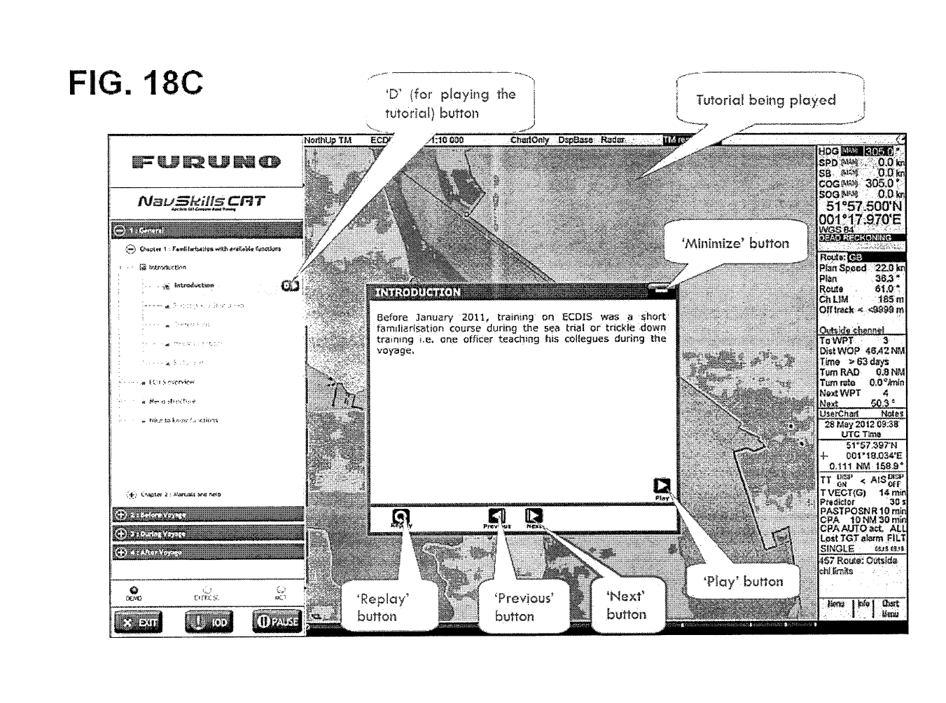

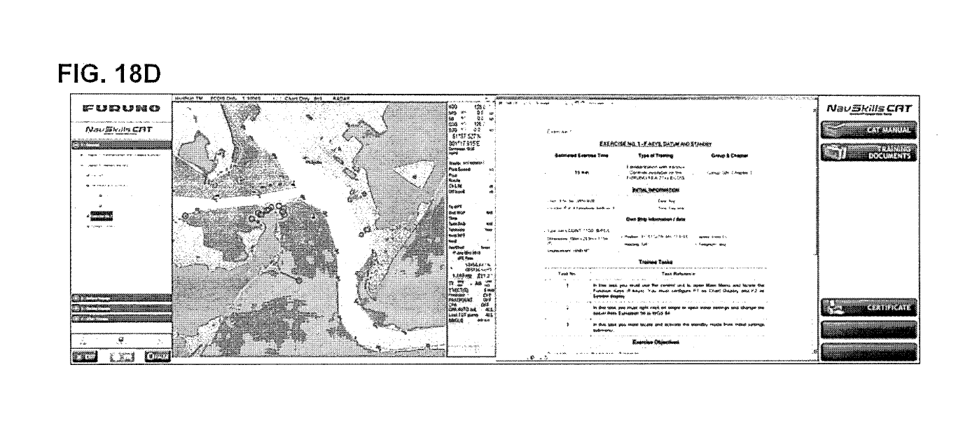

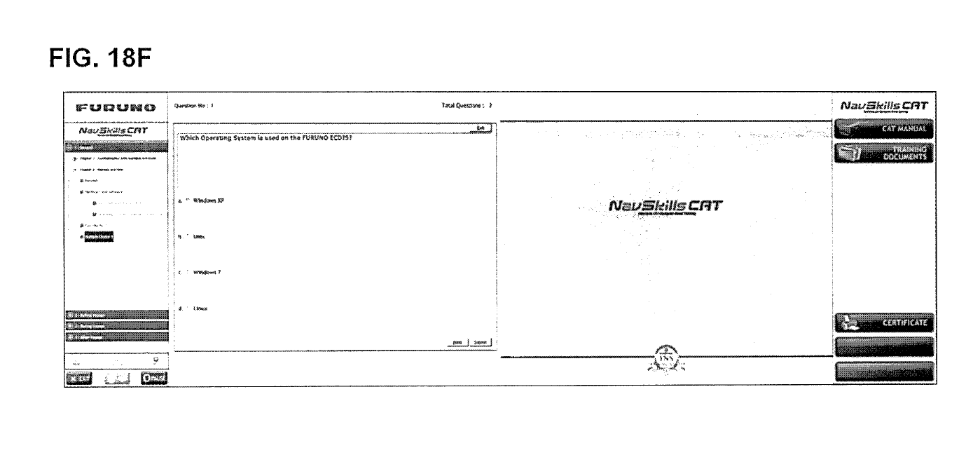

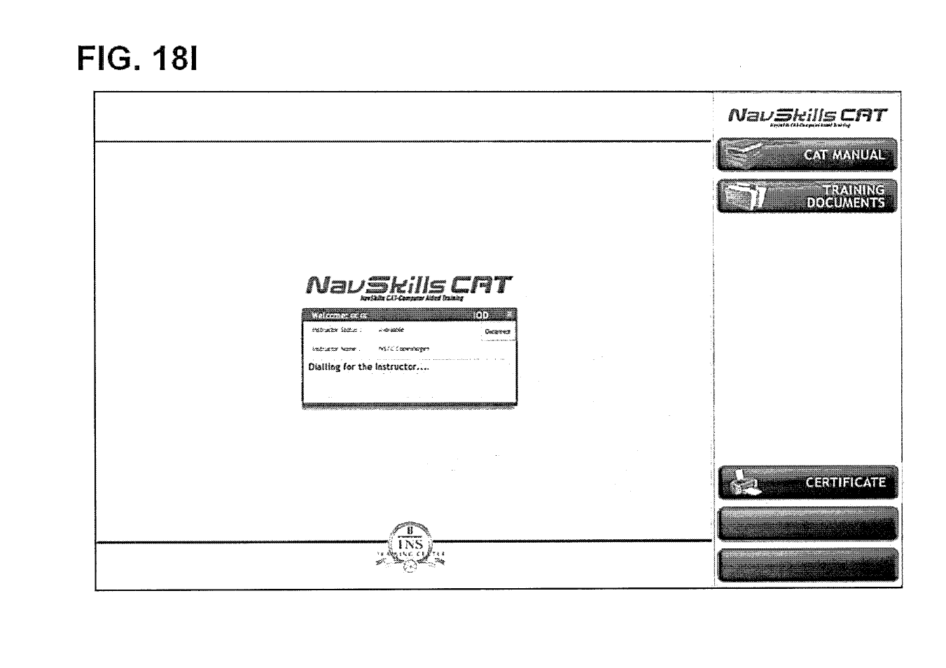

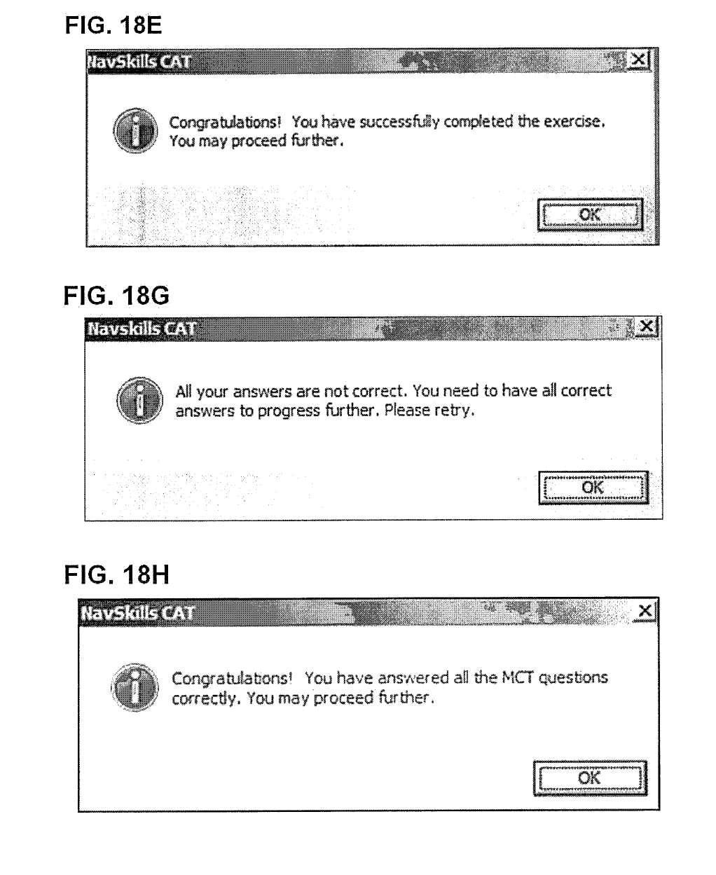

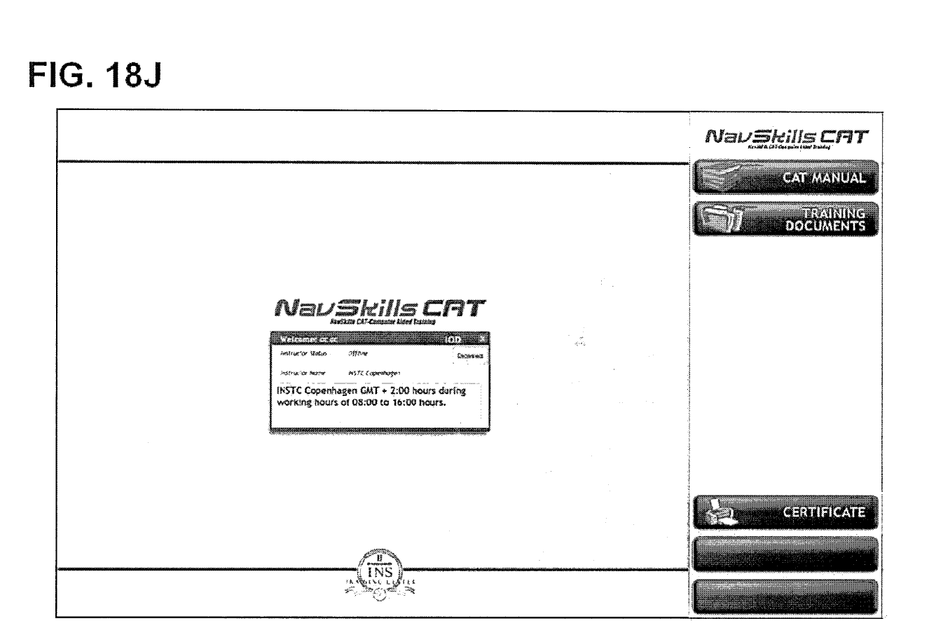

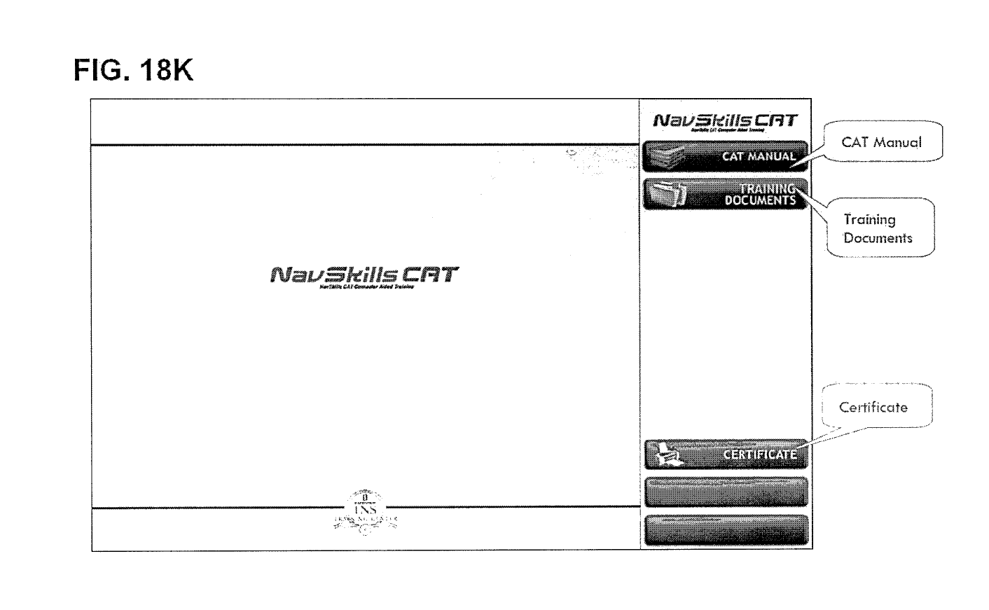

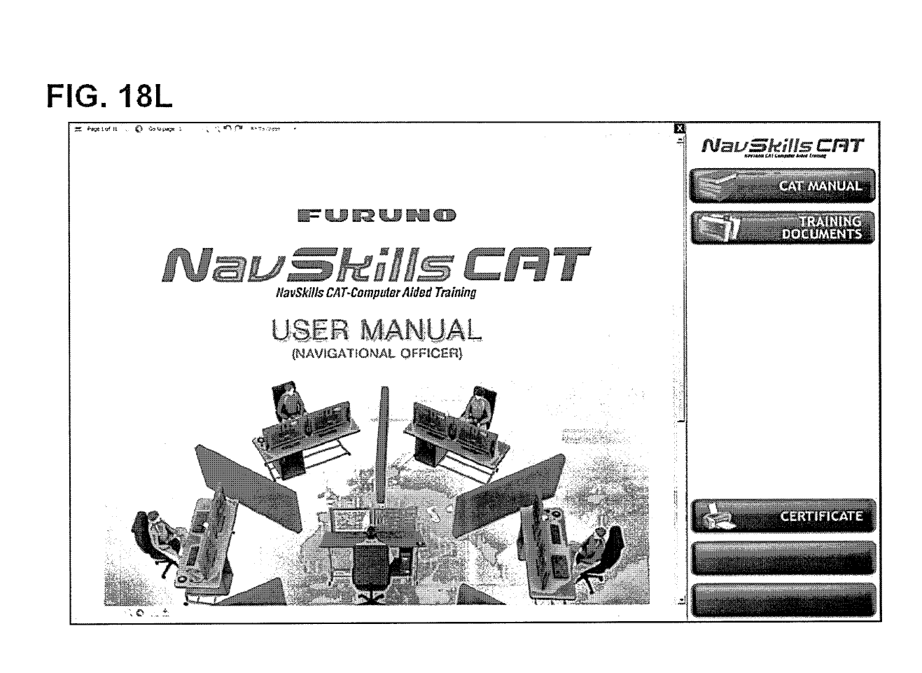

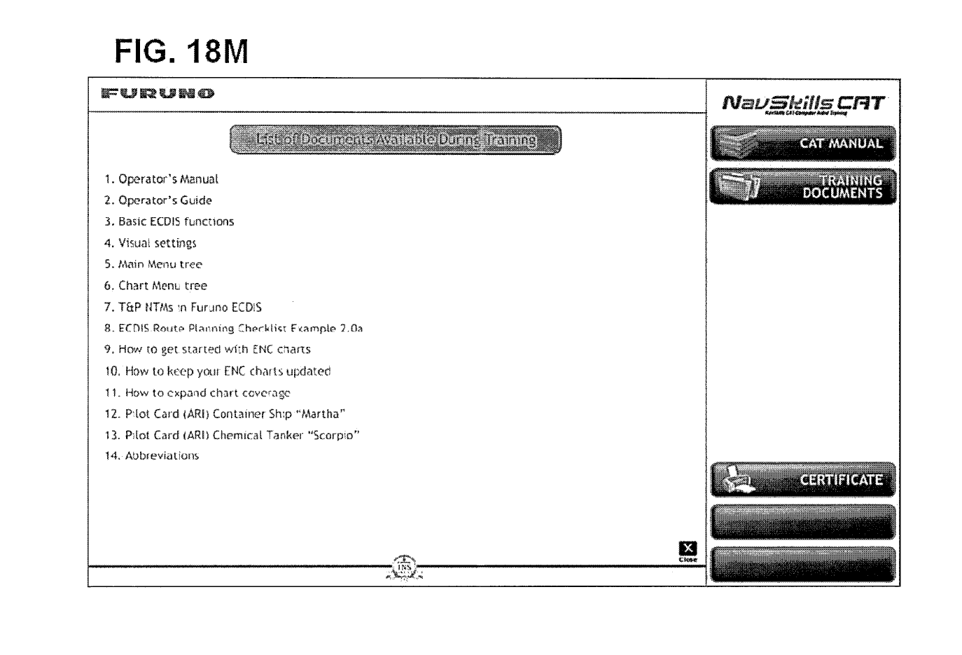

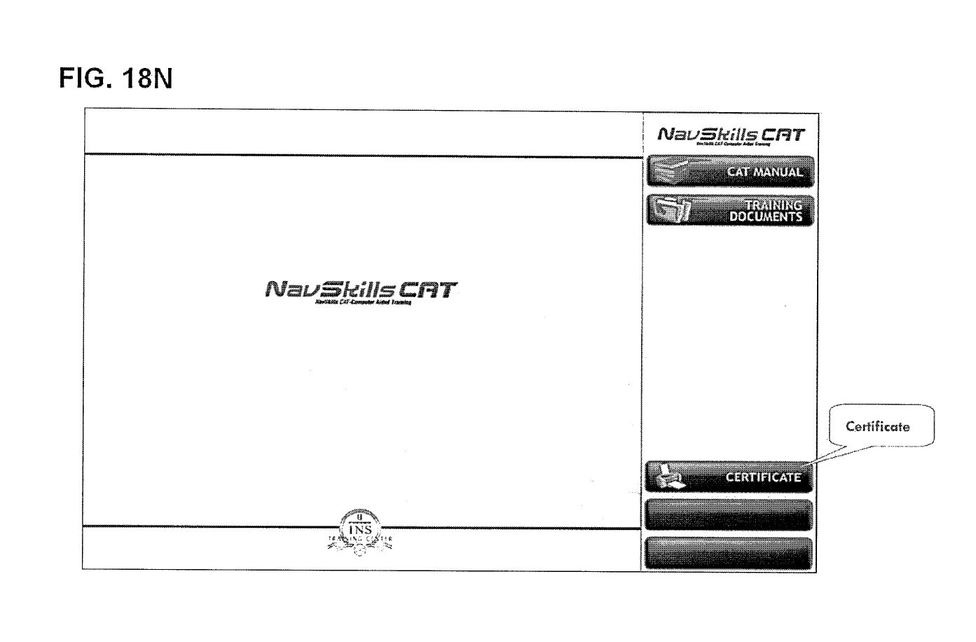

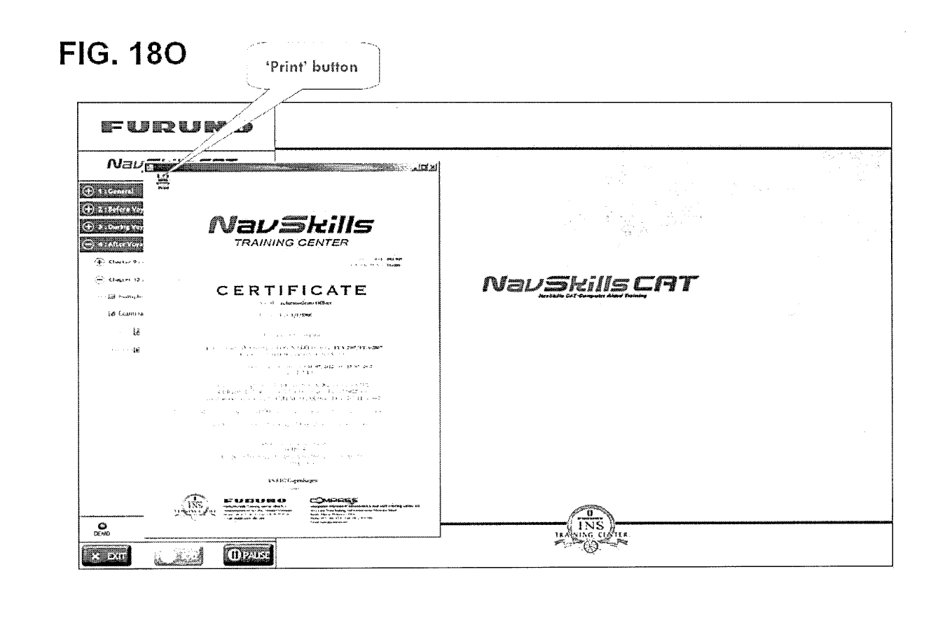

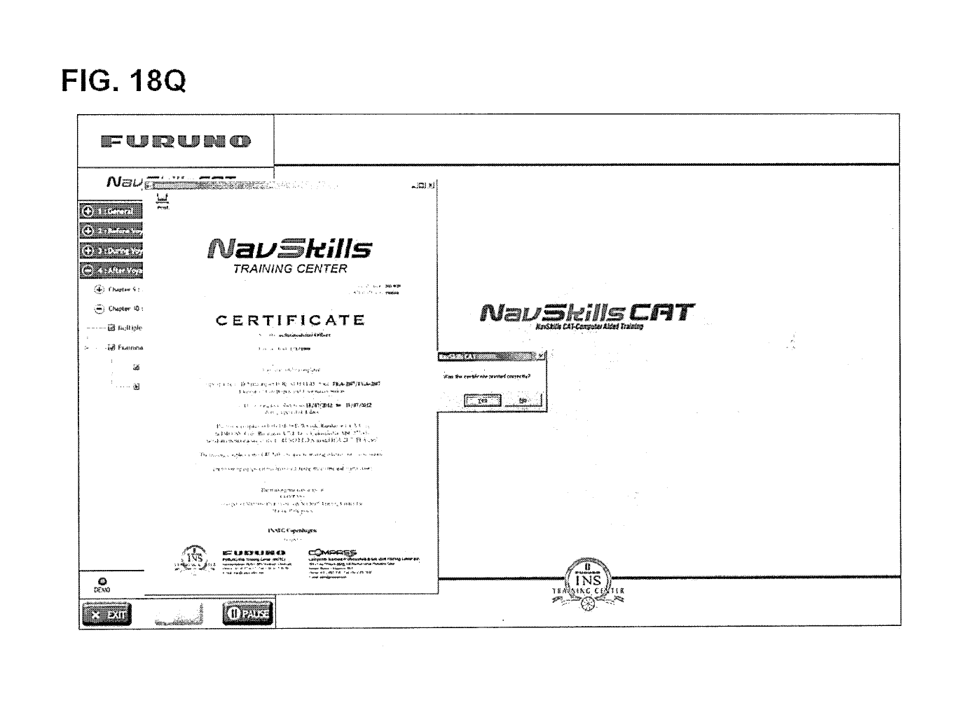

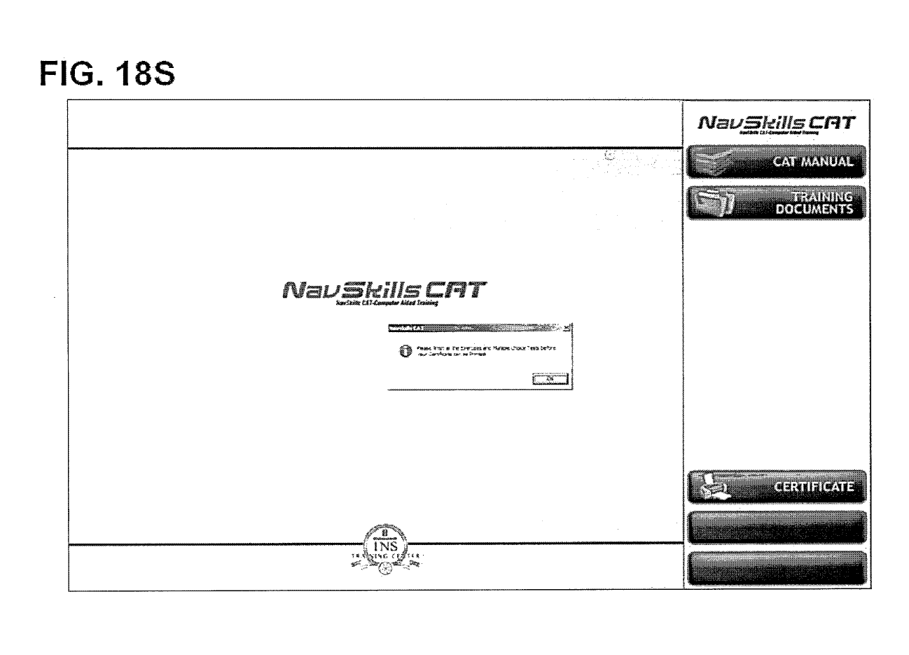

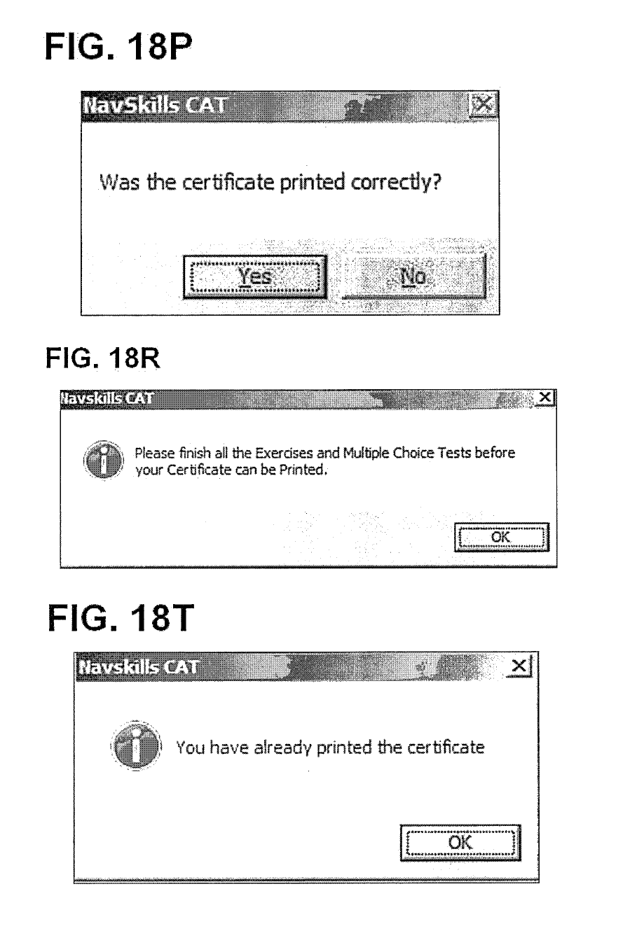

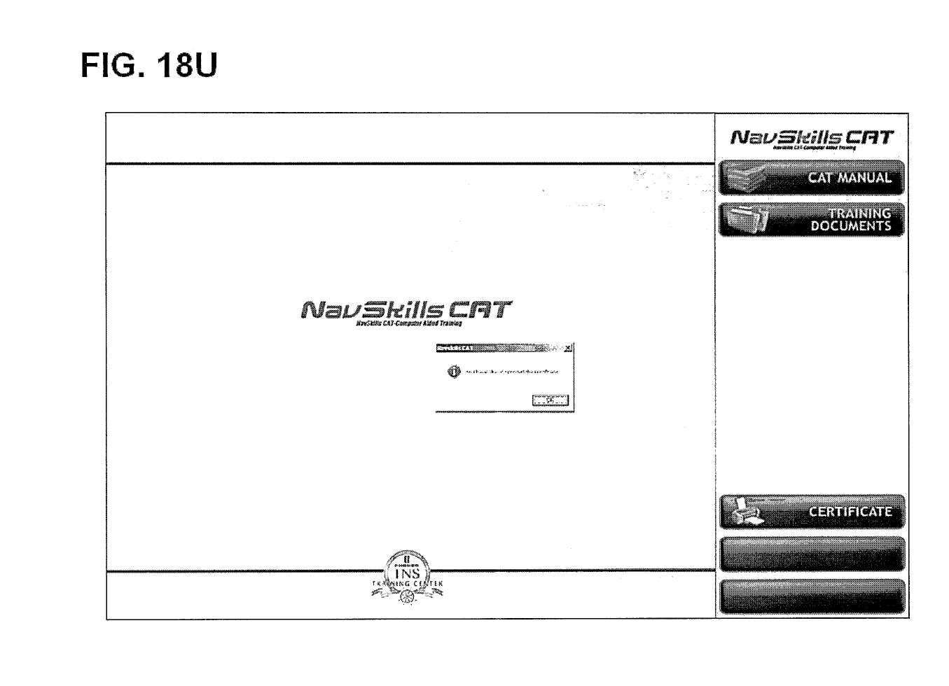

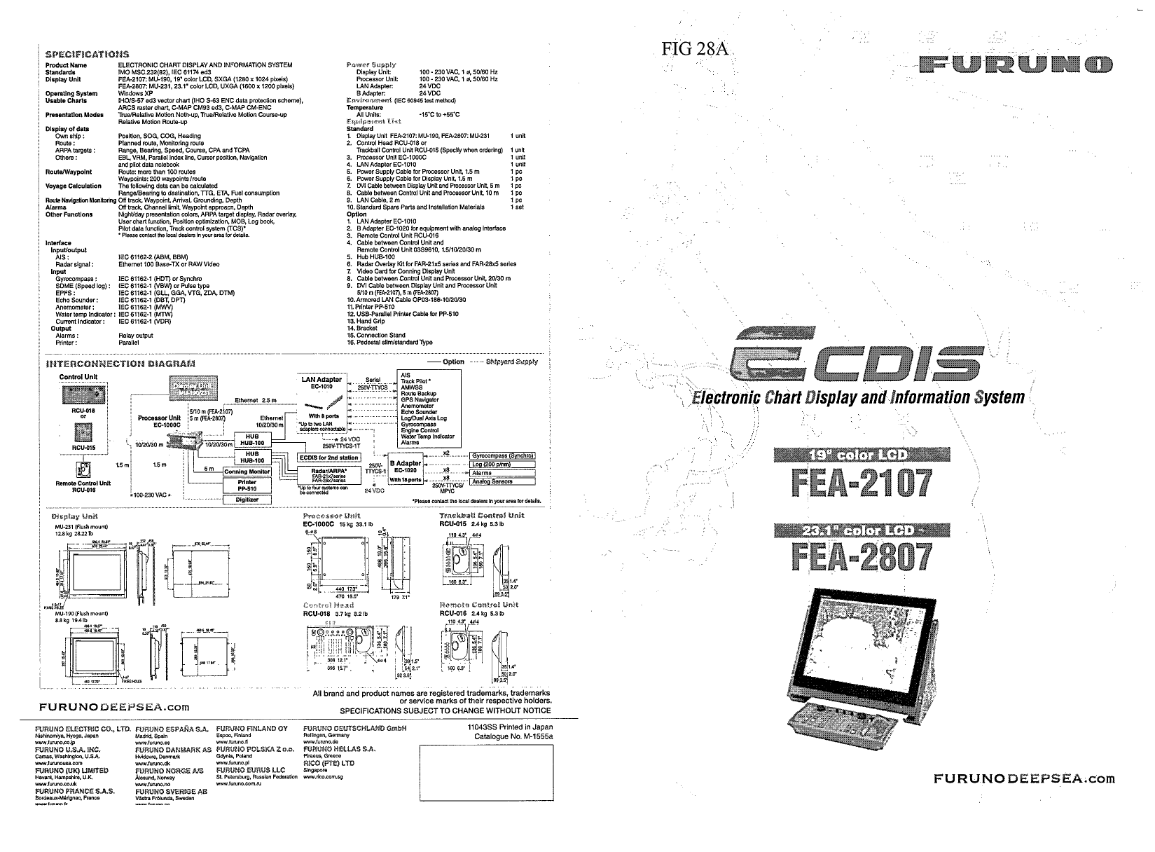

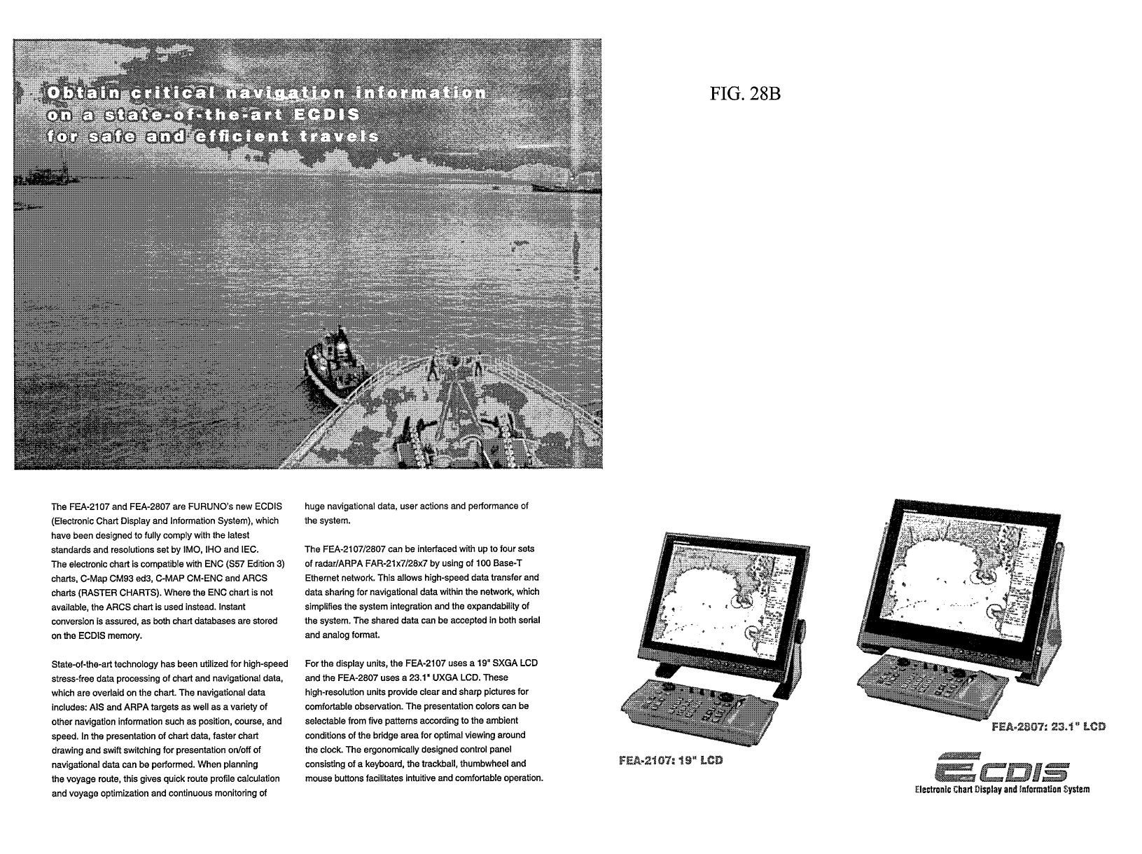

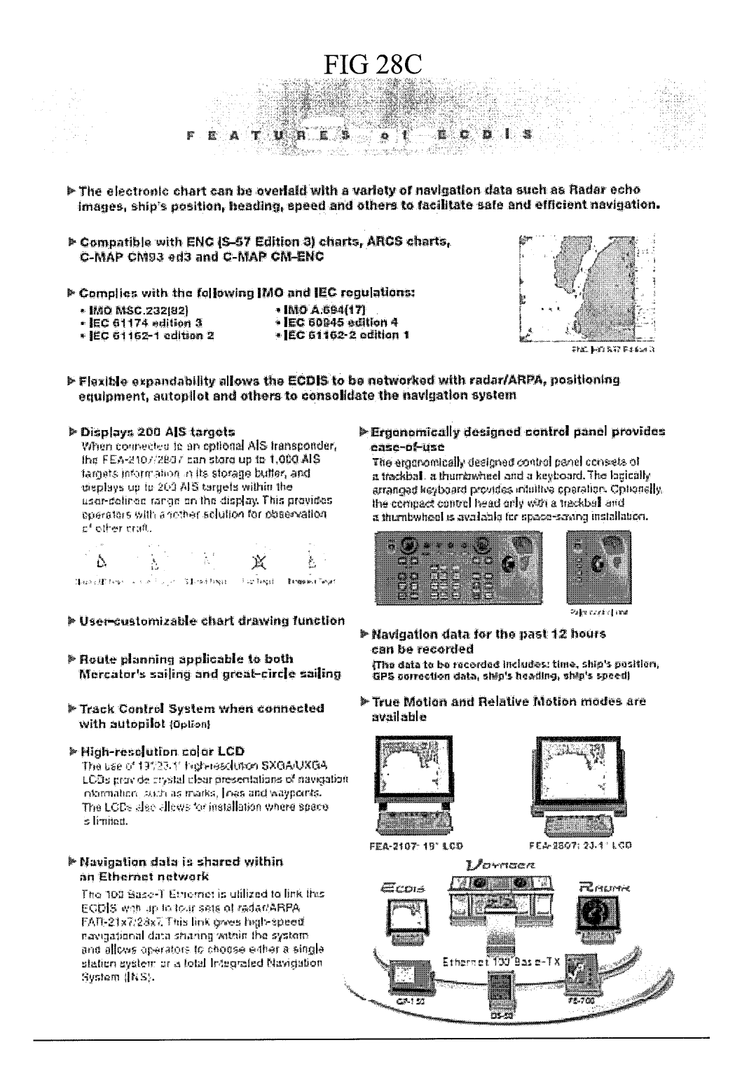

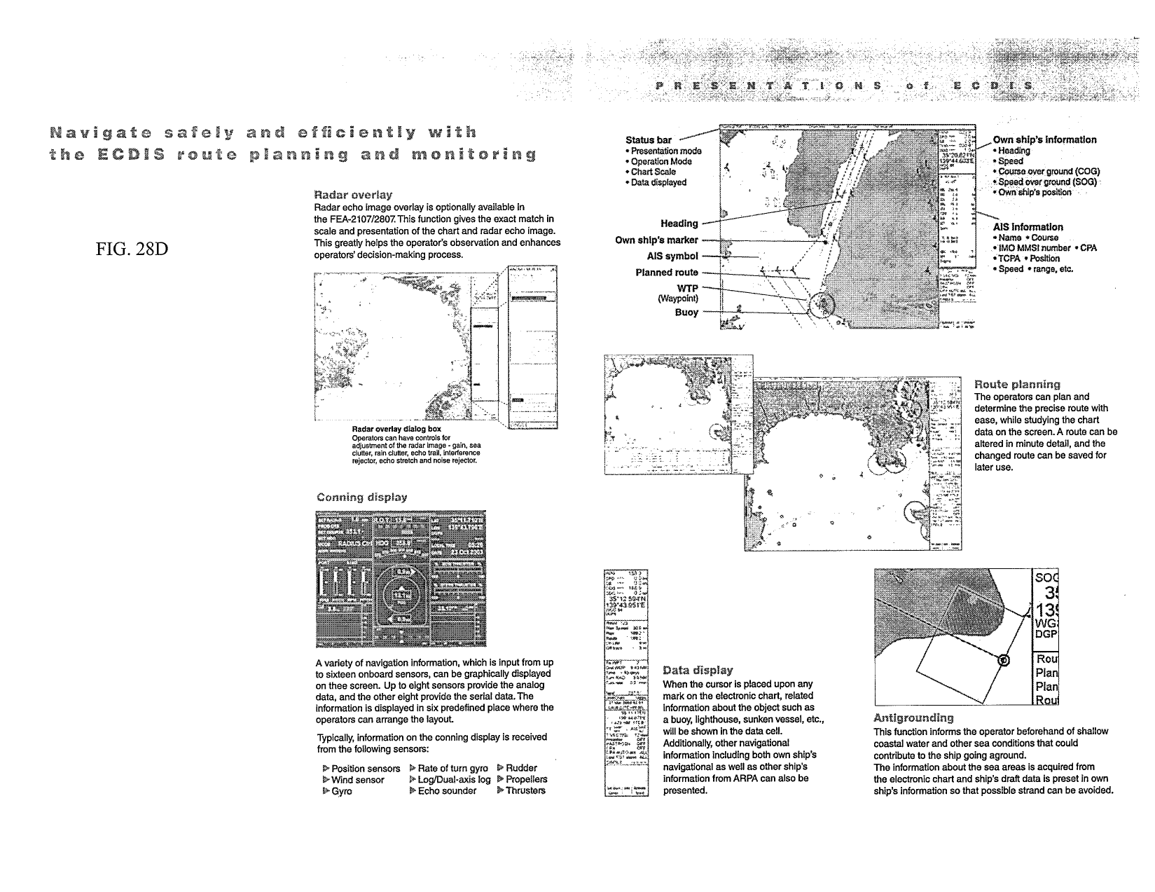

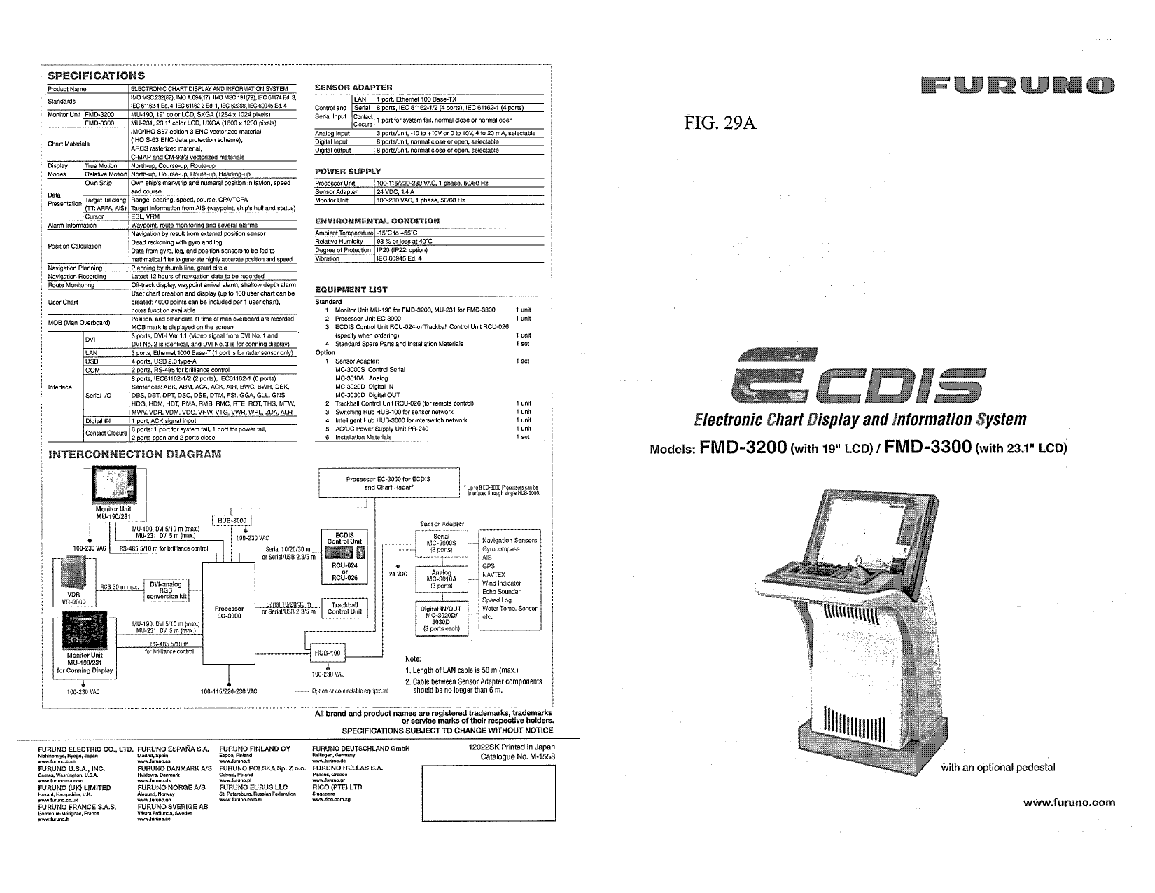

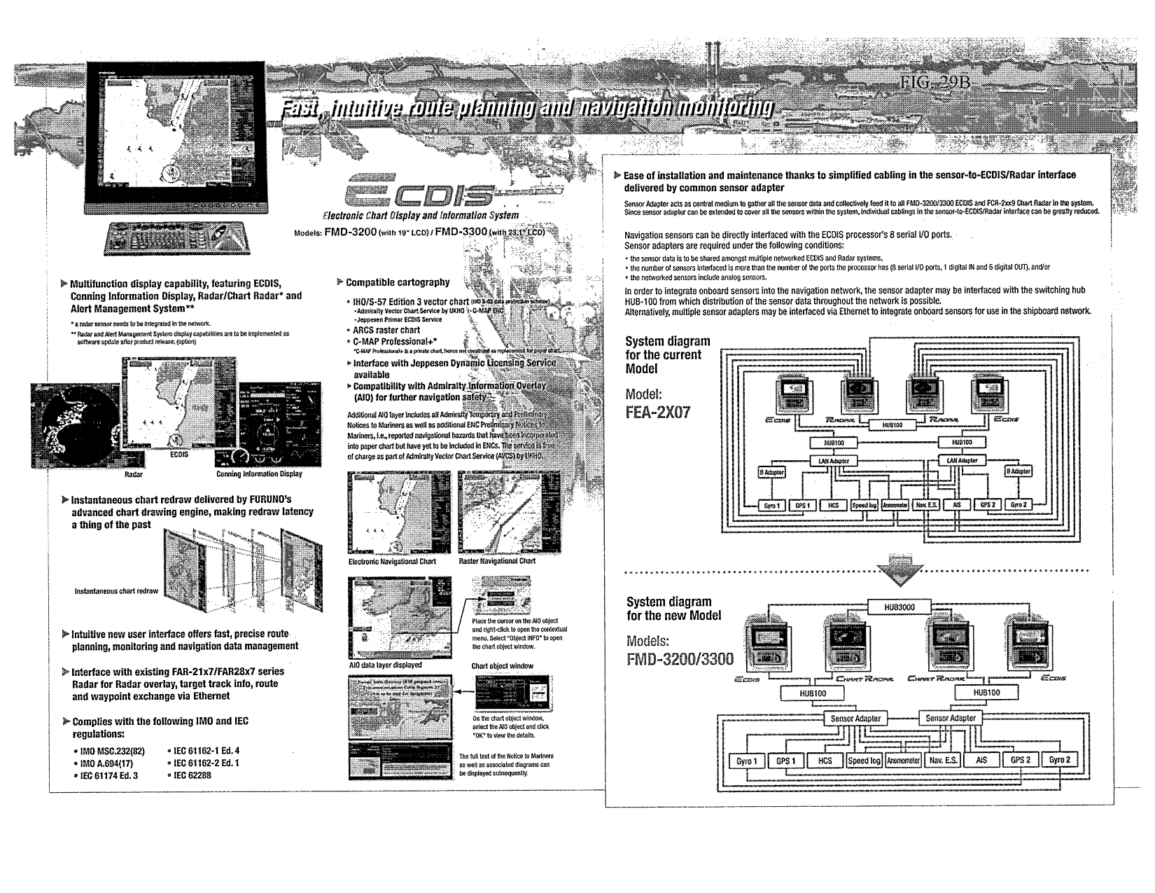

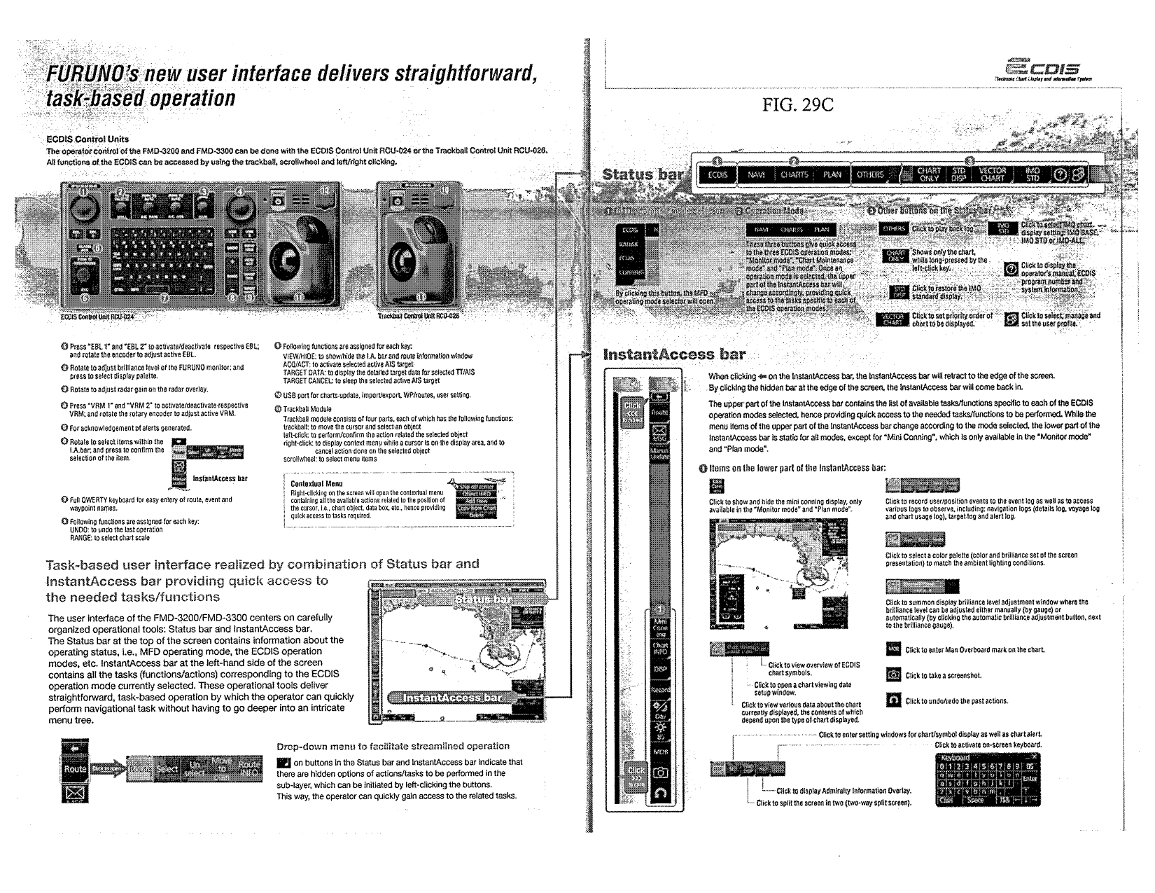

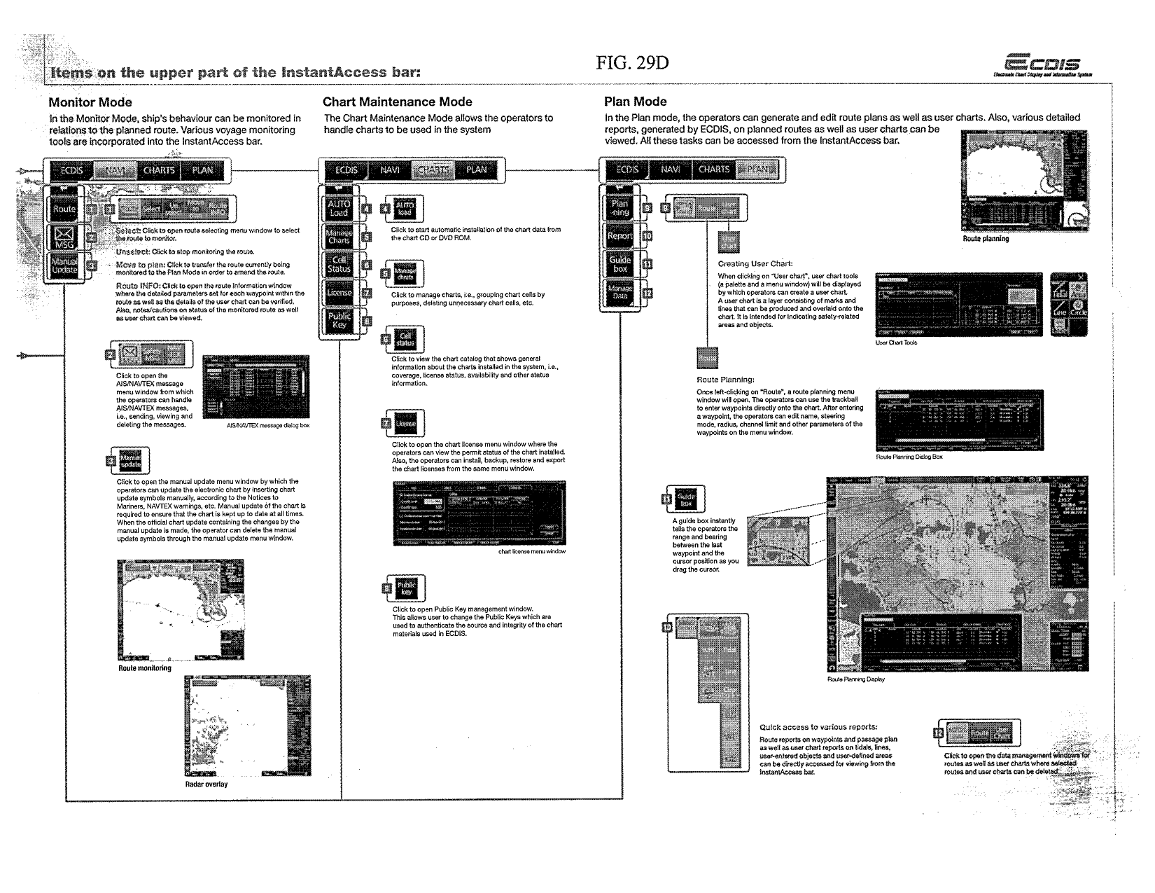

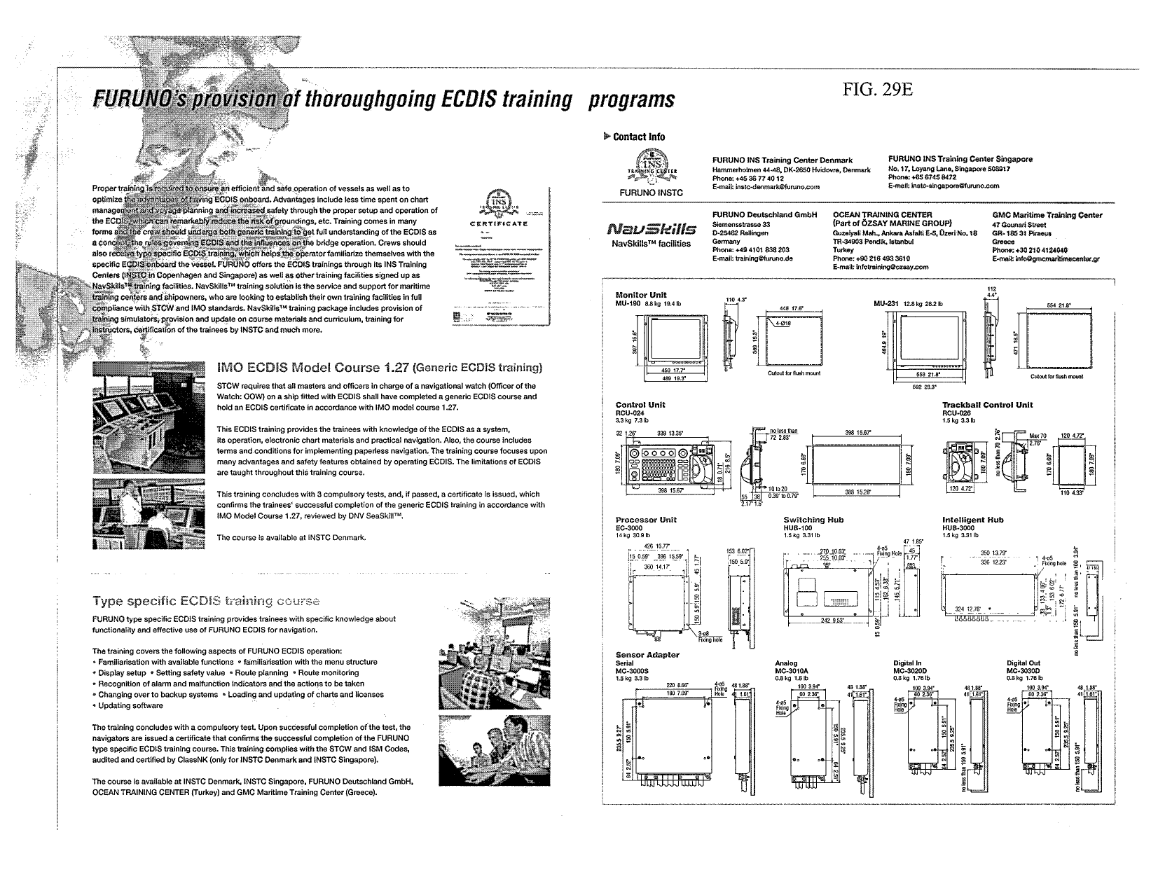

Exemplary ECDIS keyboards are shown in FIGS. 28A-18D and FIGS. 29A-29E which describe the FEA 2107/2807 (FIGS. 28A-18D) and FMD-3200/3300 (FIGS. 29A-29E) ECDIS systems.

In an exemplary embodiment, a NavSkills CAT ECDIS keyboard 23 (e.g., 23A_{ECDIS} and 23B_{ECDIS}) contains the original printed circuit board of an original ECDIS Control Panel/keyboard (e.g., such as the control panel/control unit shown in FIGS. 28A-28D and 29A-29E), extended with a USB interface and power supply circuit. The output of the NavSkills CAT ECDIS keyboard is forwarded via the NavSkills CAT workstation, over the Internet, to the emulated ECDIS environment on the Cloud system. Thus, the original ECDIS Control Panel hardware has been modified to work in the NavSkills CAT environment by means of the added USB interface and power supply circuit, as well as modifying existing Power On and Alarm system interface features.

The monitors 21A₁ and 21B₁ may be 24″ monitors, 26″ wide LCD monitors, or 27″ monitors. One monitor is for ECDIS, and the other monitor is for radar/conning/ship control and visual simulation. The processor 27A may be a PC workstation with virtual software. The keyboard set, as shown in FIG. 8B, is a set that includes a regular keyboard 25A as well as multiple keyboards 23A_{ECDIS} and 23B_{ECDIS} which are specialized for different equipment on which the user is training. For example, the keyboard set may include 1 unit of PC keyboard 25A, 1 unit of a functional ECDIS keyboard for FEA-2107 (unit 23B_{ECDIS}) and 1 unit of functional ECDIS keyboard for FMD-3200 (unit 23A_{ECDIS}). The web camera 22A and headset 28A may be separate, or may be operationally or physically connected. The mouse 26A may be a PC mouse, or other type of a more specialized control unit such as a mouse joystick system, or a mouse-type control unit such as a gaming mouse used in the electronic gaming industry.

The computer 27A may be a standard PC workstation configured to present the training software on the two monitors 21A₁ and 21B₁. The workstation 27A can be controlled by the keyboard 25A and the mouse 26A and by the specialized keyboards in the control unit 24A. In FIG. 8B, these specialized keyboards 23 are Furuno Control Heads. The ECDIS application will be operated by the Furuno Control Head.

The camera 22A is a webcam which is used for user identification or validation. Thus, NavSkills CAT platform can identify a user using a webcam system, e.g., in order to avoid cheating, and can validate the correct user for a given training session. Other user identification systems may also be used instead of, or together with a webcam. For example, a fingerprint identification system, an eye-scanning system, a facial recognition system, and/or a credit card login using a credit card of the user may be employed for user identification. The identification system used is selected taking into consideration the laws and customs of the jurisdiction where the user is conducting the training, and other considerations such as user preferences.

The workstations shown in FIGS. 8A-8C may be used in the NavSkills CAT platform. In an exemplary embodiment, the workstations are used in the NavSkills CAT platform implemented within a cloud environment, such that the workstations are configured to access the NavSkills CAT environment created on a cloud environment.

The training workstations 8A-8C with the control units for the navigational models are not ordinary mouse and keyboard systems. The trainees are able to learn by using NavSkills CAT control units 23, 24 designed for training purposes, which employ a fully functional, real user interface of the respective navigation devices for which the training is conducted. This familiarizes the NavSkills CAT trainees with the navigation equipment they will be operating once assigned to a ship, after completion of the course.

In an exemplary implementation, the NavSkills CAT workstation including a PC-based ECDIS training workstation with Furuno ECDIS control units for 2 ECDIS models provides trainees with the opportunity to learn by using Furuno NavSkills CAT ECDIS control units designed for training purposes, which employ fully functional, real user interfaces of the Furuno ECDIS FEA-2107/2807 and FMD-3200/3300 equipment. FIG. 8D illustrates exemplary monitors with screenshots and NavSkills CAT ECDIS keyboards for ECDIS training using NavSkills CAT. FIG. 8E illustrates an exemplary ECDIS exercise display during NavSkills CAT training. FIG. 8F illustrates an exemplary Conning Information display during NavSkills CAT training. The Conning Information display shown in FIG. 8F will be available in 2013. FIG. 8G illustrates an exemplary visual simulation display during NavSkills CAT training. The visual simulation display shown in FIG. 8G will also be available in 2013.

An exemplary cloud system is specified to accommodate the NavSkills CAT environment. In on embodiment, the cloud system may be scalable. In an exemplary, initial implementation, the cloud system is designed to accommodate access of 200 online users from approximately 600 training workstations. The cloud system specification may be provided modularly as a separate system into which the NavSkills CAT environment is inserted, or may be designed initially to include the NavSkills CAT environment.

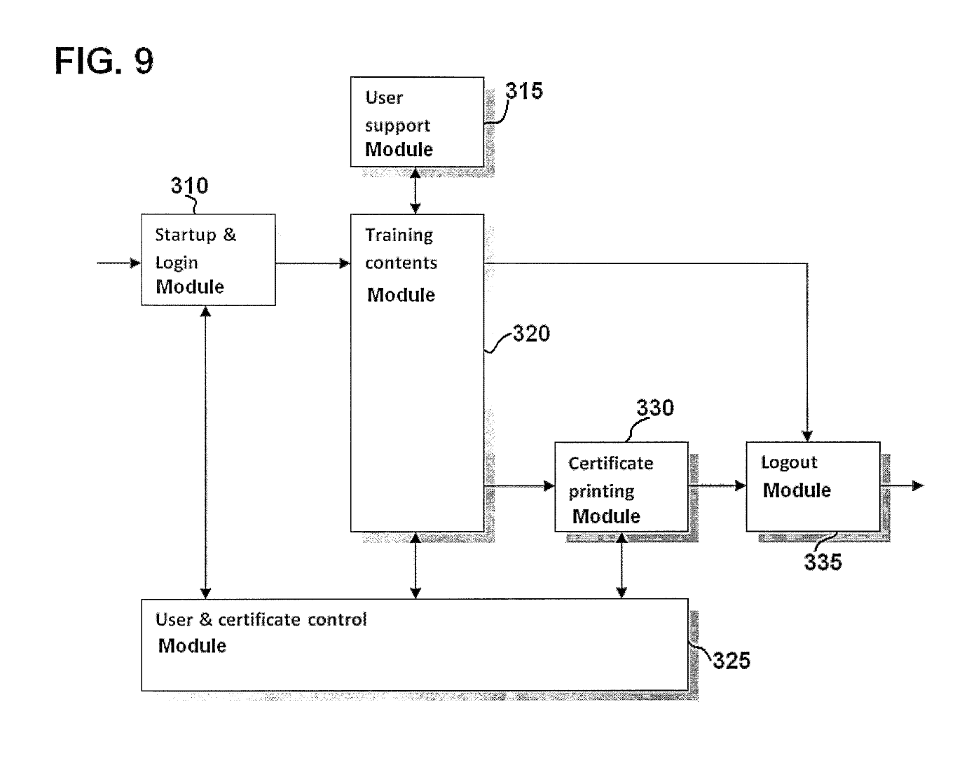

FIG. 9 is an exemplary block diagram of a NavSkills CAT system, according to an embodiment of the present invention illustrated in FIG. 1. The NavSkills CAT system shown in FIG. 9 may implement type specific training or generic training.

The system illustrated in FIG. 9 has been designed based on experience in INSTC training facilities on the Furuno ECDIS FEA-2xx7 type specific training, as well as other types of training. The NavSkills CAT system may be implemented to: register and store user profiles and user training progress information; provide assessment and test results; support a certificate database linked to user profiles; be able to handle user request to replace certificates that have been damaged or lost; provide user support request to a Furuno NavSkills training center instructor that can logon to the user environment, and monitor and guide the trainee; and allow Furuno full access to user and certificate information to edit and print out certificates.

The NavSkills CAT training system includes a startup and login module 310, a user support module 315, a module with training contents 320, a certificate printing module 330, a logout module 335 and a user and certificate control module 325. Thus, the NavSkills CAT training environment is structured around following functions: startup/login, providing training contents, user support, user & certificate control, certificate printing, and logout.

The startup and/or login are performed by the startup and login module 310 that is accessed by a user (e.g., trainee or instructor) who wishes to use the system. After accessing the system, the user accesses training contents provided by module 320, and can access the user support module 315 as needed, or at scheduled times or in certain situations, to receive support for or while using the training contents. Functions such as exercises, tests and assessments may be implemented as an integral part of the training environment.

After training, a user may receive a certificate of completion of training from the certificate printing module 330 and may then log out. When the user accesses the system at module 310 or afterwards, module 310 may communicate with the user and certificate control module 325 to ensure or confirm certain information about the user. For example, module 310 may communicate with the user and certificate control module 325 to confirm that the user has proper access to use the NavSkills CAT system, to ensure that the user has not used a fake login or access information to access the system, etc.

The training contents module 320 and the certificate printing module 330 may also communicate with the user and certificate control module 325 to ensure or confirm certain information about the user. For example, the training contents module 320 and the certificate printing module 330 may communicate with the user and certificate control module 325 to determine whether the user is properly using the training materials, whether the user has the requisite access, whether the user has a need to perform the training because, e.g., a new certificate is needed, and/or to check whether a previous certificate has expired, or to check whether a certificate has already been issued and is in force such that a duplicate training and certificate are not needed.

Process Flows for the NavSkills CAT Environment

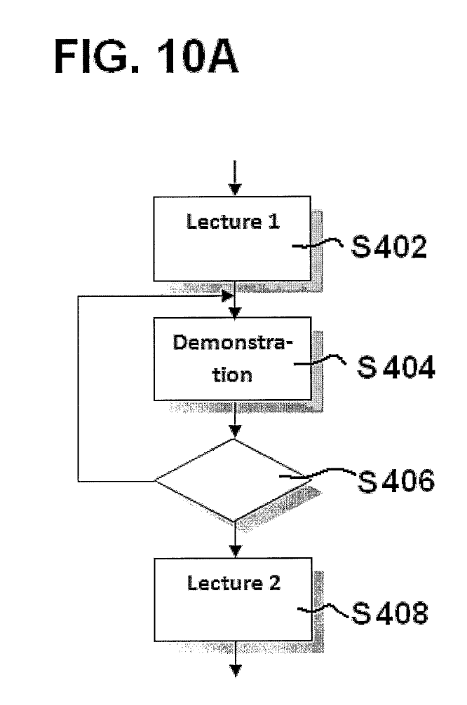

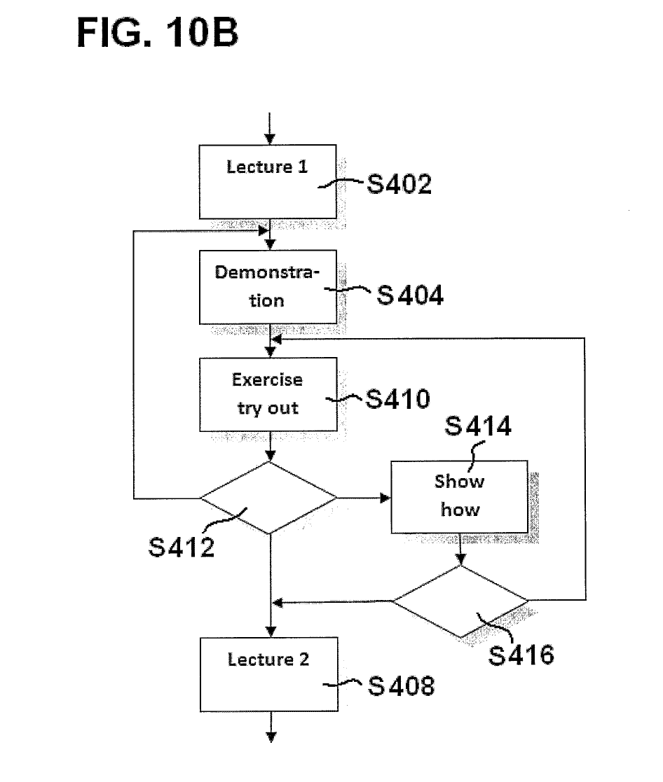

FIG. 10A is a flow diagram illustrating a training flow process for an exemplary NavSkills CAT platform, according to an embodiment of the present invention illustrated in FIG. 9. FIG. 10B is a flow diagram illustrating in more detail a training flow process for an exemplary NavSkills CAT platform, according to an embodiment of the present invention illustrated in FIG. 9.

The NavSkills CAT training environment flows illustrated in FIGS. 10A and 10B comprise Lecture, Demonstration, Exercises and Evaluation. The flows illustrated in FIGS. 10A and 10B may be separately implemented, or may be implemented together for different parts of NavSkills CAT training, or as different flows that may be performed in the same module of NavSkills CAT training. The training may be conducted with continuous interaction between the students and instructor(s) by talk, speech and/or discussions.

The teaching flow illustrated in FIG. 10A includes a plurality of lectures at steps S402, S408, etc. A lecture is followed by a demonstration (S404) and a decision step (S406) at which the user or the training system decides whether to repeat the demonstration. The decision step S406 may also provide the option to decide whether to repeat Lecture 1 (S402). After Lecture 1 (S402) and the demonstration (S404) are completed, the user progresses to Lecture 2 (S408).

The teaching flow illustrated in FIG. 10B includes a plurality of lectures S402, S408, etc. A lecture is followed by a demonstration (S404) and an exercise tryout (S410), followed by a decision step (S412) at which the user or the training system decides whether to repeat the demonstration S404, and/or whether to access a show-how session (S414). The decision step S412 may also provide the option to decide whether to repeat Lecture 1 (S402) and/or the exercise tryout (S410). After Lecture 1 (S402), demonstration (S404) and exercise tryout (S410), the user may progress to Lecture 2 (S408). After Lecture 1 (S402), demonstration (S404) and exercise tryout (S410), the user may also progress to the show-how module (S414) and to another decision step (S416), which decides whether to repeat the exercise tryout flow at S410, or whether to go to Lecture 2 (S408). The user may pass through each of the decision steps S412, S416 once or more than once, depending on whether certain lectures, demonstrations, exercise tryouts and/or show-how sessions should be repeated, or whether the user wishes to repeat them.

The user may complete training in one session, or in multiple sessions. The user may log into the NavSkills CAT platform at any time, and may also pause the training, or interrupt the training as needed. A time constraint may be added to such split sessions. For example, the user may not be allowed to log in and continue the training if more than a certain amount of time has passed from the last login, so that in this case, the user would have to start the training anew. Also, in order to obtain a certification, the user may have to complete all sessions within a predetermined time of a few days, or a few weeks, or any other appropriate predetermined time. The predetermined time frame ensures that the user does not forget the training in the initial sessions due to a long passage of time, and also ensures that the sessions are not so spread out that substantial changes and updates have been made by, e.g., the manufacturer, to the navigational equipment in this time. That is because if substantial changes and updates have been made to the navigational equipment, an updated NavSkills CAT course may need to be taken.

NavSkills CAT training may be implemented according to INSTC teaching principles. In an exemplary embodiment, the NavSkills CAT training environment flows illustrated in FIGS. 10A and 10B include Furuno INSTC training.

Login and Registration

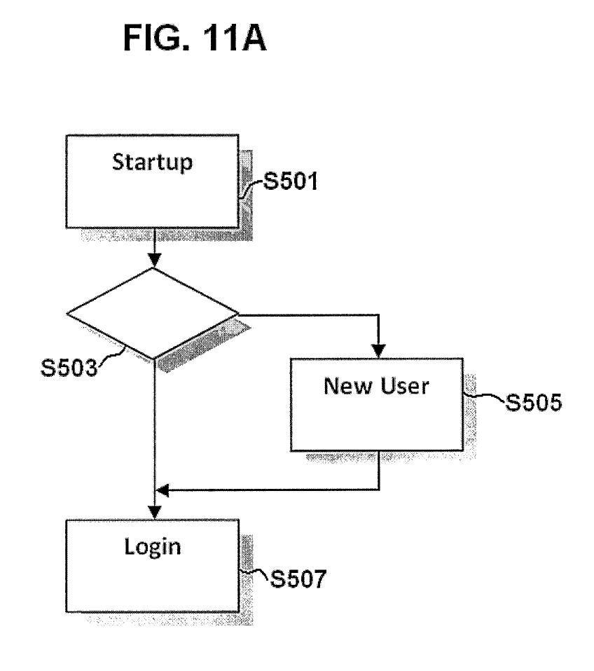

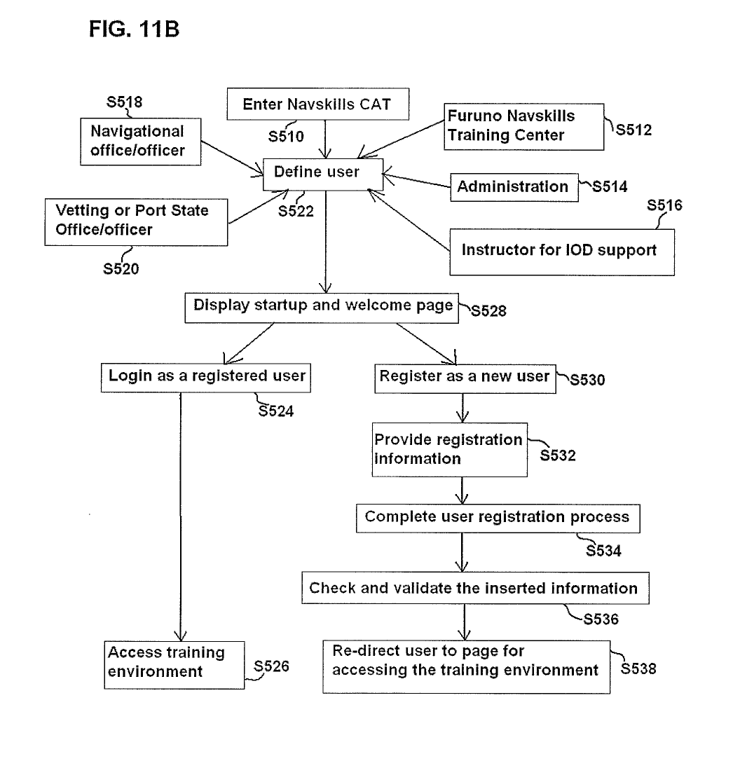

FIG. 11A is a flow diagram illustrating an exemplary process flow for startup and/or login into a NavSkills CAT platform, according to an embodiment of the present invention illustrated in FIG. 9. FIG. 11B is a flow diagram illustrating in more detail an exemplary process flow for startup and/or login into a NavSkills CAT platform, according to an embodiment of the present invention illustrated in FIG. 11A.

The function of the Startup/Login is to present the NavSkills CAT to a user and describe the procedure to enter NavSkills CAT. The flows shown in FIGS. 11A and 11B are performed in a startup and login module 310 as shown in FIG. 9.

Upon startup (S501, S510), a user is defined (S522). In an exemplary implementation, the user can be defined as: a Navigational office or officer (S518), a Vetting or Port State Office or officer (S520), a Furuno NavSkills Training Center (S512), an Instructor for IOD (Instructor on Duty) support (S516), or Administration/administrator (S514). Other definition classes for a user may also be implemented. For example, navigators for all types of vessels, superintendents, ISM/SMS (International Safety Management/Safety Management System) responsible persons and general nautical department may also be trained on the NavSkills CAT platform.

In an exemplary embodiment, a startup and welcome page is automatically presented upon power up (S528). The startup page displays a welcome message such as, for example, “Furuno Electric Co., LTD, NavSkills CAT, Type specific training” or “Generic training” with the possibility to ‘Login’ as a registered user or to ‘register as a new user’.

An exemplary Navigational Officer login (S518) is described below.

A Navigational Officer can register, enter the NavSkills CAT platform and conduct training, such as, e.g., type specific or generic training. He may either login as a registered user (S503, S524), or register as a new user (S505, S530). If the officer logs in as a registered user (S524), he/she will be presented the possibility to enter username and password when selecting to login, in order to access the training environment (S526). If the officer is to register as a new user (S530), i.e., he/she selects “New user”. The user will be presented with a user registration page to fill in the minimum information required to become a registered user (S532).

The user will then be asked to insert certain information. In an exemplary implementation, the user is asked to insert the following information: Name, including the first and last name of the student; the Date of birth, including Day, Month, Year; Gender of Female or Male; and Picture for control and verification purpose.

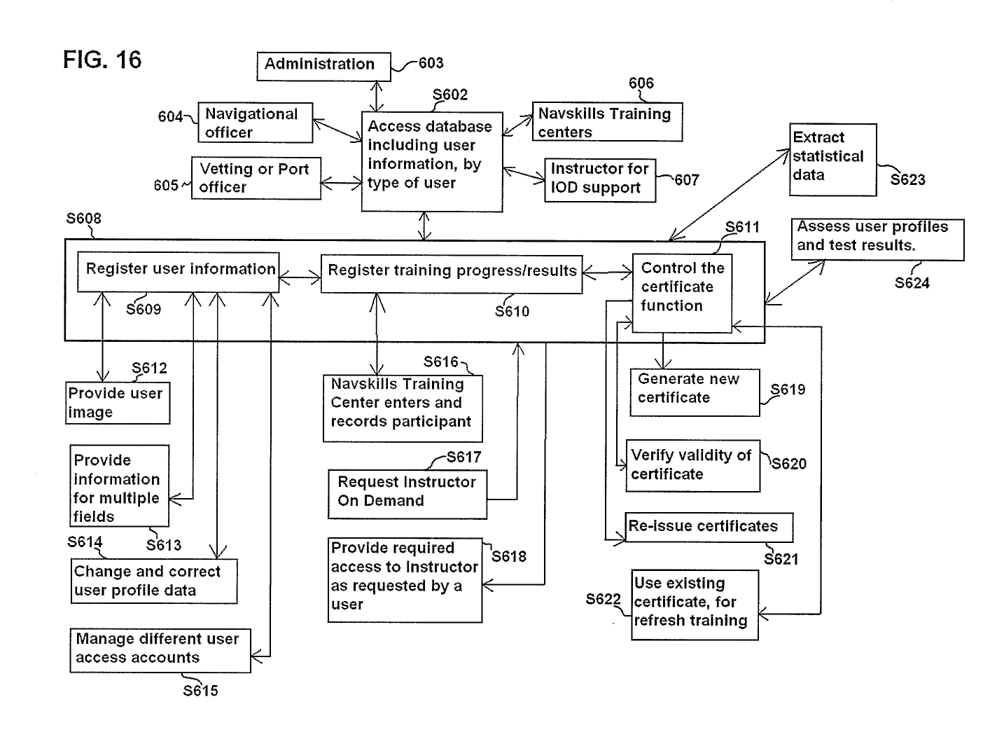

More fields then the ones listed above may appear at this step, requesting the user to provide the appropriate information. Fewer fields may also be used. The user and certificate control function described at FIG. 16 below provides more detailed description regarding user data that may be requested to be available in the training system. Also, the minimum information required at startup/login as well as validation of the data are specified in the user and certificate control flow, shown in FIG. 16.

The user selects a Login name and Password to login and access the training environment. Upon completing the user registration process (S534), the user will be prompted to check and validate the inserted information (S536). Thereafter, the user will be re-directed to the login page to access the training environment (S538).

For an exemplary Vetting or Port State Officer login (S520), a Vetting or a Port State Officer can access the certificate verification functions to verify the validity of the training certificate. As an example, the officer may access the certificate verification functions to verify the validity of the ECDIS type specific training certificate.

In an exemplary Furuno NavSkills Training Center login (S512), a Furuno NavSkills training center can access the NavSkills training center user registration function to register users that have attended certain training (e.g., ECDIS type specific training) at the NavSkills training center. The NavSkills training center would have the rights to print certificates upon successful completion of a training course. Furuno INSTC may use the same entrance to register users attending type specific or generic training at INSTC facilities.

In an exemplary Instructor for IOD support login (S516), the NavSkills CAT provides user support by means of an instructor. The user simply calls for user support by pressing the IOD button, and the instructor on duty will respond and provide the necessary support relating to the navigational equipment on which the user is training and the NavSkills CAT usage.

The number of instructors may be determined according to actual demand. In the initial stage of launching the NavSkills CAT, the INSTC in Copenhagen and Singapore may cover the support by designating instructors. In an exemplary implementation, the INSTC administration is able to control and handle the instructor accounts by designating the required and necessary amount of instructors to provide the user support.

In an exemplary Administration login (S514), the Furuno INSTC administrator has full access to the data stored in the system to perform one or more of the following, and possible all of the following: handle and manage the condition of the user profiles; re-issue certificates; control of different user access accounts; extraction of statistical data; and process user results for assessment.

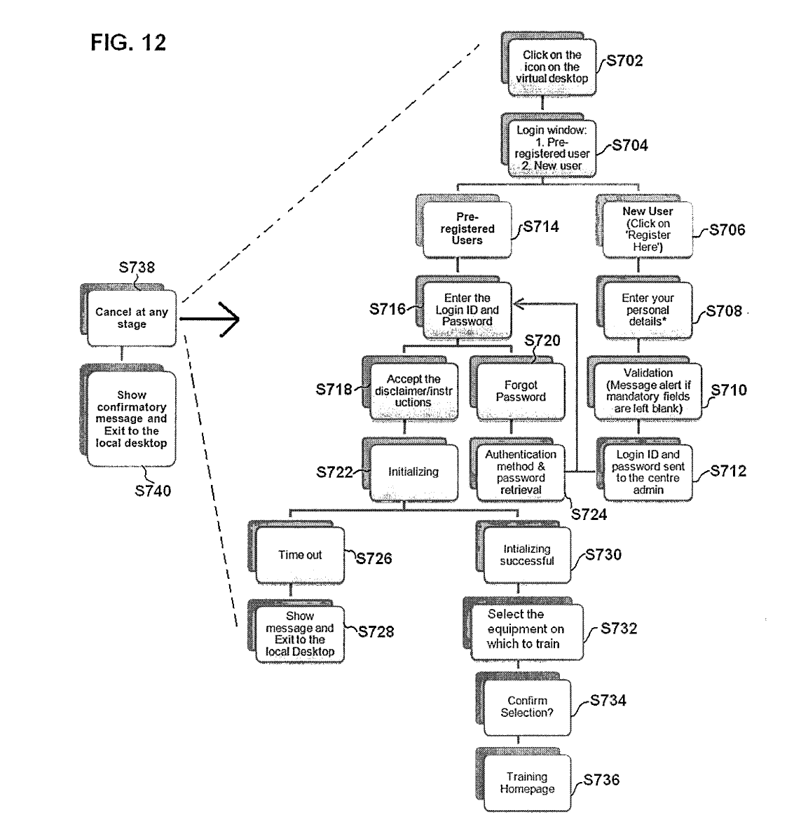

FIG. 12 is a flow diagram illustrating in additional detail an exemplary process flow for startup and/or login into a NavSkills CAT platform for a new user or for a pre-registered user, according to an embodiment of the present invention illustrated in FIG. 11A. Login/registration into the NavSkills CAT system may be performed by all existing users and by new users, by e-learners and classroom learners, and by a company Office Group using a company Office Group login, by an administrator, by Furuno marketing, and by other entities depending on the implementation and permissions in the NavSkills CAT platform.

As shown in FIG. 12, upon clicking on an icon on the virtual desktop (S702), a Login window appears allowing login as a Pre-registered user or as a New user (S704). If the user logging in is a Pre-registered User (S714), the user is asked to enter the Login ID and Password (S716). After entering this information, the user has to accept a disclaimer and read instructions, etc., as appropriate (S718). After step S718, the system is initialized (S722) and upon successful initialization (S730), the user selects the equipment on which to train (S732). In an exemplary embodiment, the user may choose the equipment/products by a pull down menu.

In an exemplary embodiment of a NavSkills CAT course, NavSkills CAT may provide a selection between a plurality of Furuno products, such as ECDIS products. For example, a selection at step S732 may be made between FEA-2107, FEA-2807 and FMD 3000 Series ECDIS equipment.

When new series of products are released by various manufacturers, e.g., when Furuno releases a new series, such product name would be added onto the pull down menu at step S732, so that the user can select which series of products/equipment to learn in NavSkills CAT. To add training modules for training on a new or updated product, NavSkills CAT may develop a training course geared toward the new or updated product, or the product manufacturer may develop the training course for their product and NavSkills CAT management may implement/customize the training course for the platform. NavSkills CAT management may work with the product manufacturer to verify that the product manufacturer has developed, supervised, and/or checked the training course for the respective product and can fully vouch for the course that is to be presented to users on the NavSkills CAT platform.

In one embodiment, the NavSkills CAT training course configuration would not change based on the combination of additional products (e.g., peripheral equipment) which are configured to connect with the product or equipment on which the user is training. It may not be necessary to change the NavSkills CAT training course in this case, because such peripheral equipment outputs the same kind of outputs, regardless of the product or equipment on which the user is training.

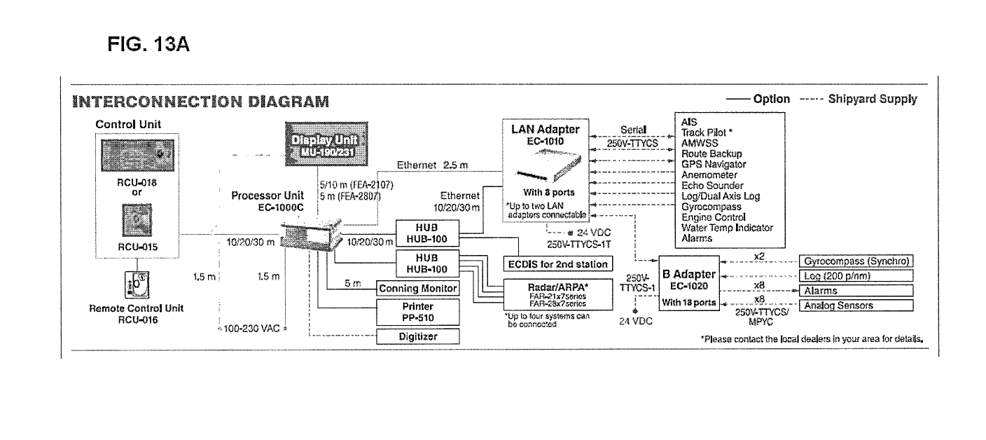

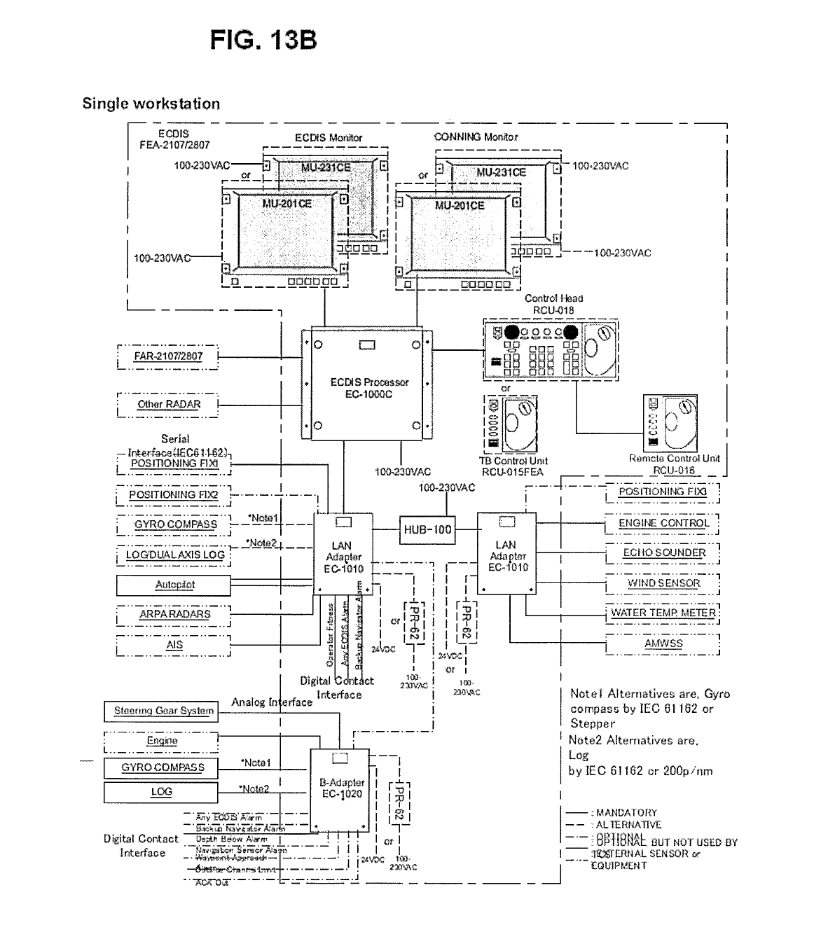

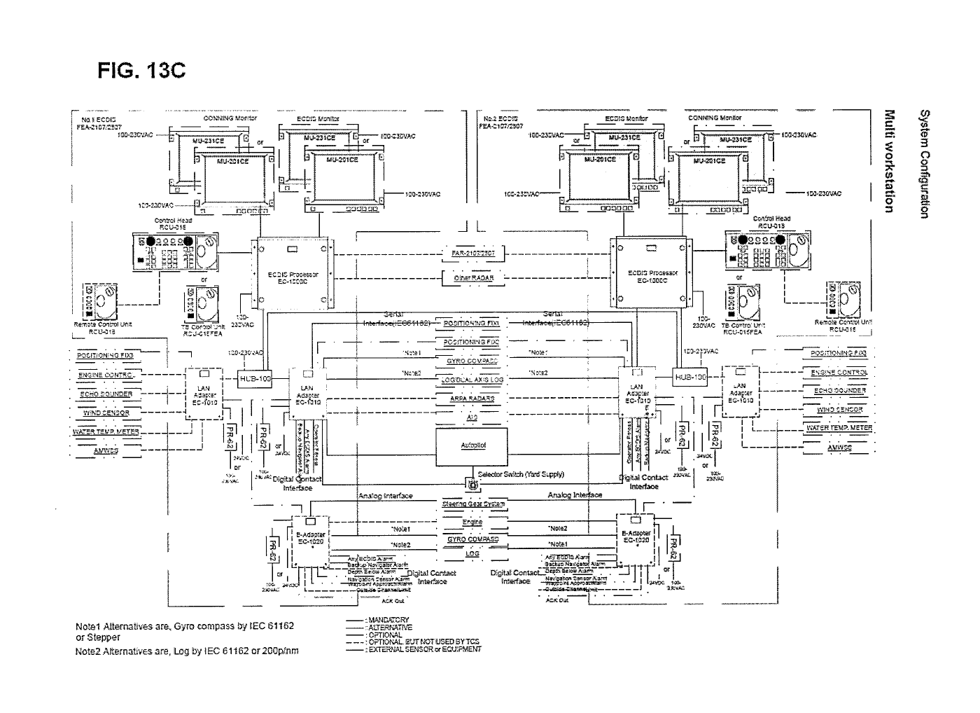

For example, peripheral equipment may be a combination of products which are configured to connect with Furuno's ECDIS equipment. Suppose a user performs training in NavSkills CAT for Furuno's ECDIS equipment (Electronic Chart Display and Information System, for which exemplary products are illustrated in FIGS. 28A-28D and 29A-29E). According to the “interconnection diagram” shown in FIG. 13A (which is the interconnection diagram for a kind of ECDIS equipment described in more detail at http://www.furuno.com/en/business_product/pdf/marine/ecdis.pdf, shown in FIGS. 28A-28D), or the “System Configurations” shown in FIGS. 13B and 13C (which are part of Furuno Operator's Manual for Electronic Chart Display and Information System (ECDIS) for Models FEA-2107, FEA-2107-BB, FEA-2107-D, FEA-2807 and FEA-2807-D including instructions for use with Autopilots FAP-2000, PT-500A and PR-6000, located at http://www.furunousa.com/ProductDocuments/FEA2107%20AUTOPILOT%20Operator's %20Manual%20Bf.pdf), “EC-1000” and/or “EC-1010” can be connected with Radar, Autopilot, AIS, GPS Navigator, Echo Sounder, Gyrocompass, and other peripherals. However, the NavSkills CAT training contents (e.g., for the ECDIS equipment) would not be changed based on the type of Autopilots, such as Furuno's FAP-2000 or Yokogawa's PT-500. In an exemplary embodiment, the kind of original Autopilot supplied from any supplier is irrelevant in the NavSkills CAT training application, as the Autopilot has been emulated based on the general expected autopilot functionalities. In this case, there is no need for a NavSkills CAT user to select a type of Autopilot in the NavSkills CAT environment. Thus, in an exemplary embodiment, the NavSkills CAT platform does not provide for a selection of a type of Autopilot.

The NavSkills CAT training contents may therefore be the same, regardless of the combination of configuration connected to Furuno's ECDIS product or other product on which the user is training in NavSkills CAT.

In another embodiment, the NavSkills CAT training course configuration may be configurable to be changed based on the combination of products (e.g., peripheral equipment) which are configured to connect with the product/equipment on which the user is training. This may be implemented in case the peripheral equipment would not output the same kind of outputs for different equipment for which training is provided in NavSkills CAT.

Upon confirming selection (S734), the user is taken to the training Homepage (S736).

If the system is not successfully initialized, the system times out (S726) and a message is shown describing the status, after which the user or system exits to the local desktop (S728).

If the user has forgotten the password (S720), an authentication method and password retrieval process is deployed (S724). Login may again be attempted (S716) until successful, and/or for a certain preset number of times.

If the user logging in is a new user (S706), the user is asked to register by entering personal details (S708). A validation screen appears (S710), or, if mandatory fields are left blank a message alert is displayed indicating that registration is not completed. After entering the appropriate information and passing validation, the user can use the NavSkills CAT system. For example, the user is taken to step S716, or is taken to the training selection page S732. The login ID and password created by the user are also sent to the centre admin (S712) and may be used for user login (S716) and/or for authentication (S724), e.g., before allowing the user to select the training in the present session.

A user may cancel the NavSkills CAT session at any stage (S738). After cancellation, a confirmatory message is shown and the system then exits to the local desktop (S740).

Training

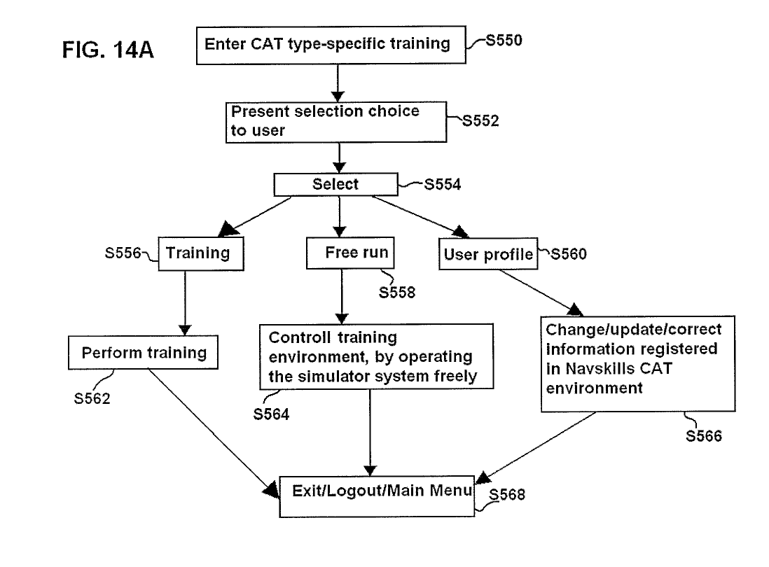

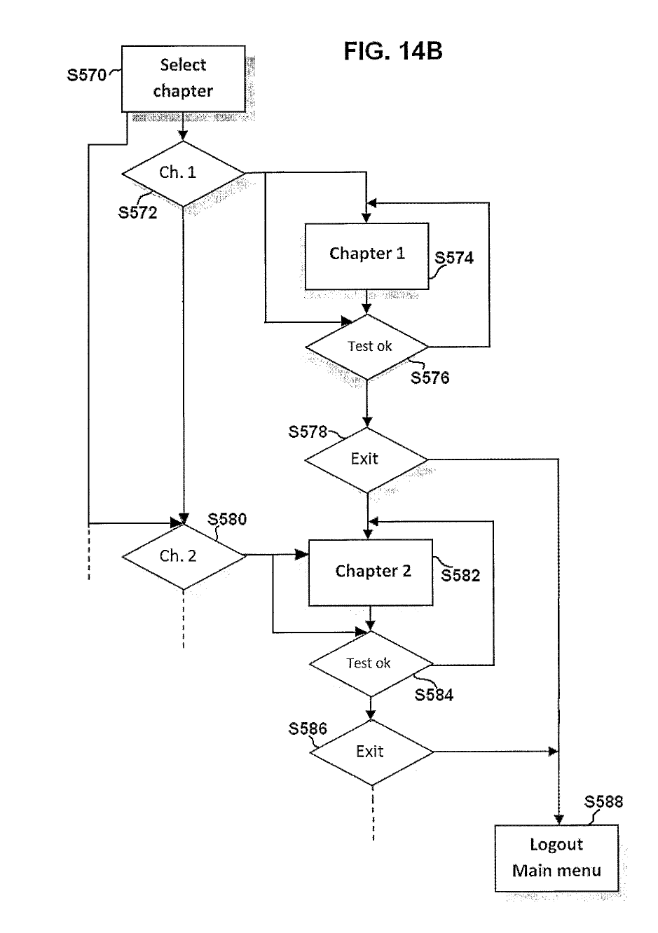

FIG. 14A is a flow diagram illustrating an exemplary process flow for accessing and conducting training on a NavSkills CAT platform, according to an embodiment of the present invention illustrated in FIG. 9. FIG. 14B is a flow diagram illustrating in more detail an exemplary process flow for accessing and conducting training on a NavSkills CAT platform, according to an embodiment of the present invention illustrated in FIG. 14A. The flow diagrams shown in FIGS. 14A and 14B are performed via the training contents module 320 shown in FIG. 9.

In one embodiment, the function of the training contents process and module is to provide computer-aided type specific or generic training. FIG. 14A illustrates training steps for type-specific training, but a similar flow process may be implemented for generic training.

In one exemplary embodiment, the training is type specific training in NavSkills CAT provided for the Furuno ECDIS FEA-2xx7 and Furuno ECDIS FMD-3200. FIG. 14A illustrates training steps for type-specific ECDIS training, but a similar flow process may be implemented for type specific or generic training of other equipment besides ECDIS.

Upon entering the CAT type specific training for Furuno ECDIS (S550), the user is presented with the choice of selecting (S552) between: training (S556), free run (S558), and user profile (S560). These three options are different in the following ways. Training (S556) is the option that needs to be selected by the user to start the actual training, which would be assessed and certified. Free run (S558) is an option that may be selected by the user to go through the entire course without any conditions, in which case the user would also not be assessed. The user profile (S560) is an option that may be selected by the user in order to edit his/her user profile.

The menu for the selection of “Training” is discussed below and a flow diagram illustrating an exemplary process flow, when training is selected, is illustrated in FIG. 14B.

In an exemplary embodiment, the content of the CAT type specific training has been adopted from the class training of ECDIS type specific training. The training is based on acquiring knowledge by following a step-by-step training. At any point, the user is free to exit the training session and to logout (S568). FIG. 14B illustrates training chapter selection and logout.

The user selects a chapter for training (S562, S570). After each training chapter, the user will have to pass a test to verify understanding of the contents (S576, S584). Upon successfully completing the test, the next chapter is unveiled. If the test is not completed, the user will have to go through the chapter again to acquire the knowledge to pass the test (arrows from S576 going back to Chapter 1, and from S584 going back to Chapter 2).

It is noted that in order to finally obtain a certificate, the user has to complete a predetermined training program. In one embodiment, if a trainee fails some lectures/courses, the trainee has to try a multiple choice quiz until he/she passes it. In one embodiment, the NavSkills CAT platform may show exactly the same lecture/course for those who failed the lecture/course before, but the multiple choice quizzes are automatically changed to appear at random.

In another embodiment, the NavSkills CAT platform may show additional material, such as background material, for a user who fails a lecture/course, if for example, it appears that the user lacks background knowledge. This may be determined by the platform to be the case when, for example, a user repeatedly fails a certain course portion. The difficulty of multiple choice quizzes may also be stepped. Also, additional quizzes may be shown to a user if it is determined that the user needs concentrated training concerning a certain equipment feature.

If the user considers that he/she knows the chapter contents, the user may directly take the test (arrow from S572 to S576, and arrow from S580 to S584) and then proceed to the next chapter (e.g., S582) that the user wishes to train on. In another alternative, the user may be allowed to simply jump to a desired chapter after entering training (arrow from S570 to Chapter 2 or a later chapter), without going through each previous chapter if, for example, the user, or the NavSkills CAT system can certify that the user has passed training for the skipped chapters (e.g., for Chapter 1, when Chapter 1 is skipped). At any time, the user may also select to exit the chapter section and go to the main menu or logout screen (S568, S578, S586, and arrows from S578 and S586 to S588).

The training on NavSkills CAT is realized to simulate the working process, e.g., to simulate the navigational activity on a ship while at sea. In an exemplary embodiment, the training is divided into following 4 groups: General; Pre-departure; During voyage; and After voyage.

In an exemplary embodiment for ECDIS training on NavSkills CAT, this training is realized to simulate the ECDIS working process on a ship while at sea. The ECDIS training may be divided into General training, Pre-departure training, During voyage training and After voyage training. These training groups may exemplarily be divided into the work process as follows:
General—Group 1, including Chapter 1 on “Familiarization with available functions”, and Chapter 2 containing “Manuals and help”;
Pre-Departure—Group 2, including Chapter 3 on “Sensors and input”, Chapter 4 on “Visual settings and safety contour”, Chapter 5 on “Documentation and file handling”, Chapter 6 on “Chart handling”, and Chapter 7 on “Preparation and planning”;
During Voyage—Group 3, including Chapter 8 on “Monitoring”; and
After Voyage—Group 4, including Chapter 9 about “Arrival”, and Chapter 10 containing “Examination”.

In a software implementation, the Group and Chapter specification may be implemented in a “Chapter & Groups classification” software module.

A detailed description of the training content is specified separately in the working documents for each chapter, which may be provided by Furuno INSTC instructors. In an exemplary structure of the NavSkills CAT ECDIS type specific training, a name for a working document may be composed by: Group no.-Chapter no.-Section no.-Contents no. As an example, the contents of the “Introduction” in group 1, chapter 1, section 1 are named: “1.1.1.1. Start-up and shutdown.docx”, and so on for other groups, chapters, and sections.

Detailed exemplary group and chapter specification are provided below. The contents of the group and chapter specifications refer to the definition of the contents which may be set by the INSTC instructors according to a common time plan. The groups may include exercises, which may be in any form. Exemplary exercise types are multiple choice tests, explanatory-type response exercises, and practice exercises on a realistic simulation interface.

An exemplary specification of group and chapter contents includes:

### General—Group 1

Chapter 1: Familiarization with available functions
Chapter 1, Section 1—Introduction
   1. Introduction
   2. Start-up and shutdown
   3. Control unit
   4. Mouse function
   5. Status bar
Chapter 1, Section 2—ECDIS Overview
   1. Information area
   2. Datum
   3. Time
   4. Alert and Alert queue
Chapter 1, Section 3—Menu Structure
   1. Main menu
   2. Chart menu
   3. Closing a menu or function
Chapter 1, Section 4—Nice to Know Functions
   1. Info
   2. Operation
   3. Function Keys
   4. Standby
   5. Restart
      Chapter 2: Manuals and help
Chapter 2, Section 1—Manuals
   1. Operators Manual
   2. Operators Guide
   3. Help
   4. ECDIS Chart 1
Chapter 2, Section 2—Hardware and Software
   1. Hardware and Maintenance
   2. Operating system, software, firewall and antivirus
Chapter 2, Section 3
   1. Exercise no. 1 (Function keys, Datum and Standby)
Chapter 2, Section 4
   1. Multiple Choice 1

### Pre-Departure—Group 2

Chapter 3: Sensors and input
Chapter 3, Section 1—Sensors
   1. Sensors
   2. Kalman Filter
   3. Record own position manually
   4. Dead Reckoning
Chapter 3, Section 2—Connected Equipment
   1. Fall Back
   2. Anchor Watch
   3. NAVTEX
   4. Safety Message
   5. Tracked Target
   6. AIS
Chapter 3, Section 3—ECDIS Mindset
   1. ECDIS mindset
Chapter 3, Section 4
   1. Exercise no. 2 (Sensor Input) & 3 (CPA, TCPA & AIS)
Chapter 3, Section 5
   1. Multiple Choice 2
      Chapter 4: Visual settings and safety contour
Chapter 4: Section 1—Visual Setting
   1. Chart Display
   2. Chart Alerts
   3. Symbol Display
Chapter 4, Section 2—Vector and Maneuvering
   1. Vector
   2. Predictor
Chapter 4, Section 3
   1. Exercise no. 4 (Chart Display) & 5 (Chart Alerts)
Chapter 4, Section 4
   1. Multiple Choice 3
      Chapter 5: Documentation and file handling
Chapter 5, Section 1—Mob and Event
   1. Event
   2. Man over board
Chapter 5, Section 2—Records
   1. Voyage Log
   5. Chart usage Log
   6. Back-up and restore
   7. Voyage log as a user chart
Chapter 5, Section 3
   1. Exercise no. 6 (Voyage Log as a User Chart) & 7 (Backup & Restore)
Chapter 5, Section 4
   1. Multiple Choice 4
      Chapter 6: Chart handling
Chapter 6, Section 1—Chart Management
   1. Chart Catalog
   2. Permit
Chapter 6, Section 2—Updating Charts
   1. Update ENC
   2. Update RNC
   3. Chart Legend
Chapter 6, Section 3—Chart Handling
   1. Manual updates
   2. Remove charts
   3. Chart viewing dates
   4. T&Ps
   5. Multimode
Chapter 6, Section 4
   1. Exercise no. 8 (Chart Catalogue), 9 (Loading a Permit), 10 (Updating ENC Charts), 11 (Chart Legend), 12 (Chart Viewing Dates)
Chapter 6, Section 5
   1. Multiple Choice 5
      Chapter 7: Preparation and planning
Chapter 7, Section 1—Route Planning
   1. Navigation parameters
   2. Route plan
Chapter 7, Section 2—Route Planning Tools
   1. Import
   2. NAVMARK
   3. Hard copy
Chapter 7, Section 3—Overlays
   1. User chart
   2. Notes
Chapter 7, Section 4
   1. Exercise no. 13 (Create a Route Plan), 14 (Create a Note), 15 (Create a User Chart)
Chapter 7, Section 5
   1. Multiple Choice 6

### During Voyage—Group 3

### Chapter 8: Monitoring

Chapter 8, Section 1—Monitoring
   1. Route monitor
   2. User chart
   3. Notes
Chapter 8, Section 2—ETA
   1. ETA and ETD
   2. Chart alert
Chapter 8, Section 3—Modes of Using ECDIS
   1. Navigation, pilot on board, standby
Chapter 8, Section 4—Mob and Event Marks
   1. Man over board
   2. Event
Chapter 8, Section 5—NAVTEX Updates
   1. Manual updates with information from NAVTEX
Chapter 8, Section 6
   1. Exercise no. 16 (Monitor the Route Plan)
Chapter 8, Section 7
   1. Multiple Choice 7

### After Voyage—Group 4

### Chapter 9: Arrival

Chapter 9, Section 1—Arrival
   1. Saving the voyage log
   2. Chart usage log
   3. Trip counters
   4. Standby
Chapter 9, Section 2
   1. Exercise no. 17 (Reset Trip Counters), 18 (Reset Voyage Log)
Chapter 9, Section 3
   1. Multiple Choice 8

### Chapter 10: Examination

Chapter 10, Section 1—Examination
   1. Examination, Multiple choice test
   2. Printing of the Certificate
   3. Goodbye and Contact Information

Free Run

The menu for the selection of a “Free run” (S558) is discussed next. The Free run mode provides the possibility to take advantage of the simulator controlling the training environment, by operating the simulator system freely (S564). For example, an ECDIS simulator may control the ECDIS training environment, by operating the simulator system on NavSkills CAT freely.

User Profile

The menu for the selection of a “User profile” mode (S560) is discussed next. The User profile provides the user with the possibility to change and update the information registered in the NavSkills CAT cloud environment (S566). In one exemplary embodiment, the user can update the user profile, but the user can not delete the user profile. With this mode, the information inserted during the initial user registration process, i.e., name, birthday and gender information, may be changed, corrected and/or updated by the user, as necessary.

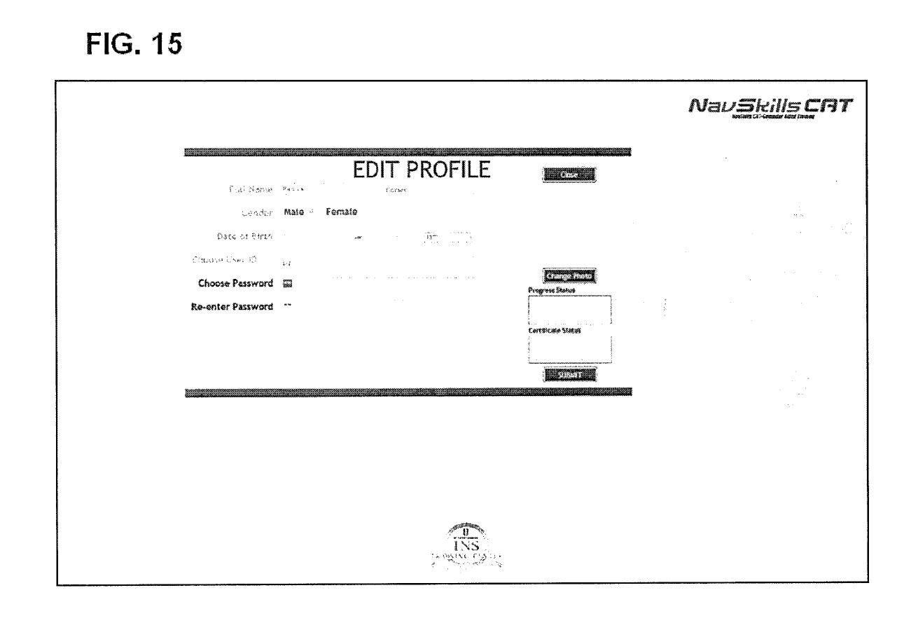

FIG. 15 illustrates an exemplary screen that appears when a user selects “user profile” (S560). The user has to fill in the details and click on ‘Submit’.

User Support

The function of the User Support is to provide direct support to the user. The user support is provided by user support module 315 shown in FIG. 9. The support is provided by instructors, which have been assigned by, e.g., Furuno, to be available for user support around the clock from anywhere in the world. The user simply requests to talk to a training instructor. The training instructor on duty will be contacted and would then provide the necessary support to the user. The user may communicate with the instructor by a headset with a speaker and a microphone. The communication between the user and the instructor may preferably be made by VoIP or VoLTE, but other types of communication may also be used.

User and Certificate Control

FIG. 16 is a flow diagram illustrating an exemplary process flow for user and certificate control in a NavSkills CAT platform, according to an embodiment of the present invention illustrated in FIG. 9. The function of the user and certificate control (S608) is to register user information (S609), register training progress/results (S610), and control the certificate function (S611). The user and certificate control function is performed by the user and certificate control module 325 shown in FIG. 9.

The NavSkills CAT system maintains user data for a longer period of time, as the type specific or generic certificate may be valid infinitely in the present implementation of navigation laws. Thereby, an exemplary database (S602) is designed to hold the following data:
1. Name—the giving and last name
2. Date of birth
3. Gender—Female or Male
4. Picture—For control and verification purpose
5. Login details: User name and password
6. The type of equipment the type specific training has been completed in
7. Training course number
8. Training, exercises and tests completed
9. Status of certificate i.e. date of issue and certificate number
10. List of workstations accessed during the training.

The reason for registering the workstations on which the user has conducted the training (item 10 above) is to provide the ability to trace any misuse by the user.

In an exemplary implementation, the NavSkills CAT platform provides access to 5 types of users that have different access levels and usage of the system (S615). The 5 types of users are:
Navigational officer (604)
Vetting or Port State Officer (605)
NavSkills Training centres (606)
Instructor for IOD support (607), and
Administration (603).

These and other types of users may be defined in the NavSkills CAT platform. Exemplary access types and usage modes associated with different user types are described in more detail below.

Type of User:Navigational Officer

For a navigational officer, the user will be registered under a user profile. The user profile may initially contain name, date of birth and gender inserted by the user (S613). During the registration process, the user may be guided to obtain a photo that will be assigned to the user profile (S612). The data input is done such that incorrect data input is reduced, and there is a clear distinction between the first and the last name. Data such as date, month, year and gender may be implemented to be selectable. The picture may be obtained using a webcam or other image-taking device.

The system may register the progress of the user training. When the user has completed a training chapter by successfully completing the test, the system registers such progress, both for the purpose of easy user re-entry, and for assessment to validate granting a certificate (S619). To validate that the correct, single user performs the training from the start to the point of granting the certificate, the webcam may randomly obtain a picture that will be stored in conjunction with the user profile.

The training platform would also assess the progress of the user to grant the certificate upon successfully completing the training program. The user will be granted the possibility to print one certificate only. In general, the user is responsible for the provided information in the user registration process. At the step of printing the certificate, the user will have to confirm or validate the information on the certificate.

The printed certificate documents that the user has completed the type specific or generic computer aided training. If the certificate is lost or damaged, the user has to contact a training center, e.g., Furuno INSTC. Furuno INSTC will then make the lost or damaged certificate invalid, and will prepare the system to grant the user the possibility to print out the new certificate once.

A navigation officer may already hold a certificate of training before using the NavSkills CAT system. For example, the navigation officer may have already received a certificate for completing Furuno generic ECDIS training such as, e.g., ref. IMO model course 1.27, or a Furuno ECDIS type specific training in a NavSkills facility. Such navigational officer is then able to acquire access to the NavSkills CAT environment, for refresh training (S622). When registering as a new user in the NavSkills CAT system, the navigation officer would checkmark “Existing certificate holder” in the training interface, and would be instructed to enter the name specified on the certificate as well as the certificate number.

The training system then validates the navigation officer according to the NavSkills CAT certificate database. If correctly registered, the navigation officer is granted access to the training/tutorial part with no limitations apart from access to the final test section.

This function requires that the existing certificate holders be registered in the NavSkills CAT platform. Such registration data may be obtained from INSTC for example, and may be prepared and compiled to include the following information:
1. Given name and last name
2. Date of birth
3. Gender
4. Equipment type
5. Training course number
6. Certificate number

The registration data may be available in MS Excel format; however, any other format may be used, depending on how the data is made available from INSTC, and depending on the requirements for compiling and entering data into the NavSkills CAT system.

Type of User: Vetting or Port State Officer

A Vetting or Port State Officer should have easy access to the system by a secure web portal to verify the validity a certificate (S620). The web portal welcome page may contain relevant information of the service and login with user name and password provided by INSTC. The Vetting or Port State Officer gains access to a Certificate Validation function, and, with the Certificate Validation function the Vetting or Port State Officer can verify the validity of a type specific or generic certificate. For example, validity of Furuno ECDIS Type Specific Certificates may be verified.

The Vetting or Port State Officer may have to insert only a minimum of necessary information from the certificate in question, and press a Verify button to receive one of two results: Valid or Not Valid. The minimum information may, in an exemplary embodiment, be determined to be:
Given name and last name
Equipment type, and/or
Certificate number

If further control is necessary, optional information can be inserted, which may include:
Date of birth
Gender
Course number
Date of issue

The verification process may provide only a “Valid” or “Not valid” response. When the combination of the inserted data is correct, the system acknowledges entries by displaying “Valid”. If for any reason the inserted information is incorrect, the result will be “Not valid” with a service information message which would state, e.g., “Kindly check and correct entered data”. A Time out function may return the user to the front login entrance.

Type of User: NavSkills Training Center

The NavSkills CAT platform may also house, control and handle all Furuno Training Certificates, such as, e.g., all Furuno ECDIS Type Specific Training Certificates. The NavSkills Training Centers may acquire secure web access to the system to register and record participants in type specific and generic training (S616).

The NavSkills training centers may access the system by an internet browser to a web address previously provided to them. The web access welcome page may contain information of the service and login with user name and password provided by INSTC. With the login rights, the Furuno NavSkills training center may gain access to enter each participant of a type specific or generic training course with 8 entry lines, where each line holds the following information:
1. Giving name
2. Last name
3. Gender
4. Birth day
5. Birth month
6. Birth year
7. Date of completion of type specific training course
8. Month of completion of type specific training course
9. Year of completion of type specific training course
10. Training equipment type
11. Check mark for the Instructor to acknowledge that the student passed the final test
12. Test score by 3 digits of numbers 1 to 9.
13. Path and name to copy of scanned test results file
14. Questionnaire result by 1 digit of numbers 1 to 5
   The 2^{nd} to 8^{th} entry lines may have certain positions as a first information line, and items 7, 8, 9 and 10 may be automatically updated with the same information from the first information line.

After a NavSkills training center instructor presses the upload button, he or she receives a system return of the entered information to acknowledge and confirm that the information is correct by pressing the Confirm/Ok button. The system then generates the certificates (S619) and a new window appears for the instructor to print out each certificate. For each printed certificate, the instructor acknowledges if the print is ok, or indicates that it is necessary to print the certificate again.

The instructor would be informed clearly about the procedure and the importance of entering and verifying correct data. When the instructor has confirmed that the certificates have been successfully printed, the system registers the status and locks the certificate print function.

The NavSkills training centers may choose to use a special template with their own logo and training center information. The NavSkills training center may, for example, be identified during login, and the designated template may be selected for the certificate printing. If printing is not possible for any reason, the system presents the possibility to print out any certificate that was not printed, at the next access by the NavSkills training center login. A time out function may return the user to the login entrance.

Type of User: Instructor for IOD support

The function of the user support as Instructor On Demand is to provide direct support to the user, in English or in any other required language (S617). In classroom training, the support of an instructor is vital. NavSkills CAT therefore extends the computer aided training to provide similar support.

The NavSkills CAT system presents the type specific or generic training in an intuitive and easy to work manner. The system may be configured to be able to advise or make information easily available for the user, for easy access. In case the user requires support, the IOD button may be activated and the user would shortly be assisted by the instructor on duty (S618). The instructor can answer any questions concerning the equipment usage and operation as well as questions related to the NavSkills CAT system. Furuno may assign instructors to be available for user support around the clock from anywhere in the world.

The availability of the IOD is clearly indicated to the user upon pushing the IOD button (S617, S618). If an instructor is not available at that specific time, the opening hours are to be clearly advised, in the form of a message, such as:
INSTC Copenhagen GMT+1 hours working hours of 08:00 to 16:00 hours.
INSTC Singapore GMT+8 hours during working hours 08:00 to 16:00 hours.

The instructor on duty may also receive a notification when his help is requested after hours by a user. Based on the notification, the instructor logs into the system, to be available to support at the time of the user's request.

The instructor may have a separate environment or interface that presents him with an overview of the users that require support. The interface may present this information to the instructor automatically, or if the instructor has required information about the user. The user may be displayed by name, equipment type the user is being trained on, and time of requesting support. The instructor may select the first user in line, but any user can be selected when the instructor is ready and available. The instructor may also select to view the same screen information/display as the user is having at that time in the cloud environment, in order to optimize the support and communication with the user.

When the instructor responds to a user request, the NavSkills CAT system may perform the following process steps. 1) A window is displayed on the user monitor with a welcome message and to prepare the user to put on and activate the headset and place the microphone in front of the mouth and thereafter press the Ready! button. 2) The system then makes the necessary connection between the user and the instructor to communicate by the microphone and headset. When the connection is made, a certain icon, such as, for example, a larger headset icon similar in size to the squared mouse icon, in an exemplary embodiment, is placed on one of the monitors (e.g., in the upper right corner of the right monitor, in an exemplary embodiment) with an indication that a connection is made. 3) The instructor then welcomes the user and introduces himself/herself. Thereafter the instructor provides support to the user, as needed.

If the instructor is not able to acquire a steady communication connection, the instructor can select to display a window that will appear on the user monitor. The instructor is then able to write messages for the user to answer. When the IOD session is complete, the instructor ends the communication, closes the window and disables the support to the user. 4) Upon completion, when the instructor ends the support and is disconnected from the user environment, the user is deleted from the support request overview.

During instructor log out, a notification or confirmation of logout is generated, to indicate that the instructor is no longer on duty.

It is preferable to have more than one instructor logged in at one time. The overview indicating user requests may then be shared between the instructors. Each instructor may also have an overview of other instructors that are online, and may communicate with them by the headset if necessary, to exchange support. Also, the overview of user support requests may be configured to indicate if a user is supported by an instructor, and also which instructor provides the respective support.

In case no instructor is available or logged in, the user would be notified by a window appearing on the user monitor or by a message. The notification provides information regarding the time when the instructor will be available.

It is noted that the NavSkills CAT platform can also be configured to allow users (e.g., navigators) to share answers between them when they review the correct answers to various training exercises. Also, instructors may communicate with users and share various user answers between instructors and with other users, when, for example, certain users' answers include useful new features or more clear explanations that may be incorporated into training.

Type of User: Administration

An administrator, such as, for example, a Furuno INSTC administrator, may log into the NavSkills CAT system and enter a designated environment to perform the following functions: change and correct user profile data (S614); re-issue certificates (S621); manage the different user access accounts (S615); extract statistical data (623); and assess user profiles and test results (S624).

When the administrator wishes to change and correct user profile data, the user profile data is locked upon issuing a certificate. Therefore, any further changes to the profile have to be accepted by the administrator, as the data is being used to be displayed on the certificate. If the user wants to change user data, the user should be informed that the change could result in re-issuing of the certificate. If the user acknowledges that the changes should be made, the administrator is notified to validate and accept the changes.

The administrator may also re-issue certificates. In case the navigator (user) looses or damages a certificate, the navigator should contact and inform Furuno INSTC accordingly. The administrator then annuls the existing certificate and unlocks the certificate printing. The navigator can choose to print out the certificate on the NavSkills CAT workstation if such is enabled on the specific workstation, or to have Furuno INSTC print out and forward the certificate by mail or currier.

The administrator may also manage the different user access accounts. The administrator may manage the instructor accounts for IOD support as well as accounts for Vetting or Port State Officers.

Presently, instructors for IOD support are available from INSTC Copenhagen and INSTC Singapore, and the instructor accounts are typically created with user name and password. The administrator may create such instructor accounts and specify log in information for the respective instructors providing IOD support. The Vetting or Port State Officer accounts may be controlled by the administrator as well.

The administrator may also extract statistical data from the NavSkills CAT system. For this purpose, the administrator may have access to a search tool to acquire data for statistical purposes. As an example, such statistical data may provide information about how many training courses Furuno Singapore has held in March 2012 for FEA-2x07 ECDIS. Statistical data may also include navigators' assessments concerning the training they have received, results provided by an evaluation team that tests the training provided on the preferred platforms and from the chosen suppliers, i.e., for products/equipment of the respective suppliers.

A search tool may also assist in handling the user profiles and certificate management.

The administrator may also assess user profiles and test results. For this purpose, the administrator has access to the user profile information, training and certificate status and may be able to validate the uploaded test results, and the user pictures taken during the training session.

User profiles may be set up such that they can be erased and deleted. While the specific user information is not important, the statistical data is. The extraction of statistical data may be performed later, when a need or requirement for the statistical data has been established. Thus, profile information may remain in a system even when the user is not registered anymore with the NavSkills CAT system. That is because certain statistical data may be determined to be valuable long after a user has last been registered into the system. Thus, statistical data may be extracted at any time, regardless of the status of users as present or past users in the NavSkills CAT platform.

Certificate Printing

The function of the certificate printing is to print out a certificate upon the successful completion of the training by a user. Certificate printing is performed by certificate printing module 330 shown in FIG. 9.

When a user has been granted the possibility to print out a certificate, the certificate will be printed and a window appears for the user to verify that the information on the certificate is correct and the print-out is acceptable. If the information is ok and the print-out of the certificate is acceptable, the user acknowledges by hitting a Confirmed button. If the information is not ok or the print out is not acceptable, the user will hit a Reject button and return to main menu of the certificate printing. The user will have the possibility to correct information in the user profile and to print out another certificate.

In an exemplary implementation, a Furuno type specific certificate may be created to include two parts separated as a graphical part and a text part. The graphical part function may function as the background of the certificate, where all colors, headline, logo and company information are affixed for the training centers in *.ai and *.png format. The text part may be represented as a MS Word document in *.docx format. For example, Furuno INSTC offices, including Copenhagen and Singapore, use the NavSkills TC INSTC certificate template. The NavSkills training centers may use their own templates, such as, for example, Compass, Furuno Germany, GMC, Moloobhoy and Ocean.

An exemplary certificate may include information about the training course number definition, in the following format:

xxxx-WXX xxxx=Year, XX=Week number
2012-W26 W26 in the year 2012
The exemplary certificate may further include certificate number definition in the following format:
TExxxxx TE=Type specific, xxxxx=5 digit number increase in steps by 1 per certificate.
TE00832 Certificate number 832
An exemplary generic ECDIS certificate number definition may be in the form of:
xxxxx xxxxx=5 digit number.
An exemplary start number for NavSkills CAT certificates may be in the range of 02000.

Logout

The function of the Logout is to log out the user from the cloud environment. Logout is performed by logout module 335 illustrated in FIG. 9.

Layout and User Interface

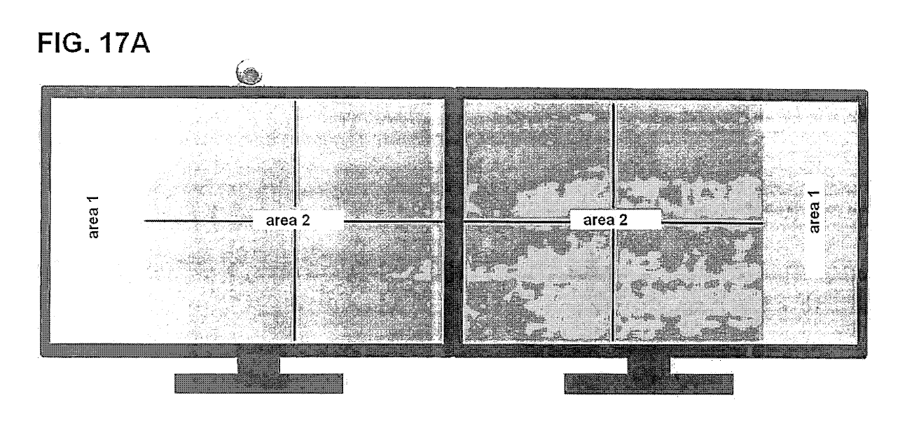

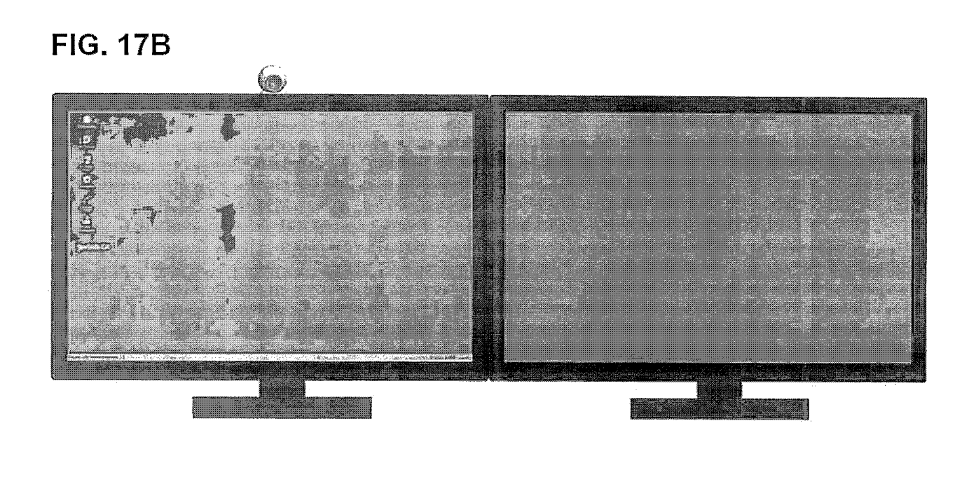

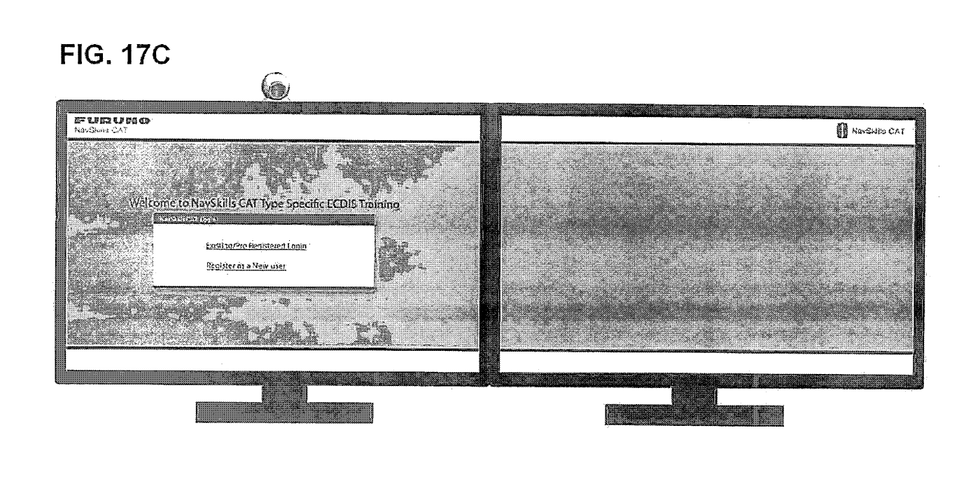

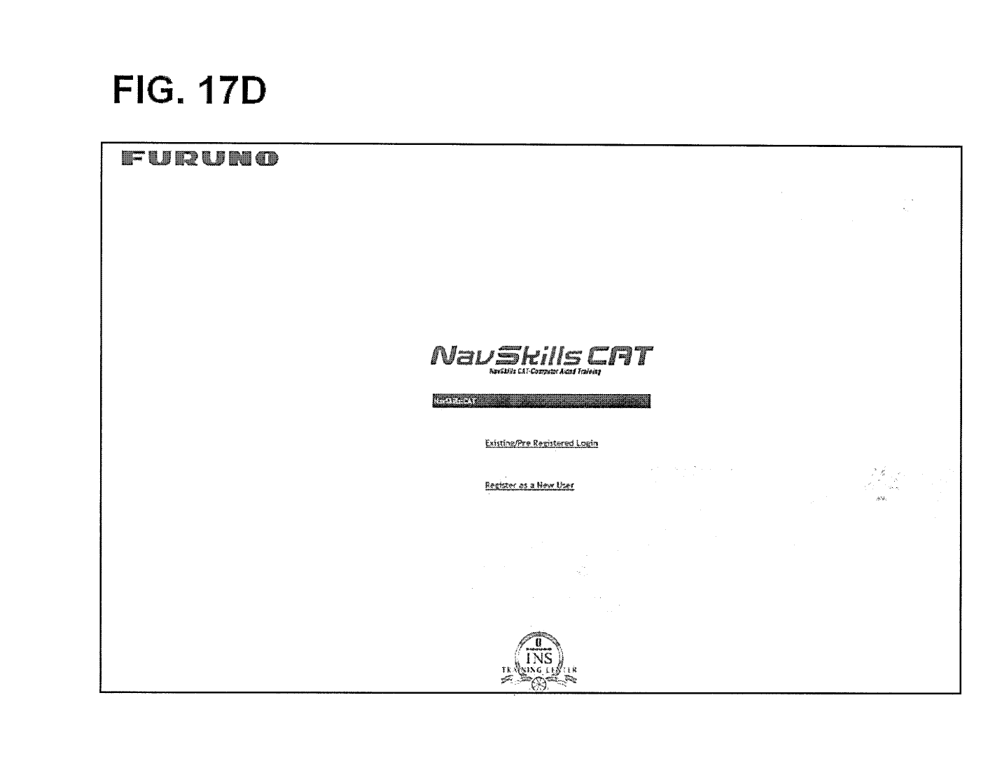

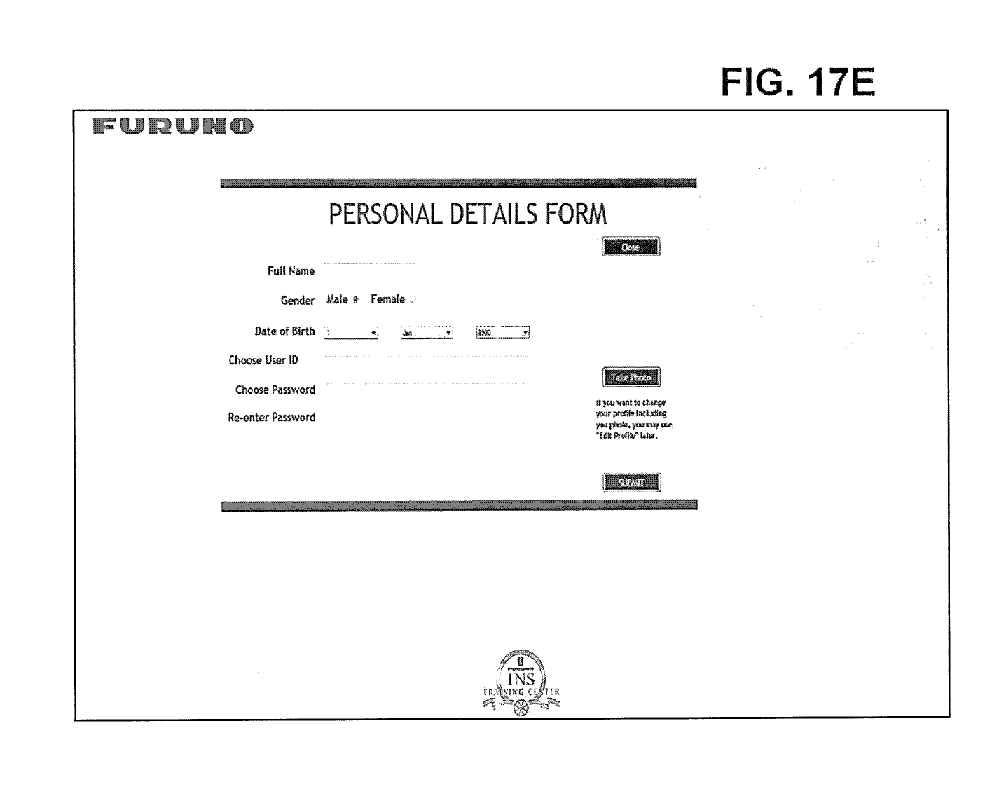

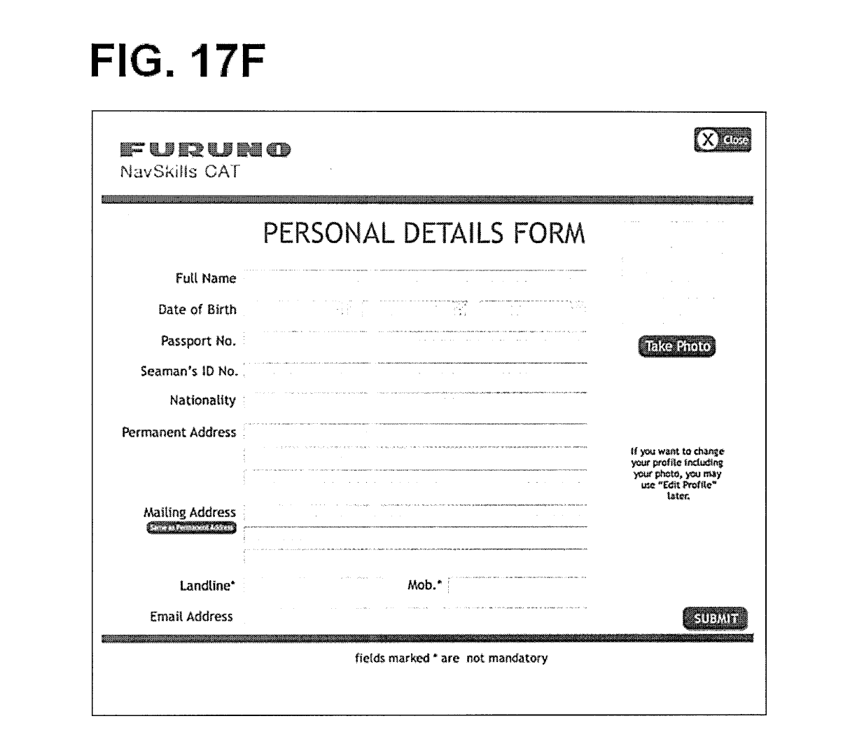

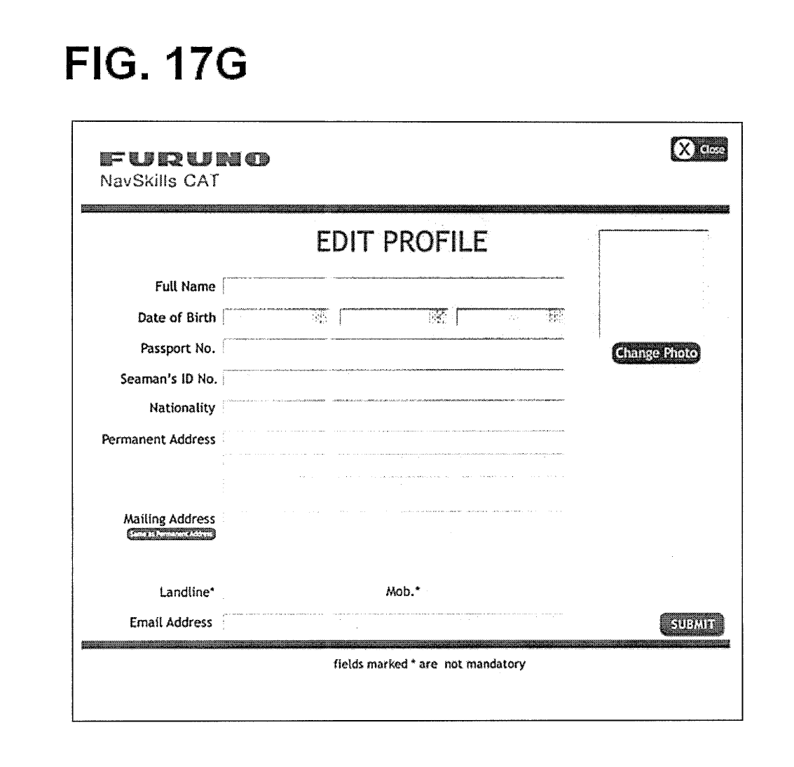

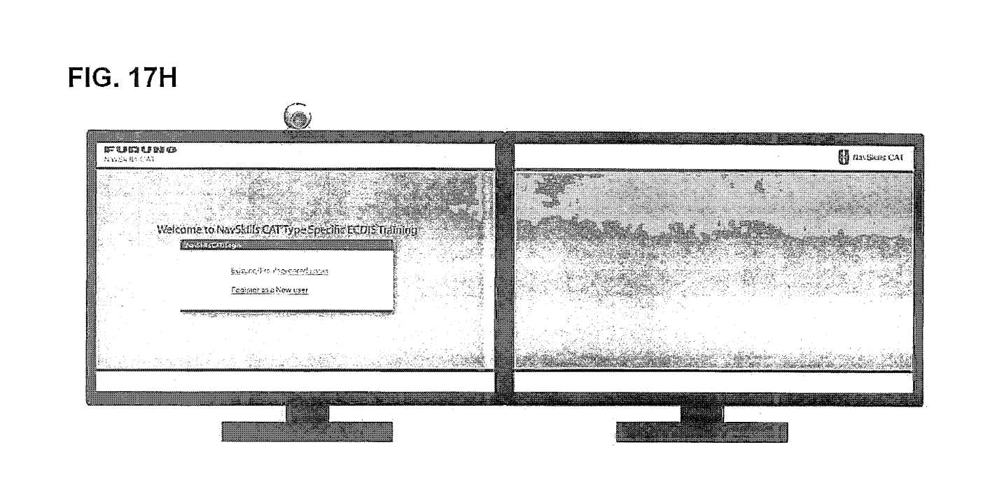

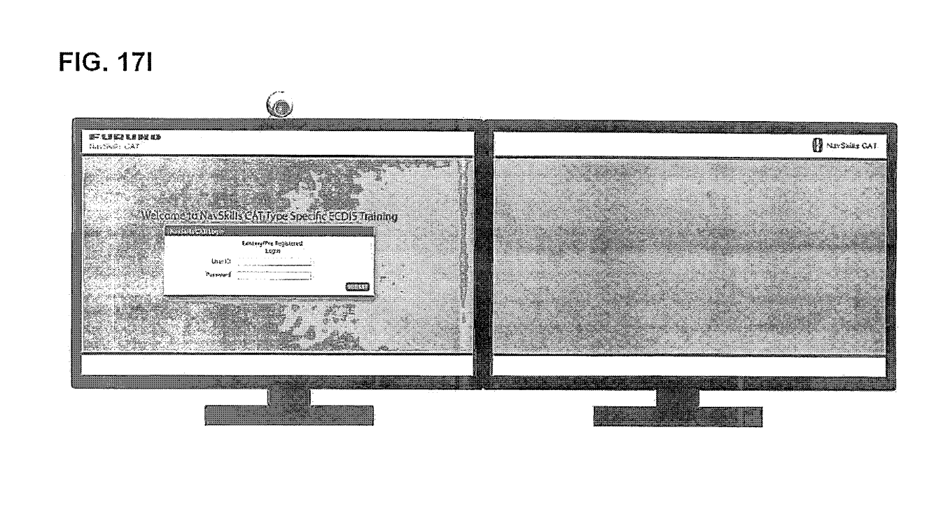

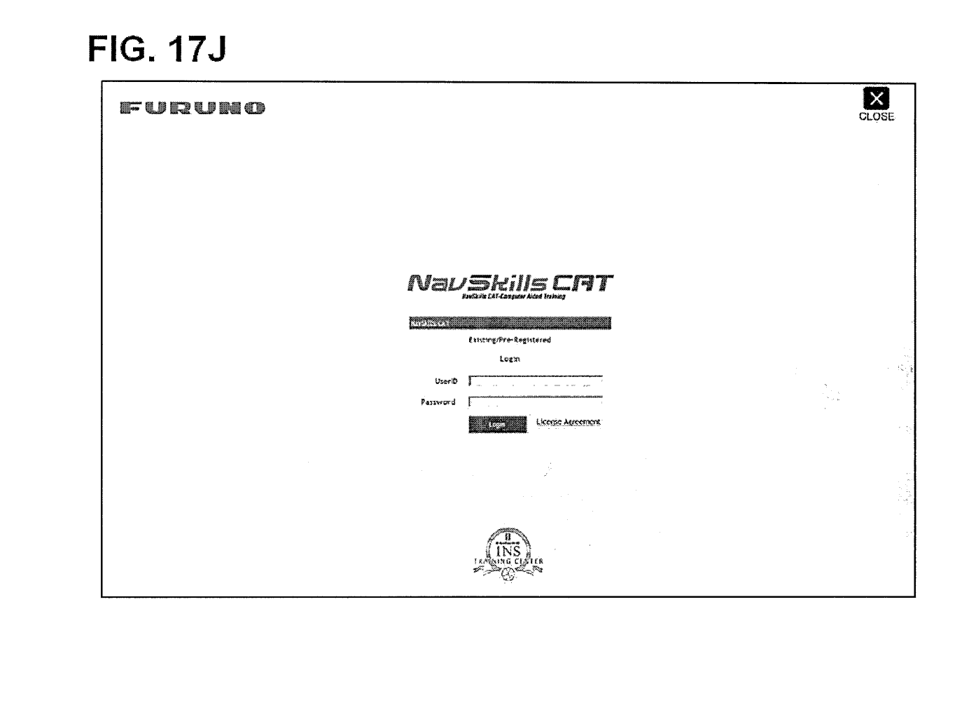

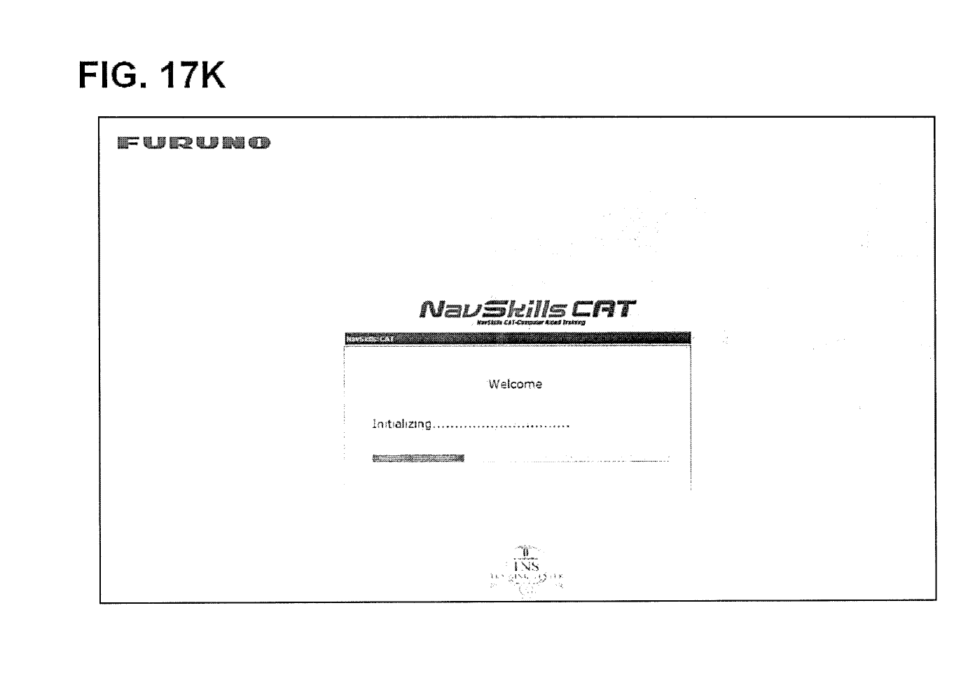

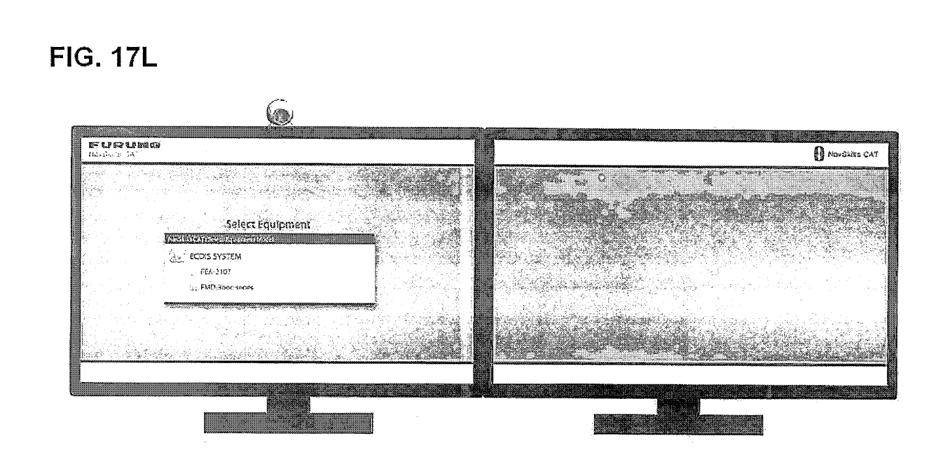

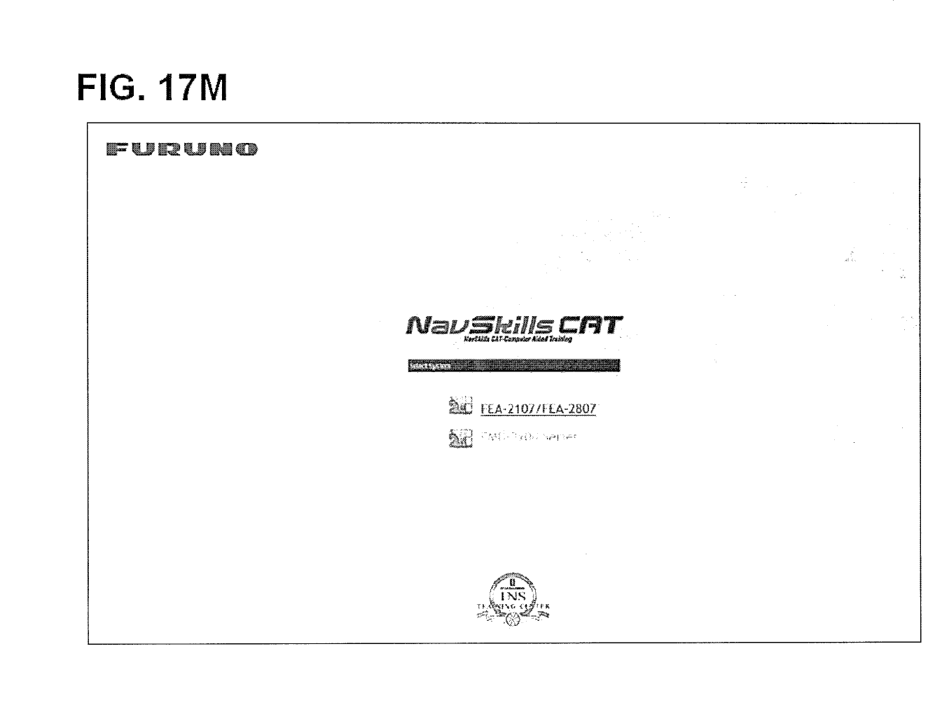

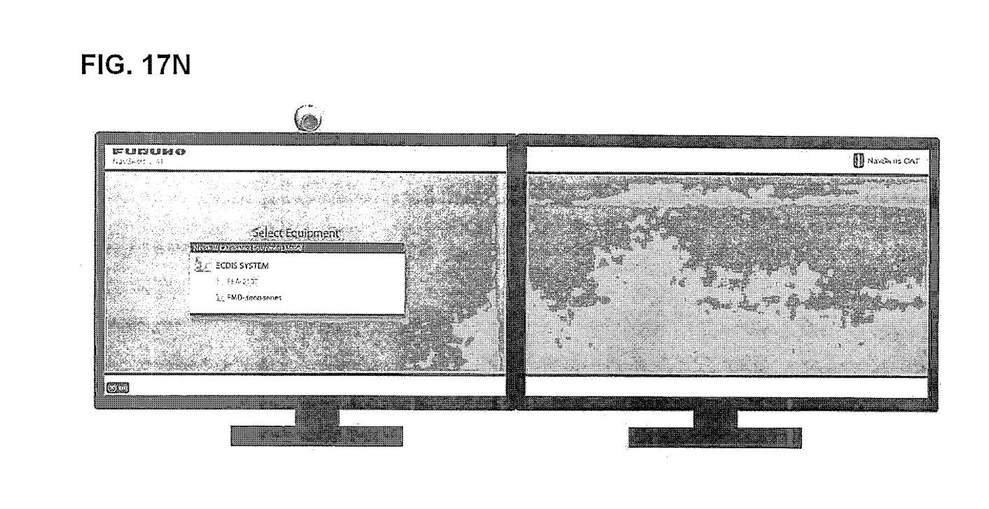

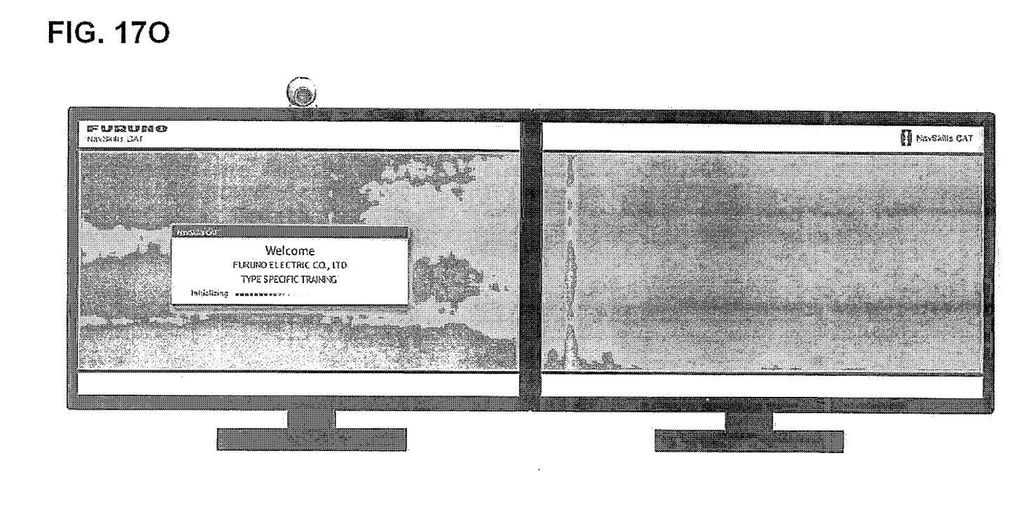

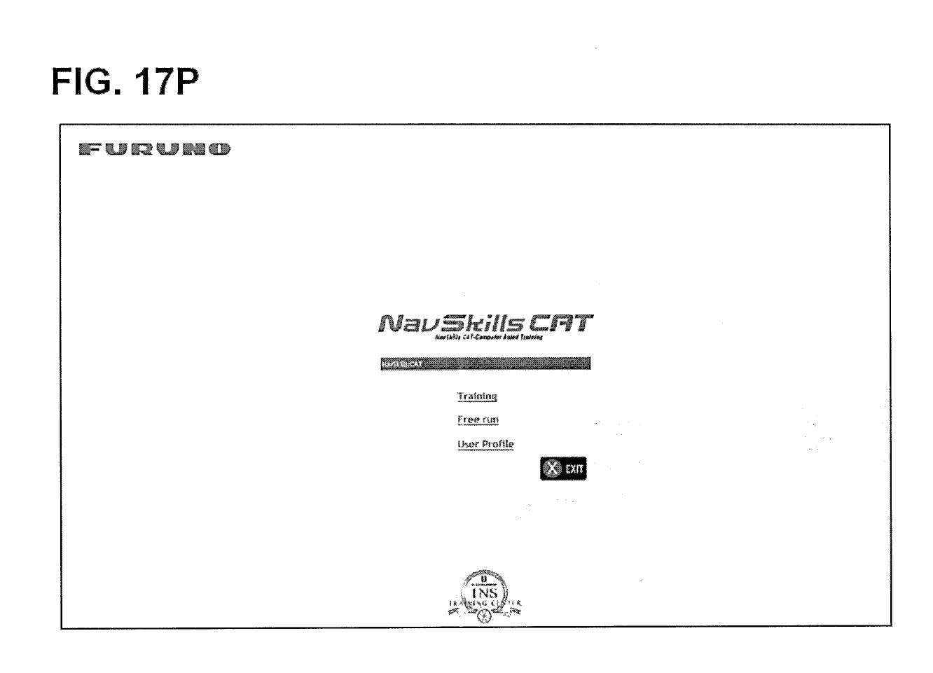

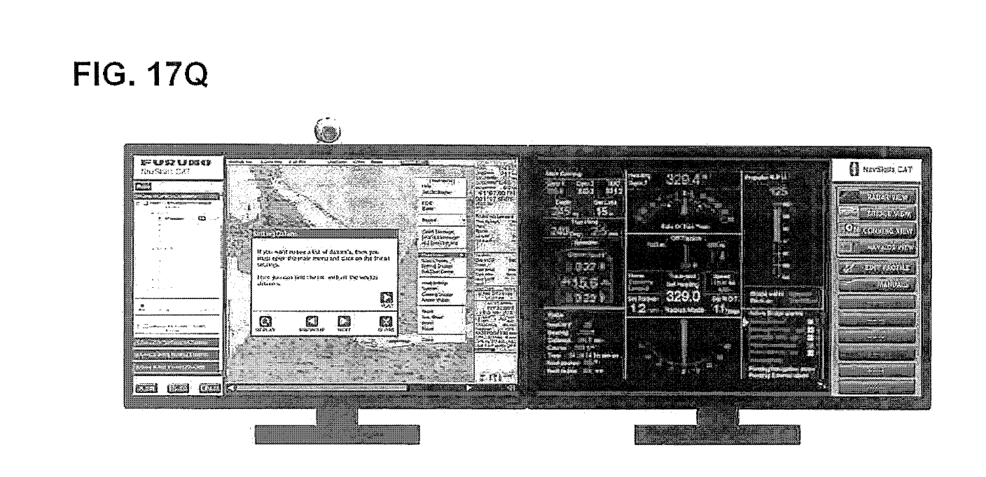

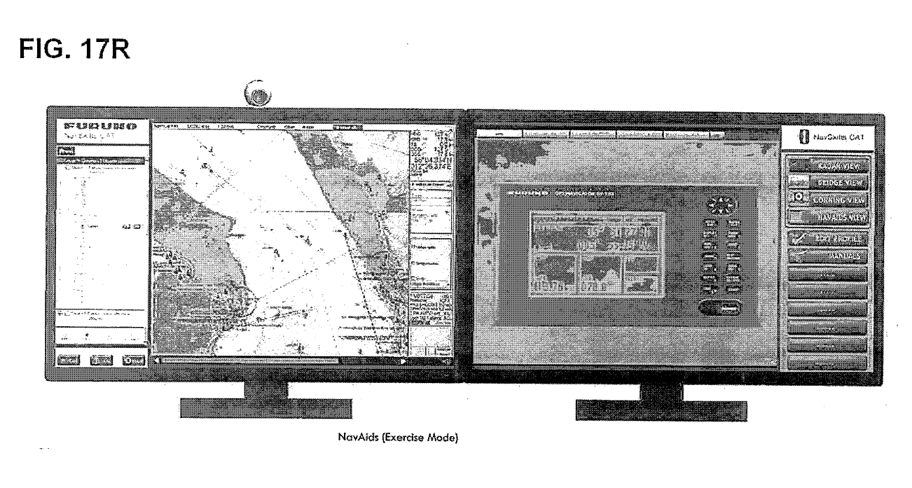

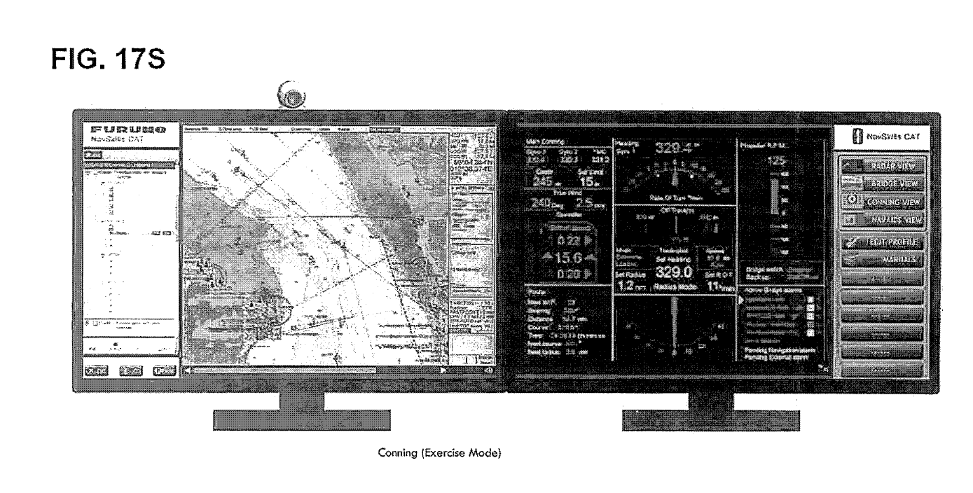

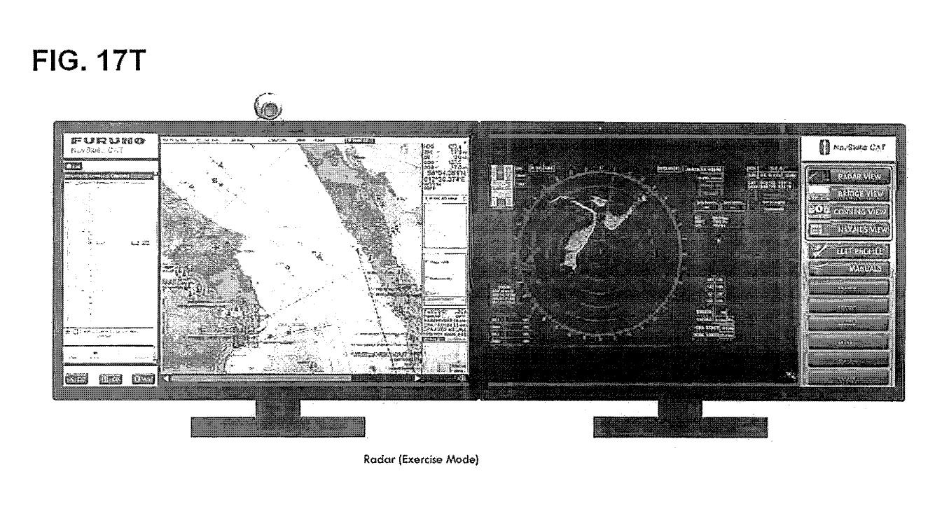

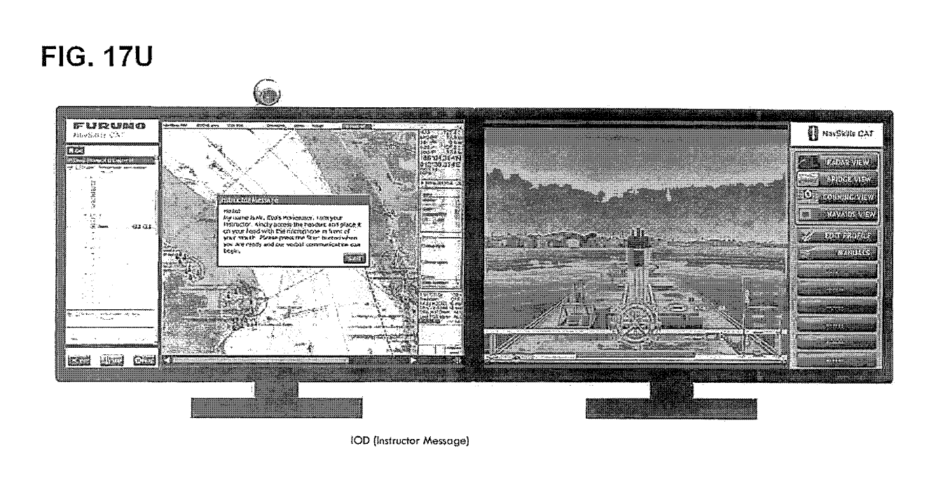

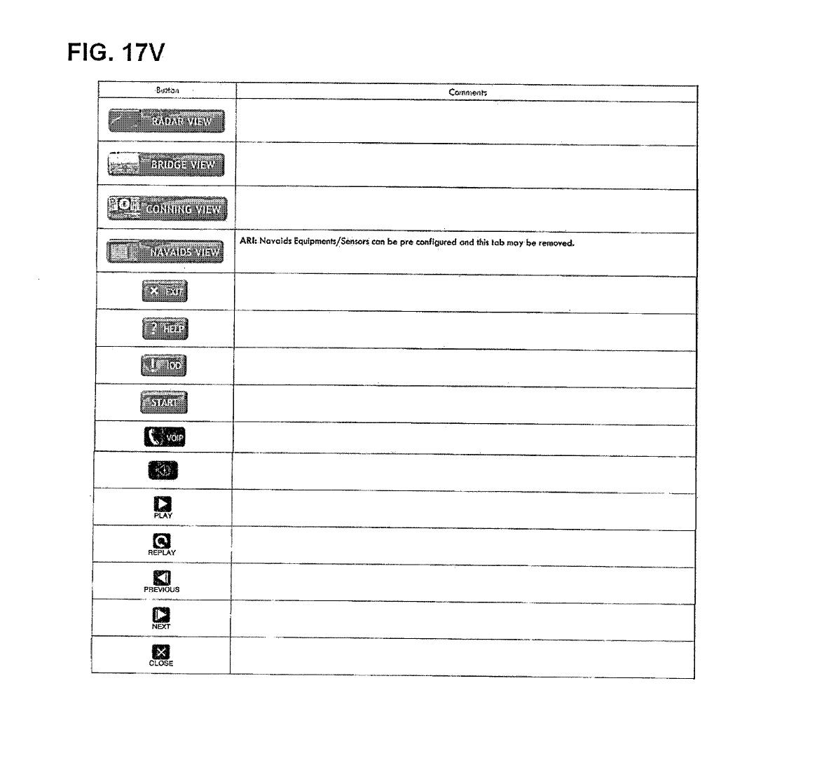

FIGS. 17A-17V illustrate details of an exemplary layout and user interface in a NavSkills CAT platform, according to an embodiment of the present invention illustrated in FIG. 9.

FIG. 17A illustrates an exemplary monitor set for use in an exemplary NavSkills CAT workstation 8, according to an embodiment of the present invention.

In an exemplary implementation, two monitors are used by a user of the NavSkills CAT system. As previously mentioned, exemplary monitors may each have a diagonal monitor size of 27″. Exemplary monitors may each have an area with a resolution of 1680×1050 pixels at one side of the screen (area 1), and a second area with a resolution of 1280×1024 pixels for the other portion of the screen (area 2). A camera may be located in the room where the monitor is located.

FIG. 17B illustrates an exemplary desktop that appears after the monitor set for the NavSkills CAT workstation is turned on. FIG. 17C illustrates an exemplary login screen that appears when a user wishes to use the NavSkills CAT system. FIG. 17D illustrates another exemplary login screen that appears when a user wishes to use the NavSkills CAT system. The login screen provides the option to login as a new user or as an existing or preregistered user. The user can click on existing pre-registered user if he already has a login id and password, or click on register as a new user to create one.

FIG. 17E illustrates an exemplary login screen that appears when the user selects registration as a new user. The user needs to fill up the data and then click on submit to register. FIG. 17F illustrates another exemplary screen presented to a user for login and registration. The registration/profile form includes several fields in which the user enters the appropriate information. Some fields are mandatory while others are optional. FIG. 17G illustrates an exemplary screen presented to a user for editing or changing profile information during login/registration, or at other steps during training. For example, the user may need to update or correct his personal information after the initial registration has been completed.

FIG. 17H illustrates an exemplary login screen that appears when the user selects the existing or preregistered user login option, which is shown with different highlighting in FIG. 17H. A trainee who is pre-registered can click on this option and continue with the login process to start the training. FIG. 17I illustrates an exemplary screen that allows login as an existing or preregistered user. FIG. 17J illustrates another exemplary screen that allows the login as an existing or preregistered user. The trainee has to enter his user id and password to login into the NavSkills CAT application. The exemplary screen shown in FIG. 17K illustrates that the application is initializing.

After the login process in complete, the trainee has to select the type of equipment or equipment model on which the user wishes to train.

In an exemplary embodiment, the user selects the model of the ECDIS on which he/she is to take the training. FIG. 17L illustrates an exemplary screen that appears after login and enables the user to select the equipment in which training needs to be performed. FIG. 17M illustrates another exemplary screen that appears after login, and enables the user to select the equipment in which training needs to be performed.

In the exemplary screen in FIG. 17L, the user may select training for one of two ECDIS systems. More systems (ECDIS and non-ECDIS systems) may be available for selection, and multiple training selections may also be enabled. FIG. 17N illustrates an exemplary screen that illustrates selected equipment for training, which is highlighted with a different color. FIG. 17O illustrates an exemplary initialization screen for starting the equipment training that was selected by the user.

Before going to training, the trainee may select between various training options. FIG. 17P illustrates an exemplary screen on which training, free run or user profile may be selected. These options were generally explained with respect to FIG. 14A. Not all options may be presented to a user, and the menu of options may depend on the type of user. For example, a beginner may be taken directly to guided training, while an experienced navigational officer may be shown more options, including training, free run and user profile shown in FIG. 17P.

Once the training is initialized, the user can select between various training options, such as demonstration, exercise mode, instructor support, etc. FIG. 17Q illustrates an exemplary screen for user training by demonstration. FIGS. 17R, 17S and 17T illustrate exemplary screens for user training in exercise mode. In FIG. 17R, the exercise mode shows a NavAids exercise shown in a 1280×1024 pixel resolution. In FIG. 17S, the exercise mode shows a Conning exercise. In FIG. 17T, the exercise mode shows a Radar exercise. FIG. 17U illustrates an exemplary screen for user training in IOD mode, in which an instructor is communicating with the user for training as shown on the screens. FIG. 17V illustrates an exemplary screen menu including buttons with which the user can select various training exercises and types of communication with instructor, as well as appearance characteristics and navigation controls functions.

FIGS. 18A-18U illustrate screens of an exemplary user interface for conducting training on a NavSkills CAT platform, according to an embodiment of the present invention illustrated in FIG. 9. The user interface may appear on a PC workstation or on other type of visual interface.

In a preferred embodiment, the workstation from where the virtual instance is accessed has a resolution of 1680×1050. When the module is loaded, a home screen is shown. FIG. 18A illustrates an exemplary home screen. The home screen appears on two adjacent monitors. FIG. 18B illustrates an exemplary screen on a left monitor for the user interface. FIG. 18K illustrates a screen on an exemplary right monitor for the user interface.

On the left monitor shown in FIG. 18B, various modes are shown. These include a demo mode, an exercise mode, and an MCT mode. A Menu showing structure groups, chapters, section and contents is also shown on the left monitor. An exit button, a pause button and IOD button are also present on the left monitor.

FIG. 18C illustrates an exemplary left screen on a left monitor for the training user interface, illustrating a tutorial in play mode. On the left hand side, the trainee can see the tree structure of the contents of training as shown in FIGS. 18B and 18C, including the four groups, with each group containing a number of chapters, each chapter containing a number of sections, and each section having various contents. Each content is a topic, corresponding to which there is a tutorial which can be played by the trainee. When the tutorial is played, the trainee sees a message window, on which a small description about the tutorial is written, along with the controls to navigate through the tutorial. The buttons that are available for the control are as follows:
‘Play’ button: To play the current animation set,
‘Replay’ button: To replay the tutorial from start,
‘Previous’ button: To go to the previous sub-animation in the tutorial,
‘Next’ button: To go the next sub-animation in the tutorial,
‘Close’ button: To close the tutorial and unlock the next tutorial (available only when the tutorial ends), and
‘Minimize’ button: To minimize the information box.

Besides these buttons, indication buttons are available for three modes in which the training is done. These buttons may select:
a ‘Demo’ Mode: in demonstration mode, the trainee views the tutorials.
an ‘Exercise’ Mode; in exercise mode, on the left hand side monitor, the trainee takes the exercise, and on the right hand side monitor, the instructions are given to the trainee on how to proceed to complete the exercise. FIG. 18D illustrates an exemplary screen for the exercise mode, and FIG. 18E illustrates an exemplary screen message displayed upon successful completion of the exercise;
an ‘MCT’ Mode, which is a multiple-choice test mode, in which the trainee is provided with multiple choice questions on the left hand side monitor which he/she has to answer; the trainee will not be allowed to proceed until he/she answers all the questions correctly, and the trainee has to take the test again until all questions are answered correctly; FIG. 18F illustrates an exemplary screen for the MCT mode.

In case all answers to the exercises in the MCT mode are not correct, a message is displayed requesting exercise retry. FIG. 18G illustrates an exemplary screen with a retry message.

When the trainee has successfully completed the MCT with all the answers correct, a proceed message is displayed. FIG. 18H illustrates an exemplary screen with a proceed message, which indicates that the trainee can proceed to the next tutorial.

The other three buttons on the left monitor are, as mentioned above, the exit button, the IOD button and the Pause button. The ‘Exit’ button is used to exit to the page where ‘Training/Free run/User Profile’ can be selected. The ‘IOD’ button (Instructor on Demand) is used to demand help from an instructor. The ‘Pause’ button is used to pause the tutorial being played. FIG. 18I illustrates an exemplary screen with a message indicating that IOD is available, and FIG. 18J illustrates an exemplary screen with a message indicating that an IOD is not available and indicating when an IOD will be available. Such messages may appear when the IOD button is selected.

FIG. 18K illustrates a screen on an exemplary right monitor for the user interface. The right screen of the training interface illustrated in FIG. 18K includes three buttons on the right hand side:
the ‘CAT Manual’ button which may be used to open the user manual of the ECDIS system as shown, in an exemplary screen shot shown in FIG. 18L;
the ‘Training Documents’ button which may be used to open the available supporting documents for understanding and going through the ECDIS course successfully, as shown, in an exemplary screen shot, in FIG. 18M;
the ‘Certificate’ which is enabled when the trainee completes the training and is ready to print the certificate.

The trainee can print the certificate after completing the course successfully. The trainee can print the certificate by clicking on the ‘Certificate’ button. FIG. 18N illustrates an exemplary screen that appears when a certificate would be printed. The trainee can see the preview of the certificate which will be printed. FIG. 18O illustrates an exemplary screen with a sample certificate before printing.

The trainee can review the certificate and then click on the ‘Print’ button if he/she finds that all the details are correct. After the print has been requested, the trainee is asked to confirm printing of the certificate whether it was printed correctly or there is any discrepancy. FIG. 18P illustrates an exemplary screen with a certificate printing message, and FIG. 18Q illustrates the larger screen on which the certificate printing message shown in FIG. 18P appears.

If the certificate has printed correctly, the trainee should click on ‘Yes’ else he/she should click on ‘No’ and repeat the process of printing the certificate. If the trainee tries to print the certificate before completing the training, he/she would be shown a warning message. FIG. 18R illustrates an exemplary screen shot with a warning message, and FIG. 18S illustrates the larger screen on which the warning message shown in FIG. 18R appears.

If the trainee tries to print the certificate after confirming the printing of the certificate, he/she is shown another message stating that the certificate has already been printed. FIG. 18T illustrates an exemplary screen with a message that the certificate has already been printed, and FIG. 18U illustrates the larger screen on which the message shown in FIG. 18T appears.

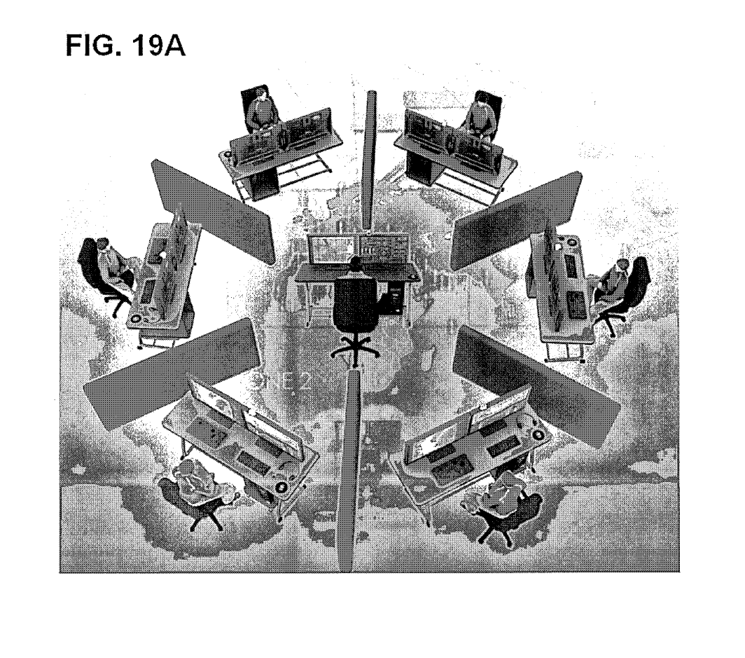

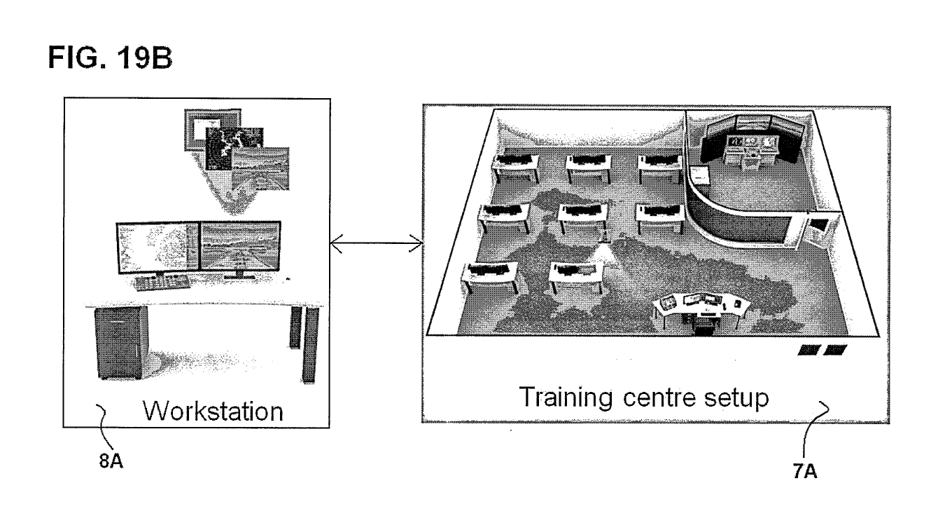

FIG. 19A is a diagram illustrating an exemplary NavSkills CAT training setting, according to an embodiment of the present invention. As shown in FIG. 19A, multiple NavSkills CAT training workstations, in different locations which may be as close as in the same room, or as far as on different continents, can be used for training, while a central station may monitor training, update the system, provide help, etc., using communications channels such as the cloud environment, the Internet, VoIP, VoLTE, or other means of communication and transmission of information.

FIG. 19B is a diagram of a set-up including workstation(s) and training centre(s) which provide training in a NavSkills CAT platform based on cloud computing, according to an embodiment of the present invention. As shown in FIG. 19B, a training centre setup 7A may include NavSkill CAT workstations, instructor workstations and Mini Bridges which are optional. In an exemplary embodiment customized for ECDIS training, a training centre setup includes 8 ECDIS workstations, 1 instructor workstation and 1 Mini Bridge.

A Mini Bridge works as a “Bridge System” simulator. Examples of simulators and implementation of simulators are provided by the Japanese train simulation game series Densha de Go! (internet link at http://en.wikipedia.org/wiki/Densha_de_Go), which includes simulators for various driving and train features.

An exemplary NavSkills CAT workstation 8A at a ship owner's office or on-board a ship may contain: a PC workstation with visual, ECDIS, Radar and Nav aids, a web camera and a fingerprint reader. Workstation 8A may be located in the training center 7A, or may be located in a different location and communicate with the training center 7A.

The CAT training system of the present invention may be set up by the following procedure. A cloud server is first set-up. The Cloud includes one or more computers hosting the training application software. The necessary number of workstations/terminals are then arranged, training software is developed, and functionality for VoIP/VoLTE or other type of communication is established. Acceptance/accreditation of the NavSkills CAT training system is then sought from flag, P&I and vetting organizations. A network of training centres is set-up. In an exemplary implementation, 12 training centres may be set-up in 3 time zones.

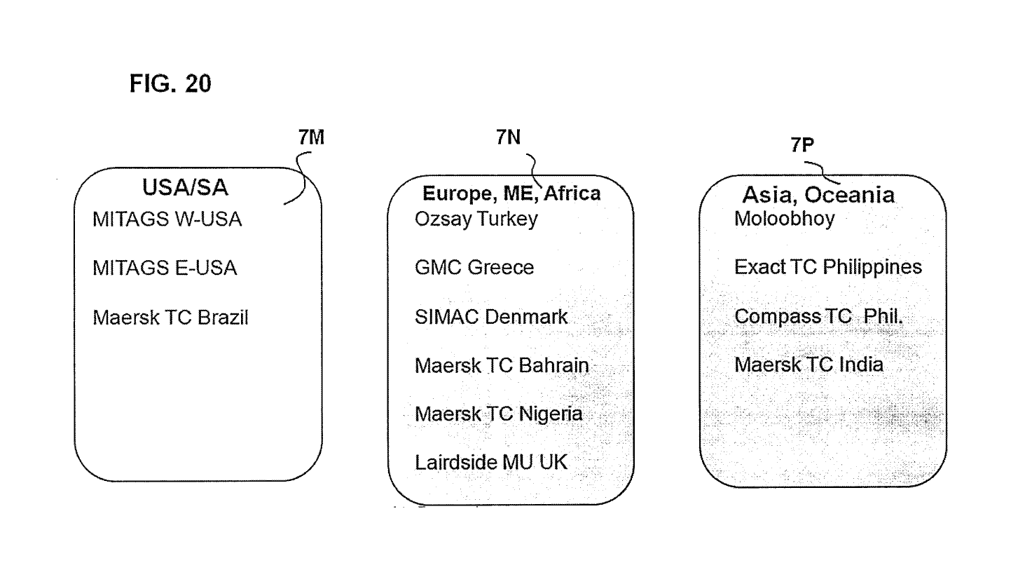

FIG. 20 is a diagram illustrating exemplary training centers set-up for deployment of a NavSkills CAT platform based on cloud computing, according to an embodiment of the present invention. Training centers 7M, 7N and 7P may be set up under Furuno NavSkills in USA and South America (SA), in Europe, Middle East (ME) and Africa, and in Asia and Oceania. The specific centers shown in FIG. 20 are existing and future possible Furuno training centers providing classroom training and the NavSkills CAT platform.

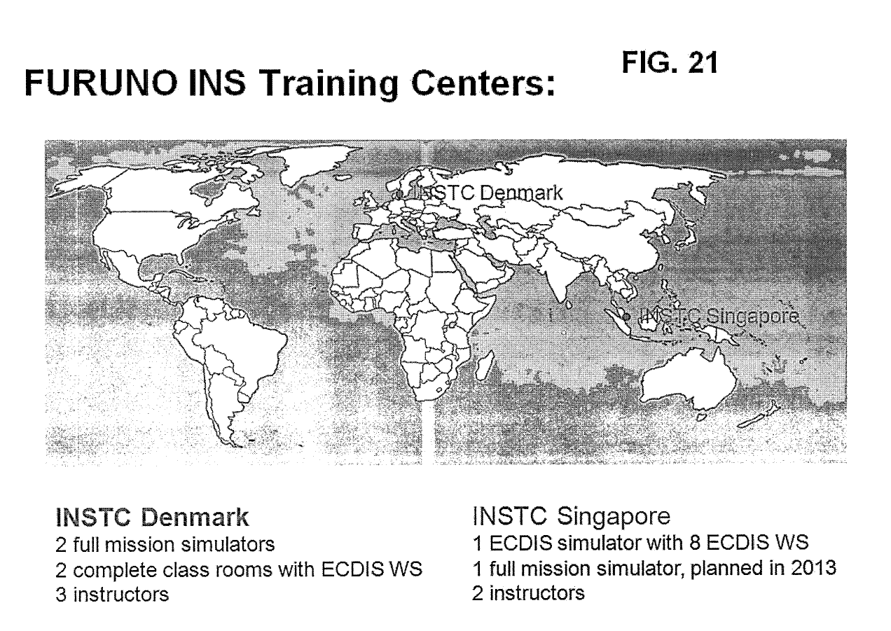

FIG. 21 is a diagram illustrating exemplary deployment of a NavSkills CAT platform at Furuno INS training centers, according to an embodiment of the present invention. At INSTC Denmark, 2 full mission simulators, 2 complete class rooms with ECDIS WS (workstations) and 3 instructors are currently dedicated to NavSkills CAT training. At INSTC Singapore, 1 ECDIS simulator with 8 ECDIS WS, 1 full mission simulator (planned in 2013) and 2 instructors are dedicated or planned in the very near future for NavSkills CAT training.

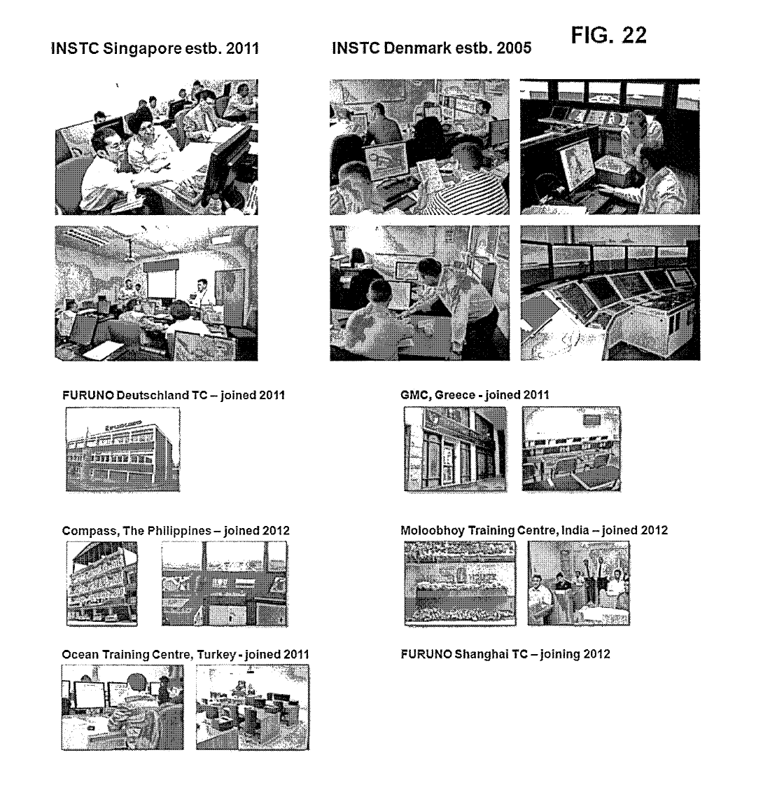

The training centers provide a wide range of training courses. Exemplary offered courses include: IMO ECDIS Model Course 1.27, approved by DNV SeaSkill™ (currently only available in Denmark, available in Singapore in 2013); IMO IBS/INS Model Course 1.32, approved by DNV SeaSkill™ (currently only available in Denmark, available in Singapore in 2013); Furuno's type specific ECDIS training approved by ClassNK (available in both Denmark and Singapore); ECDIS shore staff training course (currently only available in Denmark, available in Singapore in 2013); and IBS/INS shore staff training course (currently only available in Denmark, available in Singapore in 2013). FIG. 22 illustrates some pictures from Furuno INS Training centers.

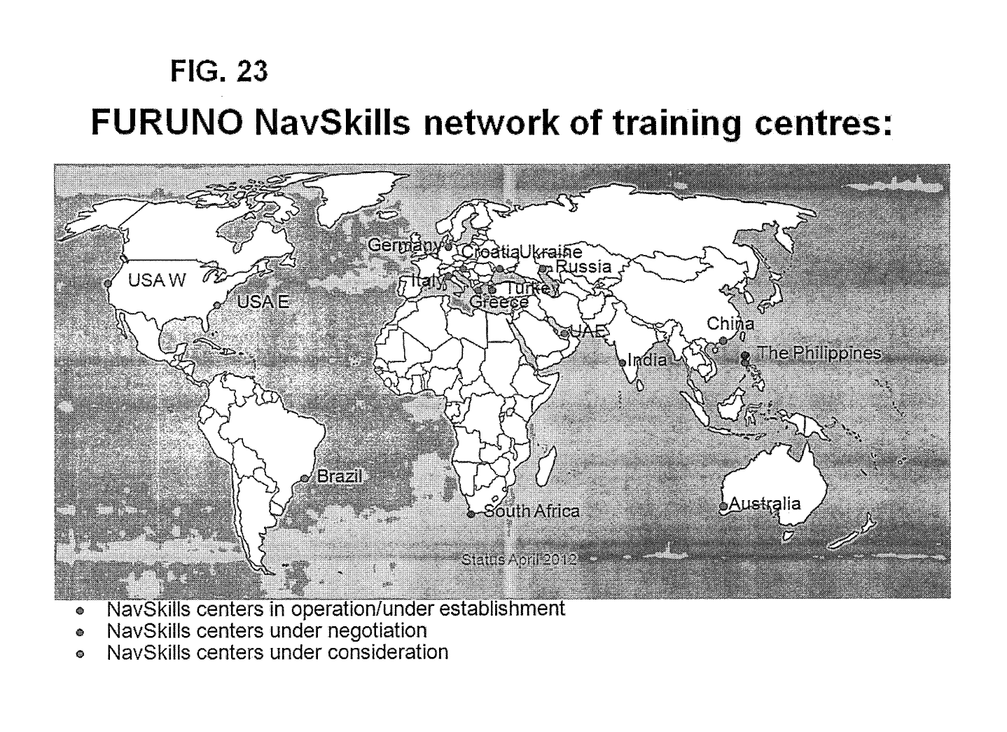

Furuno is currently establishing a global network of training centres to provide easy access to training on Furuno's products. The global network would include the NavSkills CAT network of training centres. The training centres are carefully selected to ensure high quality in operation of the training centre and highly skilled instructors, which have to follow and use Furuno's training syllabus, training schedule and training material. Furuno carries out an annual audit of the training centres. Local instructors are educated by Furuno to perform the training on behalf of Furuno. In this way, Furuno can ensure that the training provided in Furuno and NavSkills training centres becomes and stays identical, and the ship owner can freely choose between the training centres, being assured of the quality of training he receives. FIG. 23 illustrates current and planned centers for Furuno NavSkills CAT network of training centres.

The NavSkills CAT platform of the present invention provides type specific and generic training for users of navigational equipment, based on a self-study computer-aided training implementation. In an exemplary implementation, the ECDIS type specific training is designed to equal the 2 days classroom type training that takes place at a Furuno INSTC training center (e.g., INSTC Denmark or INSTC Singapore) for ECDIS. Thus, NavSkills CAT training application may be based on a one or more-day class room type training conducted at various locations.

The NavSkills CAT training grants, upon satisfactory completion of exercises and tests, an official certificate. For example, for ECDIS training, the training grants a DNV certified Furuno ECDIS type specific certificate.

In a preferred embodiment, the NavSkills CAT is implemented in a cloud environment where preconfigured training workstations logon to register, train and certify the users. In an exemplary implementation, the NavSkills CAT software solution and apparatuses are implemented to be able to work on a cloud environment based on the WMware platform, may provide full emulation of Furuno type devices (such as, for example, FEA-2107/2801) and other navigation devices, including all menus and sub-menus on the main monitor of the NavSkills CAT workstation. The NavSkills CAT software solution and platform may be implemented to be optimized for best performance with limited bandwidth and lay-time between the training workstation and the cloud environment, while providing a visual simulation and also emulating Radar/Conning/Ship controls selectable on the secondary monitor. The NavSkills CAT interface may be implemented to use a set of menus on the NavSkills CAT, workstation for easy operation and navigation through the training.

The NavSkills CAT may provide distant learning for generic and type-specific training for familiarization and operation of various types of vital navigation equipment, to provide equipment certification. NavSkills CAT may provide the generic training together with the type-specific training. To implement a certain type of training, the software for the NavSkills CAT is modified to be customized for the desired type of training and type of navigational device. Thus, the NavSkills CAT is a distant training platform that uses a computer aided training platform to provide high quality training to users of Furuno's equipment as well as users of other navigational technologies. The NavSkills CAT provides an experience that includes advantages of computer based training as well as classroom training.

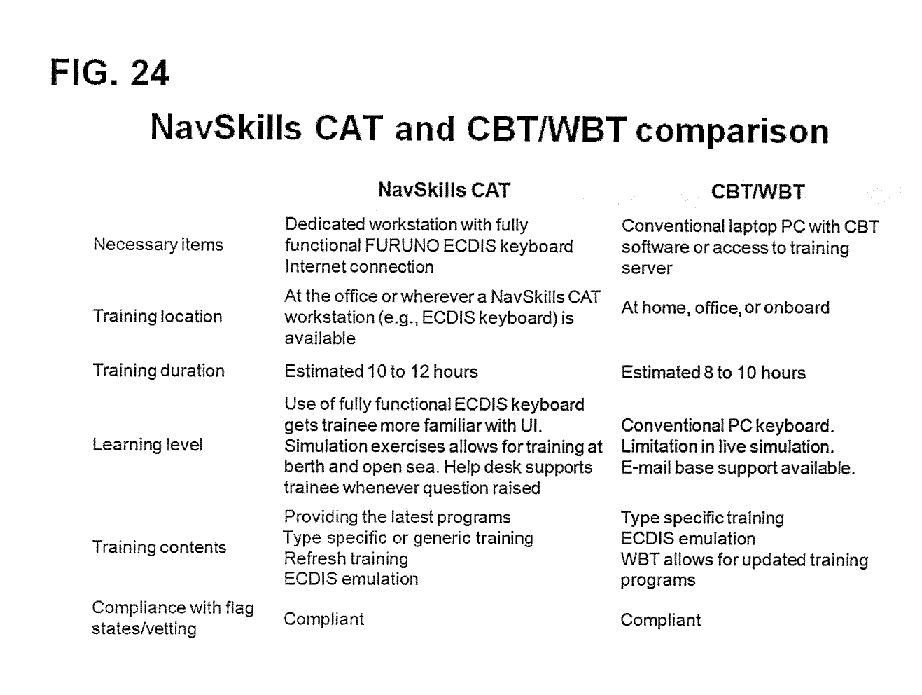

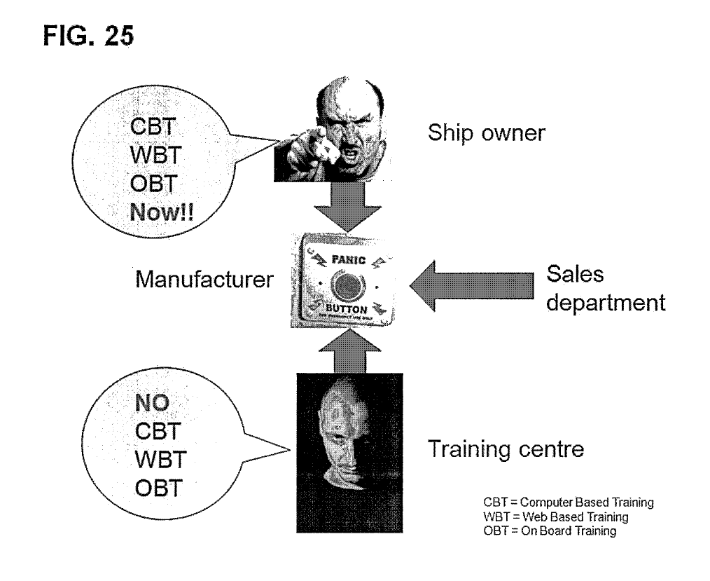

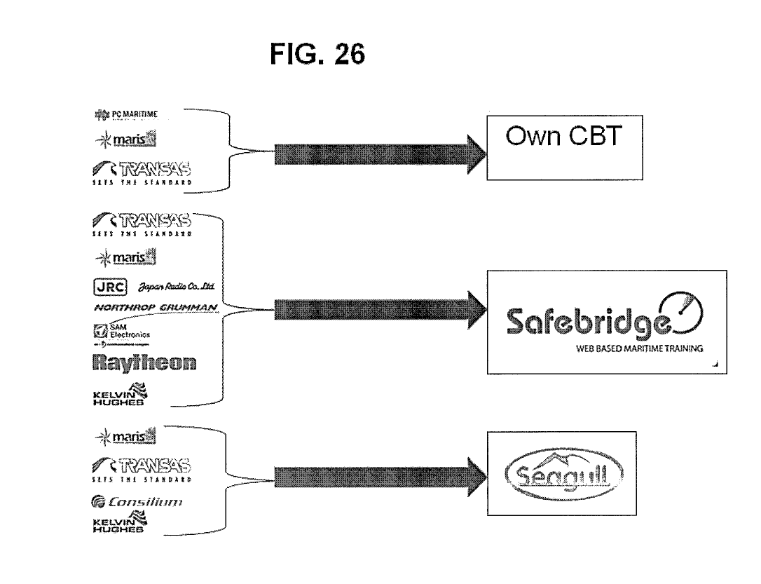

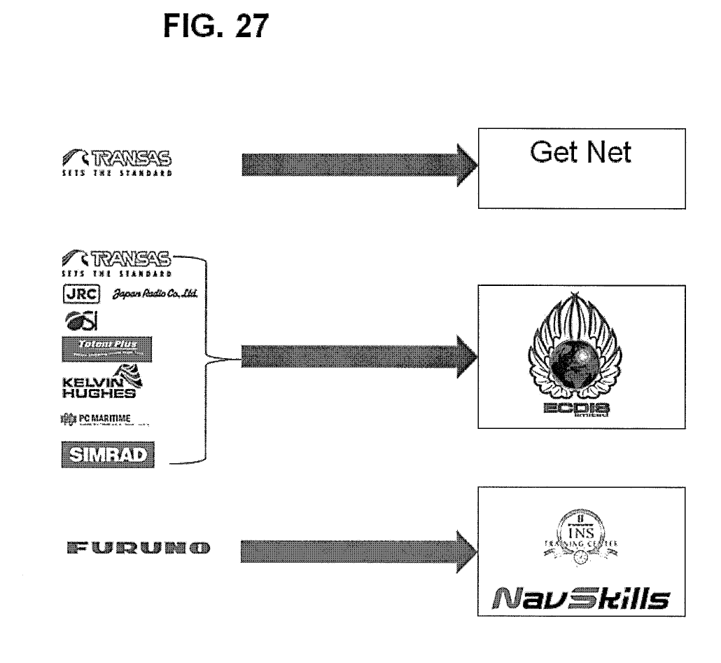

FIG. 24 illustrates a comparison between an exemplary NavSkills CAT training platform for ECDIS according to an embodiment of the present invention, and CBT/WBT training for ECDIS. NavSkills CAT is more efficient and responsive to training needs than other training platforms such as Computer Based Training (CBT) and Web Based Training (WBT). NavSkills CAT training can be performed at any location and at any time. For example, training on NavSkills CAT can be performed locally where navigators live, or close to a shipping office, in international hubs, at specifically selected training facilities, or at other locations such as at sea.

NavSkills CAT platform can be customized to also offer online training courses for navigation equipment, such courses being distributed as an online package that enables a user to take the training course on the Internet, without a NavSkills CAT workstation. Specifically, the Cloud environment of NavSkills CAT can be used to additionally house web based training (WBT) applications and even computer based training (CBT) applications. For example, existing e-learning systems, including computer based training and web based training may be housed on the NavSkills CAT Cloud environment. Thus, NavSkills CAT can be implemented such that it would not compete with current CBT and WBT training applications; instead, NavSkills CAT may work in association with CBT and WBT training applications.

In one embodiment, the NavSkills CAT Cloud environment may house learning systems (e.g., learning software) located both locally at dedicated computer centers, and available from the Internet, and may also house learning systems only available via the Internet and accessible from any regular computer, such as, for example, learning applications for which a specialized workstation is not required.

A flat fee (e.g., yearly flat rate) subscription cost structure for training on the NavSkills CAT platform may be implemented based on contract length (one or multiple years) and number of NavSkills CAT workstations included in the flat fee (pay-per-workstation plan), regardless of the number of trainees using the service. Alternatively, a price structure for pay per training/pay-as-you-go plan may be implemented, based on number of certificates to be granted after training (pay-per-certificate plan), and based on number of NavSkills CAT workstations.

The service fee may depend on number of trainees receiving the service. The subscription for the NavSkills CAT service using one NavSkills CAT training workstation may include maintenance and upgrade of the training workstation.

Flexible price plans for NavSkills CAT may also be designed according to the need of the customers.

For example, the NavSkills CAT may be offered to ship owners on a subscription basis with a yearly flat rate which may be per workstation. The NavSkills CAT platform training may, for example, be implemented as a subscription-based service package dedicated for ship owners who are looking to incorporate general or specific training for certain navigation equipment into the in-house training scheme for their own navigators. NavSkills CAT can be customized for training on certain navigation equipment as needed. This makes navigation equipment training more cost-effective and accessible. Once signed up for NavSkills CAT service subscription and set up the NavSkills CAT workstation delivered, the training provided by NavSkills CAT is readily available.

The flat fee may cover the provision and maintenance of the training NavSkills CAT workstation, access to helpdesk, and access to the NavSkills CAT training application on the central training server for the ship owners and their navigators. This means that the ship owner can train as many navigators as he wishes on the system, within the subscription period at a fixed fee, and because the training is utilizing cloud computing, the training is available 24/7. The helpdesk may provide access to online instructors support via VoIP, VoLTE, etc. The ship owner can choose subscribe to any number of workstations at a yearly fee per workstation, and the ship owner can use one workstation for any number of trainees.

At the present time, training on the current Furuno ECDIS FEA-2107/FEA-2807 is available since September 2012. Training programmes for the new ECDIS FMD-3200/FMD-3300 as well as refresher training modules are currently being developed, both of which may be offered within the same subscription fees. This means that owners having the current ECDIS in their fleet today do not have to worry about the additional cost when introducing the new ECDIS in the fleet, because the type specific training for both models will be available within the flat yearly fee. The NavSkills CAT may be distributed through Furuno's worldwide distribution network.

With this subscription, the ship owner and his trainees can receive training on a group of equipment models (e.g., Furuno ECDIS models and other Furuno models) or all equipment models supported by NavSkills CAT, at no additional cost. The ship owner thus obtains easy access to cost efficient training globally using the NavSkills CAT platform, in a uniform way in accordance with high quality standards. The ship owner is also ensured to receive updated training and certificates at all times. Thus, NavSkills CAT provides easy access to general and specific navigational equipment training worldwide, at a fixed flat fee.

In an exemplary implementation, a trainee does not have to pay a training fee based on his/her access time on-line. In another exemplary implementation, an on-line billing function is incorporated in the NavSkills CAT platform. Such billing function may be employed in real time by a user.

For a user that already uses other types of training (e.g., traditional classroom training), a training package may be designed to provide access to both NavSkills CAT (subscription) and classroom training (not included in subscription). In this way, the ship owner can achieve easy access to cost efficient training globally (training center or CAT) and the training is provided in a uniform way in accordance with high quality standards. The ship owners also receive updated training and certificates accepted by flags, vetting and P&I (Protection & Indemnity).

A service subscription for NavSkills CAT may include everything needed for in-house training for the navigational equipment, so that no further investment is required besides the subscription service fee. An exemplary subscription to the NavSkills CAT service may include:
provision of one PC-based training workstation with the control units for the navigational models for which NavSkills CAT is customized,
online access to the latest training programmes for the navigational models on the training cloud server
two-way communication support to online instructors via VoIP or VoLTE, and
certification of the trainees upon successful completion of the course curriculum.

For example, a NavSkills CAT service subscription for in-house type specific ECDIS training for Furuno ECDIS models FEA-2107/2807 and FMD-3200/3300 would include provision of one PC-based ECDIS training workstation with the Furuno ECDIS control units for both models, online access to the latest training programmes for the both models on the Furuno training server, two-way communication and certification of the trainees from Furuno INSTC upon successful completion of the course curriculum.

In an exemplary implementation geared for ECDIS training, the training centers that implement the CAT training system based on cloud computing of the present invention would purchase one ECDIS simulator with a number of workstations from Furuno, would enter into the NavSkills agreement with Furuno, and would make 2 instructors available—one for classroom training and one for online support for the training system. In return the training centers would receive a portion of the subscription fee (to be shared between the training centers) from the ship owners per workstation. In an exemplary embodiment, the training centers would receive half of the subscription fee.

Thus, the NavSkills CAT training system based on cloud computing of the present invention may be implemented as an add-on business to classroom training which would therefore not compete with the training centers. The training system of the present invention may thus connect the training centers to the owners (end users) directly, with possible spin off. The training centers will benefit from the ECDIS installations using the training system of the present invention. The CAT training system based on cloud computing of the present invention may, for example, be connected to Furuno's global network of training centers, in order to deliver training on Furuno's products anywhere and anytime.

NavSkills CAT provides a platform for navigational training which meets a high quality standard, based on the continuous study on the policies governing type specific training set by the various flag states and through an ongoing contact to vetting companies, ship owners and other stake holders to ensure that the training provided by NavSkills CAT can meet the current and future requirements of the shipping industry. The user of the NavSkills CAT platform learns one or more, and preferably all of the following:
how to navigate the menus of the equipment, and how to verify the data displayed and used by the equipment,
how to verify the performance of the equipment and the validity of data presented,
how to troubleshoot the equipment and establish the necessary steps to safe operation,
how to handle emergency situations using the equipment the best way without allowing the equipment to distract the navigator from the emergency at hand, thus creating resilient navigators, who are able to operate the respective equipment under various circumstances including emergency situations,
how to judge and decide when to switch from one type of navigation (e.g., ECDIS based navigation) to other types of navigation,
how to make the equipment an integrated part of the bridge operation,
safe operation of the equipment for which training was performed, which decreases the risk of equipment assisted groundings and encourages best practice.

Thus, NavSkills CAT provides global access to high quality training satisfying the requirements of flag states, PSC and vetting. NavSkills CAT can be updated based on consultation with various flag states, ship owners and other stake holders to meet the different demands of vetting agencies and of various clients and potential clients. NavSkills CAT provides training on older as well as newer navigation equipment products. Thus, when a navigator is in possession of an older certificate which was provided for training on an older navigation equipment, he can take a NavSkills CAT course which trains him on the updated or newer navigation equipment. The navigator can take such course on a short notice, e.g., when he is notified that a ship he needs to board has a system which is a different version from the old system on which he was trained. Before boarding the ship and without having to travel to a classroom, the navigator can conveniently take the course in the area where he is then located, and receive real-time help, in his own language, from NavSkills CAT helpdesks located anywhere in the world, The training would familiarize the navigator with the new or updated features of the navigation equipment, with the differences between human-machine interfaces of old and new systems or of different system brands, etc.

NavSkills CAT ensures good and valuable training for the navigational and shipping industry, while promoting economical efficiency, compliance with rules such as vetting, ISM, flag state, safety, best practices, and efficiency in bridge operation. Consequently, the ship owners will have more competent navigators onboard their vessels bringing even more safety and efficiency to the ship operation. Thus, NavSkills CAT reduces the risk of accidents and improves efficiency in bridge operation on ships.

NavSkills CAT training also helps the navigators understand the legal aspects in operating the respective equipment, as well as the capabilities and the limitations of the equipment onboard their ship, while imposing less work load on the navigator during his training. NavSkills CAT training also helps shore based staff (superintendents/operation managers) to understand how to translate the bridge procedures from paper charts to ECDIS or other display and information systems, and enables the shore based staff to handle the implementation of certain equipment operation onboard ships. NavSkills CAT training also helps crew managers understand the need for training and the amount of training that may be necessary for various members of the crew.

The NavSkills CAT training system of the present invention may be installed on all types of vessels, such as, for example, general cargo, tankers, container ships, bulk carriers, passenger ships, Offshore Supply Vessels (OSV), Anchor Handling Tug Supply (AHTS) vessels, etc. The training software of the present invention may be designed to be adapted or fit to various ship and ship system specifications, or may be custom designed for a certain ship system specifications.

Although detailed embodiments and implementations of the present invention have been described above, it should be apparent that various modifications are possible without departing from the spirit and scope of the present invention. Modifications and adaptations of the present invention will be apparent to those skilled in the art from consideration of the specification and practice of the invention disclosed herein.

For example, although aspects of the present invention have been described in the context of maritime applications, it should be realized that the principles of the NavSkills CAT training system of the present invention are applicable to other environments and applications. For example, the NavSkills CAT training system of the present invention may also be adapted for training of other equipment such as equipment on land, in air/space and in underwater stations, for non-maritime vessels, and industrial infrastructure.

The foregoing description of an implementation of the invention has been presented for purposes of illustration and description. It is not exhaustive and does not limit the invention to the precise form disclosed. Modifications and variations are possible in light of the above teachings or may be acquired from the practicing of the invention.

Additionally, although some aspects of the present invention are described for being stored in a memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

1. A computer aided training system, said system comprising:
a workstation providing a simulation of a device,
said workstation being configured to connect to a cloud environment and to access a training application that comprises training for said device, wherein said training application is hosted on said cloud environment.

2. The computer aided training system according to claim 1, wherein said device is a navigation apparatus.

3. The computer aided training system according to claim 2, wherein said navigation apparatus is an Electronic Chart Display and Information System.

4-5. (canceled)

6. The computer aided training system according to claim 1, wherein, in said cloud environment, said workstation is preconfigured to log into the training application, and
said computer aided training system is configured to train and certify a device user after user training on said workstation.

7. The computer aided training system according to claim 1, wherein said training application is dynamically updated on a cloud server of said cloud environment.

8. The computer aided training system according to claim 1, wherein the computer aided training system implements “multi-instructors”-to-“multi-trainees” training via a cloud server of said cloud environment, using at least one of VoIP, VoLTE and video streaming.

9-10. (canceled)

11. The computer aided training system according to claim 1, wherein said workstation provides said simulation of said device as an emulation of said device including a plurality of menus on a display.

12. The computer aided training system according to claim 1, wherein said workstation provides the simulation of said device using:
at least two displays, wherein
one display of said at least two displays is configured to display features of said device and
another display of said at least two displays is configured to provide a simulation of a ship feature, and
a control head which simulates an actual control head of said device.

13-14. (canceled)

15. The computer aided training system according to claim 1, said computer aided training system further comprising a helpdesk connected to said cloud environment, for providing online support to a user performing said training for said device,
said online support being provided via one or more of VoIP, VoLTE, streaming video and messaging.

16. (canceled)

17. The computer aided training system according to claim 1, wherein said training application is accessible at a user location through said cloud environment.

18-20. (canceled)

21. The computer aided training system according to claim 1, wherein said computer aided training system provides a certificate of training to a user of said workstation, upon completion of training for said device on said workstation.

22. The computer aided training system according to claim 1, wherein said training application is configured to provide different levels of access to different types of users.

23-24. (canceled)

25. The computer aided training system according to claim 1, further comprising an identifying device for verifying identity of a user, using at least one of a magnetic card, an image taking device, and a recognition device for recognition of an anatomical feature.

26-33. (canceled)

34. The computer aided training system according to claim 1, wherein
said device is an ECDIS apparatus, and
said training application provides at least one of type-specific ECDIS training, ship-specific ECDIS training, and generic ECDIS training.

35-69. (canceled)

70. A method of distributing training to a user to qualify the user for operating a device, said method comprising:
producing a simulation of said device, and
distributing, via a network, a training application for said device to a location of the user, said training application providing training using said simulation of said device.

71-72. (canceled)

73. The method according to claim 70, wherein said device is a navigation apparatus, said navigation apparatus being an Electronic Chart Display and Information System.

74-107. (canceled)

108. The method according to claim 70, wherein said device is an ECDIS apparatus, and said training application provides at least one of type-specific ECDIS training, ship-specific ECDIS training, and generic ECDIS training.

109. (canceled)

110. A computer readable storage medium storing a computer program, the computer program when executed causes a processor to perform the step of:
distributing to a location of a user, via a cloud environment, a training application for a device, said training application providing training using a functional simulation of said device at the location of the user.

111. (canceled)

112. The computer readable storage medium according to claim 110, wherein said device is a navigation apparatus, said navigation apparatus being an Electronic Chart Display and Information System.

113-144. (canceled)

145. The computer readable storage medium according to claim 110, wherein said device is an ECDIS apparatus, and said training application provides at least one of type-specific ECDIS training, ship-specific ECDIS training, and generic ECDIS training.

146. (canceled)
